(19) United States
(12) Patent Application Publication
(10) Pub. No.: US 2026/0245058 A1
(43) Pub. Date: Aug. 20, 2026

(54) COMPUTER IMPLEMENTED SYSTEM FOR PROVIDING DATA PROCESSING SERVICES

(71) Applicant: HYPERLAYER IP COMPANY LIMITED, Dublin (IE)

(72) Inventors: Paul ROLLES, Dublin (IE); Christopher John LOWRIE, Dublin (IE); Mathew MEGENS, Dublin (IE)

(21) Appl. No.: 18/841,026

(22) PCT Filed: Jun. 14, 2024
(86) PCT No.: PCT/EP2024/066696

§ 371 Date: Aug. 23, 2024

Related U.S. Application Data
(60) Provisional application No. 63/508,517, filed on Jun. 16, 2023.
(60) Provisional application No. 63/508,519, filed on Jun. 16, 2023.
(60) Provisional application No. 63/508,520, filed on Jun. 16, 2023.
(60) Provisional application No. 63/508,521, filed on Jun. 16, 2023.
(60) Provisional application No. 63/508,523, filed on Jun. 16, 2023.
(60) Provisional application No. 63/508,525, filed on Jun. 16, 2023.
(60) Provisional application No. 63/508,526, filed on Jun. 16, 2023.
(60) Provisional application No. 63/508,528, filed on Jun. 16, 2023.
(60) Provisional application No. 63/508,529, filed on Jun. 16, 2023.
(60) Provisional application No. 63/508,530, filed on Jun. 16, 2023.
(60) Provisional application No. 63/508,531, filed on Jun. 16, 2023.
(60) Provisional application No. 63/508,532, filed on Jun. 16, 2023.
(60) Provisional application No. 63/508,533, filed on Jun. 16, 2023.
(60) Provisional application No. 63/508,536, filed on Jun. 16, 2023.
(60) Provisional application No. 63/508,538, filed on Jun. 16, 2023.
(60) Provisional application No. 63/508,539, filed on Jun. 16, 2023.
(60) Provisional application No. 63/508,540, filed on Jun. 16, 2023.
(60) Provisional application No. 63/508,542, filed on Jun. 16, 2023.
(60) Provisional application No. 63/508,544, filed on Jun. 16, 2023.

(30) Foreign Application Priority Data
Jun. 16, 2023 (GB) 2309099.6

(51) Int. Cl. G06Q 20/08; G06Q 20/20; G06Q 20/22; G06Q 20/26; G06Q 20/36

(52) U.S. Cl. CPC G06Q 20/0855; G06Q 20/204; G06Q 20/227; G06Q 20/26; G06Q 20/36

(57) ABSTRACT

A computer-implemented system is configured to provide data processing services to an entity; the system includes: (i) a data-analysis environment, which includes or accesses a data store that stores data and meta-data for one or more data objects that represent a store of value (‘data objects’), such as data objects that are created by the entity; and (ii) an API layer that links the data-analysis environment to (a) a digital wallet publisher, and to (b) a service publisher that publishes data to, and receives data from, the data-analysis environment.

### BACKGROUND OF THE INVENTION

### 1. Field of the Invention

The field of the invention relates to a computer-implemented system for providing data processing services. An implementation of the system provides new functions, such as the real-time analysis, permissioning and blocking of financial transactions using a real-time rules engine; it can be implemented as a middleware layer that connects to legacy core technology via an API layer, such as legacy core banking technology, enabling that legacy core banking technology to support new functions, such as enhanced digital wallets, without the complex, slow, risky and costly process of modifying and updating the legacy core banking technology.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

The core banking and payments infrastructure used by banks, merchants, businesses, and ordinary consumers are designed to handle tens of millions of transactions very rapidly and with very high levels of security. These core, legacy platforms are highly complex, very large and are typically designed to handle transactions between tens of millions of businesses and merchants, and tens of millions ordinary consumers and businesses. They are inherently difficult to update; altering this core banking and payments infrastructure is slow, risky and costly.

This makes it difficult to test, and to implement at scale, a broad range of new functionality that could be appealing to ordinary consumers, suppliers, merchants and banking and payment providers. There is some innovation however: for example, due to a recent wave of digitisation in the banking industry and in particular in payments, there are now financial services applications that link up to bank accounts, credit cards and investments and that pull information about payments, card usage and other transactions into digital platforms. These innovations are taking place across both the business and consumer sectors and are streamlining business processes, for example by automating the loading of bank account transactions into accounting packages and aiding consumers with their day to day financial life in the form of digital wallets. Digital wallets are therefore becoming increasingly popular for conducting a number of transactions, such as taking deposits, incentivizing card use, lending, facilitating foreign exchange fees or overdraft fees. However digital wallets are often targeted at a very specific customer demographic such as people with money, people who need to borrow money or people who travel abroad a lot. Digital wallets may also provide budgeting functions that display the money coming in and help a user track their spending. Digital wallet providers tend to engage with their customers in a limited way and only focus their understanding on what customers have done in the past and are not able to predict what they will do in the future. But innovating beyond simple digital wallets is in practice a very difficult challenge, primarily because of the need to reliably handle tens of millions of transactions in real-time and within the constraints of having to work with the legacy, core banking and payments infrastructure of multiple different banks and payment providers.

The invention addresses this challenge.

### SUMMARY OF THE INVENTION

The invention is defined in claim 1. Implementations of the invention include a number of different Key Features, which we summarise as follows:
Key Feature A. High level architecture
Key Feature B. The digital wallet
Key Feature C. Consumer spending intent
Key Feature D. Auto allocating a transaction to a Jar
Key Feature E. Dynamic, rule-based, real-time analysis of a proposed transaction
Key Feature F: Direct payment from a data object
Key Feature G: Shared Jars
Key Feature H: Shared Jar messaging
Key Feature I. Delegated Permission/devolved spending
Key Feature J. Reconciliation
Key Feature K. Supplier Messages
Key Feature L. Merchant Specific Jars
Key Feature M. Merchant Intent
Key Feature N: Merchant Rewards
Key Feature O: Merchant Matching
Key Feature P: Merchant Money
Key Feature Q: Indirect Debit
Key Feature R: Intent based lending
Key Feature S: Cash proxies
Key Feature T: Priority of payment
Key Feature U: One card

Appendix 1 expands on these Key Features and adds a number of sub-features relevant to some or all of these Key Features.

### BRIEF DESCRIPTION OF THE FIGURES

Aspects of the invention will now be described, by way of example(s), with reference to the following Figures, which each show features of an implementation of the invention called HyperLayer™ and HyperJar™:

FIG. 1 illustrates an overview of the HyperLayer architecture for a single user.

FIG. 2 illustrates the high-level functions of the system.

FIG. 3 provides a screenshot of a page of the end-user app that enables an end-user to open as many sub-accounts or jars as they want and to spend directly from any jars.

FIG. 4 provides a screenshot of a page of the end-user app that enables an end-user to set permissions or rules for each jar that the end-user has created.

FIG. 5 provides a screenshot of a page of the end-user app that enables an end-user to share each jar with any number of users such as friends, family or kids, with each having a set of permissions or rules, with key elements of the interface shown expanded.

FIG. 6 provides a screenshot of a page of the end-user app that enables an end-user to set or create jar permissions for another user, with key elements of the interface shown expanded.

FIG. 7 provides a screenshot of a page of the end-user app that enables messaging services between the users of a shared jar, with key elements of the interface shown expanded.

FIG. 8 provides a screenshot of a page of the end-user app that enables an end-user to block or restrict where money in a jar can be spent.

FIG. 9 provides a screenshot of a page of the end-user app that displays any merchant loyalty rewards, voucher and/or gifting.

FIG. 10 provides another screenshot of a page of the end-user app that displays any merchant loyalty rewards, voucher and/or gifting.

FIG. 11 provides a message or alert displayed notifying an end-user that a transaction has been processed.

FIG. 12 shows a diagram that illustrates the ecosystem of intent data.

FIG. 13 is a diagram illustrating a high-level view of a possible cloud computing infrastructure.

FIG. 14 is another diagram illustrating a more detailed view of the cloud computing infrastructure.

FIG. 15 is a block diagram illustrating the application running on a cloud and services.

FIG. 16 shows a diagram illustrating the functions available with a typical bank account.

FIG. 17 shows a diagram illustrating the functions available with a typical Neobank account.

FIG. 18 shows a diagram illustrating the functions available with an Hyperjar account.

FIG. 19 shows a diagram illustrating how users can create an arbitrary number of fully functional accounts (“Jars”).

FIG. 20 shows a diagram illustrating how a Jar can have an “overflow” into another Jar.

FIG. 21 shows a diagram illustrating a user's defined collection of MIDs/MCCs.

FIG. 22 shows a screenshot of a chat.

FIG. 23 shows a diagram illustrating an “overflow” when sharing a zero-balance Jar.

FIG. 24 shows an illustration of the MRE engine.

FIG. 25 shows a diagram illustrating when a transaction is Face to face.

FIG. 26 shows a diagram illustrating when a transaction is made online.

FIG. 27 shows a diagram illustrating when a transaction is used online or in-store where no QR code/barcode scanner is available.

FIG. 28 shows a diagram illustrating a typical points loyalty scheme.

FIG. 29 shows a diagram illustrating saving with HyperJar.

FIG. 30 shows a table illustrating the HyperJar rewards and loyalty features.

FIG. 31A provides a diagram illustrating a normal bank account.

FIG. 31B provides a diagram illustrating a HyperJar system.

FIG. 32 shows a diagram illustrating the HyperLayer Self Reinforcing Business Model.

### DETAILED DESCRIPTION

This detailed description describes an implementation of the invention that will be referred to as the HyperLayer system; the HyperLayer system can operate as a middleware layer that is integrated via APIs to, for example, banks' existing core banking technology, enabling banks to offer their customers advanced HyperLayer-based functionality without needing to fundamentally change their legacy, core banking technology. This advanced functionality includes an enhanced digital wallet called HyperJar.

It is not just banks and payment providers that can implement this invention, but any organisation that wishes to enhance their existing transaction processing technology infrastructure with an advanced middleware layer that enables a broad range of new capabilities. And note also that the system is not limited to a middleware layer; it can be implemented as an integral part of a data processing and transaction handling system; however, for banks, and other financial institutions, a key advantage of HyperLayer technology is that it can be implemented as a middleware layer that has been designed to operate with existing, legacy core banking systems from multiple different banks and payment providers, enabling a broad range of new transaction processing functionality to be offered to merchants, businesses and ordinary consumers, without the need to fundamentally alter and update those legacy core banking and payment systems. In other sectors, e.g. social media companies, merchants etc. HyperLayer can be integrated with their consumer apps to provide enhanced transaction handling functionality, such as integration with an advanced digital wallet. Note that the HyperLayer system may be generalised as an end-user marketing and behavioural change system that goes beyond financial services, and that can be applied wherever there is a need to analyse and manage transactions of any type in real time.

### The Detailed Description is Organised in the Following Sections:

1. General introduction
2. Overview of the system's architecture
3. Overview of the wallet provider application
4. Intent: a multi-factor approach
5. Cloud infrastructure and deployment
6. Use cases examples

### APPENDIX 1: KEY FEATURES

### We Also Include the Following Further Appendices:

Appendix 2: Back End Differentiation
Appendix 3: Consumer Intent
Appendix 4: Infrastructure overview
Appendix 5: Hyper Jar Direct Pay
Appendix 6: Reward Taxonomy
Appendix 7: Merchant Intent
Appendix 8: B2B Taxonomy
Appendix 9: Layer Architecture

### 1. Overview of the HyperLayer Technical Architecture

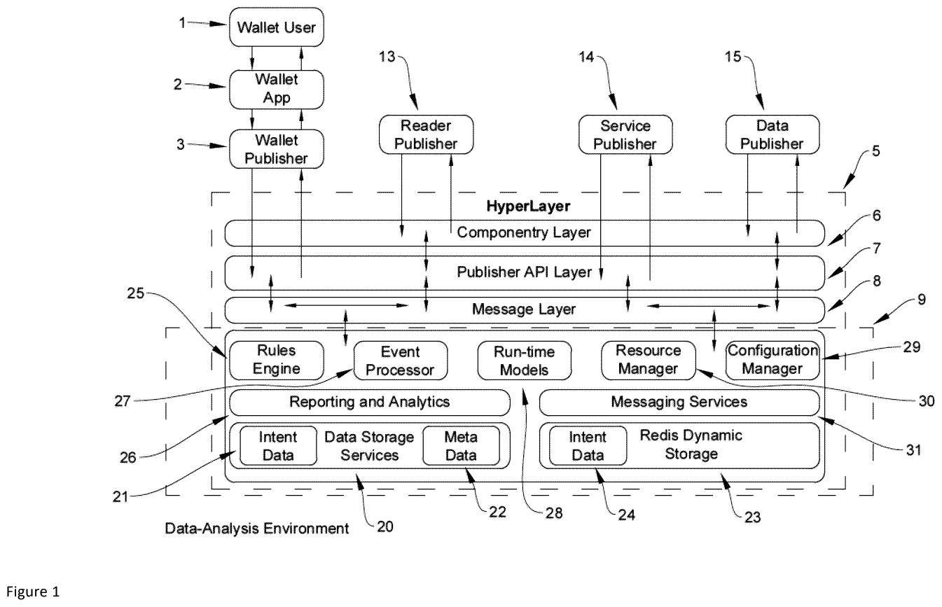

FIG. 1 is an overview of a simplified HyperLayer technical architecture that provides transaction handling services to an entity or end-user, such as a legal entity or a person or company, for a single user, in this example a digital wallet user 1. For multiple users, the HyperLayer system provides even more functionalities, such as user intent functionality or data-sharing (we will describe below what we mean by ‘user intent functionality’.

Wallet users 1 have access to a front-end interface wallet application 2 running on a connected device or a web application. The front-end interface wallet app 2 sends data to and receives data from wallet publisher 3, and also provides access to multiple back-end services from the HyperLayer system 5. The HyperLayer system 5 provides back-end services that can process transaction-related messages from:
one or more service publishers 14, such as banks, saving institutions, merchants or companies;
one or more data publishers 15, such as mortgage providers that allow users to view and pay down an outstanding balance or a retailer that publishes rewards or vouchers.

Note that because the HyperLayer system 5 re-frames the role of banks, merchants etc as message publishers and readers, there is no need to alter the legacy, core transaction processing infrastructure of these banks, merchants etc.; this infrastructure remains the same, and needs only to be able to send data (e.g. messages) to and receive data (e.g. messages) from the publisher API layer 7 in the HyperLayer system 5.

The HyperLayer system 5 may also enable other third parties, reader publishers 13, to have limited access rights for a portion of the stored information, such as reading access rights based on permissions granted by the data owner.

The HyperLayer system 5 is made up of a message layer 8 that receives messages from a data-analysis environment 9. Above the message layer 8 sits a publisher API layer 7 that provides, as noted above, the APIs that enable all external systems (banks, merchants etc.) to exchange messages with the HyperLayer system 5. Above the publisher API layer 7 is a componentry layer 6 that makes the API layer more accessible and efficient, providing a simpler and more cohesive interface.

The data-analysis environment 9 is made up of a data storage services module 20 that stores intent data 21 and meta-data 22. A Redis dynamic storage module 23 (or a similar, fast in-memory resource) also stores intent data. The data storage services module 20 stores intent data 21 and meta-data 22 for one or more data objects that represent a store of value (‘data objects’). A store of value may for example be a bank account; a crypto wallet; credit card rewards; airmiles reward points etc. that has a value of exchange and can be consumed in whole or in part when a transaction is being processed.

The intent data storage modules 21 and 24 can be thought of as forming an intent data layer (IDL) that may further record or store any actions, profiles or events related to each end-user. The intent data layer 21, 24 is an example of a data store that is accessed by a Reporting and Analytics environment 26 for data analysis. Intent data 21, 24 may be in the form of a ‘Data Lake’, or User Intent Data Lake (UDL); The data-analysis environment 9 is configured to store and/or determine each end user's intent, such as future spending intent. Further detail on the processing of user intent is described below. Other instances of data lakes are a HUDL (HyperLayer User Data Lake), MUDL (Merchant User Data Lake) or CUDL (Controller User Data Lake); these terms will be explained later in this specification. Although not necessarily capturing ‘intent’ as such, we think of these different types of data lake as being stored in the intent data portion 21 of the data storage services module 20, but they can be separate from the intent data portion 21.

Sitting above the data storage services module 20 and the Redis dynamic storage module 23 is a messaging services module 31 that manages the management of all messages that are handled by the HyperLayer system 5. Further modules in the HyperLayer system 5 include an event processor 27, a run-time model 28, a resource manager 30 and a configuration manager 29.

A key module in the HyperLayer system 5 is a rules engine 25; this enables the real time application of pre-set rules to determine, for example, if a transaction is to be allowed or blocked; we will expand on rule-based transaction handling later, but it is an important use case and is an example of how the HyperLayer system 5 enables transaction processing that is impossible to implement solely on a legacy core banking technology. For example, take the simple case of a lender wishing to lend a sum of money, say $X, to a recipient (e.g. a company) to enable that recipient to run and grow its business. We describe this as ‘Hypothecated SME Lending’. In an ideal world, the company would use the money lent to it solely for purposes defined in a loan agreement, such as paying companies in its supply chain, agreed payments to employees and directors, paying government taxes etc; in practice, the lender may have visibility on what is spent by the company, but has no automatic way of determining if that spend is in compliance with the loan conditions. If the company spends the money in a manner that is inconsistent with the loan conditions, then there is little the lender can do, other than notify the company that there has been a breach of the loan conditions and attempt to recover any loses. With the HyperLayer system, the bank (as a service publisher 14) can provide the loan to the company; that $X is reflected in an account, or ‘jar’ controlled by the company, and from which the company can initiate spending transactions, payments etc.; we use the generalised term ‘store of value’ to refer to accounts or jars; the $ balance in this store of value and all transactions affecting this store of value are accessible from the wallet app 2 or other app of the company. The data defining this store of value for this company is stored in the data storage services module 20; it can be stored as data in the data lake, such as the intent data module 21, e.g. as a HUDL (HyperLayer User Data Lake) and/or also as meta-data in the meta-data store 22.

A MUDL (Merchant User Data Lake) in data storage services 20 can store a list of the approved payees or merchants that the bank permits the company to send money to, plus the associated spending limits—i.e. the rules that need to be applied to automatically determine whether or not to permit a payment from the company's account or jar, as shown in the wallet app 2. When the company tries to make a payment from its wallet app 2 to a merchant, then, in real-time, a message from the merchant defining the intended transaction is generated via the service publisher node 14 to the HyperLayer system 5; the associated meta-data for that transaction (e.g. amount, merchant name and ID, time and date) passes to the meta-data store 22; the rules engine 25 analyses the meta-data for the transaction to determine if it meets all the lender-defined rules stored in the Merchant User Data Lake and that define transactions that are to be allowed or to be blocked. If the rules are all met, as determined by the rules engine 25, then messages flow back through the HyperLayer system 5 to the external payment processor (one of the service publishers 14), enabling the payment to proceed; this all happens automatically and in real-time. Conversely, if the rules are not all met, then messages flow back through the HyperLayer system 5 to the external payment processor, declining the payment. This sort of useful functionality is very challenging to implement within legacy, core banking infrastructure.

In FIG. 1, we have discussed the underlying technical architecture of the HyperLayer system. The HyperLayer system implements a number of Key Features, using this technical architecture. These Key Features (A-T) are summarised in Appendix 1, but we list them here as a preview:

### Key Feature A. High Level Architecture

A computer-implemented system configured to provide data processing services to an entity, the system including:
(i) a data-analysis environment, which includes or accesses a data store that stores data and meta-data for one or more data objects that represent a store of value (‘data objects’), such as data objects that are created by the entity; and
(ii) an API layer that links the data-analysis environment to (a) a digital wallet publisher, and to (b) a service publisher that publishes data to, and receives data from, the data-analysis environment.
   Key Feature B. The Digital Wallet with Direct Spending from a Jar

A computer-implemented system configured to provide data processing services to an entity, the system including:
(i) a data-analysis environment which includes or accesses a data store that stores data and meta-data for one or more data objects that represent a store of value (‘data objects’), such as data objects that are associated with the entity; and
(ii) an API layer that links the data-analysis environment to (a) a digital wallet publisher, and to (b) a service publisher configured to receive a message defining a proposed transaction from the data-analysis environment, such as a payment transaction relating to the data object associated with the entity;
(iii) a digital wallet app, such as a smartphone or desktop app, that exchanges data with the data-analysis environment and where the digital wallet app includes a user interface that displays one or more user-selectable icons or items that each represent a data object in the data store;
   and where the data-analysis environment is configured (i) to analyse data or meta-data in the message defining the proposed transaction to allocate that proposed transaction to the relevant data object in the data store and, if the transaction is allowed, then (ii) approve the transaction and initiate the response to the transaction proposer, (iii) to automatically alter the value of the relevant data object and (iv) to automatically alter the value of the data object as shown by the digital wallet app, or if the proposed transaction is not allowed, then (v) decline the transaction and initiate the response to the transaction proposer.

### Key Feature C. Consumer Spending Intent

A computer-implemented system configured to provide data processing services to an entity, the system including a data-analysis environment which:
(i) includes or accesses a data store that stores data and meta-data for one or more data objects that represent a store of value (‘data objects’);
   and in which data-analysis environment is configured to enable a data object to be created, selected, defined or modified by the entity to represent a future intent or an intended future action, namely one or more of: (a) what they intend to spend on; (b) where they intend to spend; (c) when they intend to spend; (d) who they intend to spend with; (e) how they intend to spend.

### Key Feature D. Auto Allocating a Transaction to a Jar

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to receive proposed or completed transaction data from an external digital system, such as a debit card, points/loyalty card, an app running on a smartphone or a webshop, and to analyse the transaction data to automatically allocate the transaction to an appropriate data object by comparing the transaction data with the meta-data for one or more data objects.
   Key Feature E. Dynamic, Rule-Based, Real-Time Analysis of a Proposed Transaction A computer-implemented system configured to provide data processing services to an entity, the system including a data-analysis environment which includes or accesses:
(i) a data store that stores data and meta-data for one or more data objects defined or selected by that entity and that each represent a store of value (‘data objects’); and where the data or meta-data for a data object defines (a) one or more permissions that describe who can and cannot transact with a data object or a clusters or group of several individual data objects, and/or (b) one or more rules that describe whether a predefined transaction or other event affecting the data object is permitted or blocked; and
(ii) a rules engine that is configured to automatically and in real-time analyse a proposed transaction relating to a specific data object, against the permissions and/or rules stored in the data store, and is configured to automatically send a message or signal that results in the proposed transaction being automatically allowed or blocked.
   Key Feature F: Direct Payment from a Data Object

A computer-implemented system configured to provide data processing services to an entity, the system including a data-analysis environment which:
(i) includes or accesses a data store that stores data and meta-data for one or more data objects that each represent a store of value (‘data objects’);
(ii) is configured to analyse in real time a payment transaction to determine if it relates to a specific data object and to analyse any applicable rules or permissions for that data object;
and, if the rules or permissions allow the payment transaction, to then process and record the payment transaction against that specific data object in real time.

### Key Feature G: Shared Jars

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’); and in which the data-analysis environment is configured to enable a data object to be created, selected, defined or modified by the entity to represent a shared data object that one or more third parties, identified by the entity and whose identities are recorded in the data store, are able to view and/or to transact with.

### Key Feature H: Shared Jar Messaging

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
   and in which a data object is created, selected, defined or modified by the entity to represent a shared data object that one or more third parties, identified by the entity, are able to view and to transact with, and the identities of the third parties is stored as data or meta-data in the data store;
   and in which the data-analysis environment is configured to enable messages relating to the shared data object be sent between the entity and the third parties.

### Key Feature I. Delegated Permission/Devolved Spending

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable the entity to create, select, define or modify a data object to give a third party entity the ability to perform actions in relation to the data object that are delegated by or devolved by the entity to that third party entity, such as initiating a payment transaction from that shared object.

### Key Feature J. Reconciliation

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable multiple entities to share a data object for a shared transaction or event;
   and in which the data-analysis environment is configured to automatically reconcile or allocate sums, e.g. after the transaction or event has concluded, among the multiple entities, according to rules or conditions as agreed by the multiple entities.

### Key Feature K. Supplier Messages

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable a supplier to create rules relating to one or more of the data objects, the rules being stored in the data store;
(iii) includes or accesses a rules engine that is configured to automatically apply those rules when determining if data messages are sent and displayed in relation to the data object or objects.

### Key Feature L. Merchant Specific Jars

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
   and the meta-data for a data object defines which third party merchant or merchants are permitted to transact with the data object.

### Key Feature M. Merchant Intent

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’), such as money; and
(ii) is configured to share, with one or more merchants, one or more of the following types of intent-related data, which are collected into a queryable database or data set that is stored in or is accessible by the data-analysis environment: what the user intends to buy using a specific data object; who the user intends to spend their money with, using a specific data object; when the user intends to spend their money, using a specific data object; any transaction entered into by the entity using a specific data object with the merchant or other merchants, such as what was purchased, when it was purchased, where it was purchased, and whether any reward or incentive was used in the purchase.

### Key Feature N: Merchant Rewards

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable a merchant to define one or more rules for awarding rewards or incentives, the rules being stored in a rules engine in or accessible by the data-analysis environment; and the data-analysis environment is configured to use the rules engine to determine whether to automatically award those rewards or incentives to a data object that satisfies the rule(s).

### Key Feature O: Merchant Matching

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to analyse a proposed transaction to automatically identify a counter-party or origin of the proposed transaction, such as a specific merchant that the entity is transacting with.

### Key Feature P: Merchant Money

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) enables the creation, supply, or purchase of, non-fiat currency linked with a specific merchant or group of merchants, such as rewards points or vouchers, and stores these as data objects;
(iii) is configured to analyse in real time a payment transaction to determine if it relates to one of the data objects stored in step (ii) above, and to analyse any applicable rules or permissions for that data object; and, if the rules or permissions allow the payment transaction, to then determine the value to be exchanged, then process and record the payment transaction against that specific data object in real time.

### Key Feature Q: Indirect Debit

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to receive a direct debit request from a specific merchant and, when there is no data record stored in the data store of the entity agreeing to accept a direct debit from that merchant, to meta-tag the amount of the direct debit request as a debt that the user entity owes to the specific merchant and to store that meta-tag to enable the user entity to automatically make future payments to that merchant to progressively pay off that amount.

### Key Feature R: Intent Based Lending

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’); in which the meta-data defines the entity's future intent or spending plans with a specific merchant;
(ii) is configured to generate financial and/or credit evaluation data for that merchant that automatically uses or takes into account the meta-data that captures the future intent or spending plans of that entity.

### Key Feature S: Cash Proxies

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to store a data record for the amounts of one or more non-fiat items owned by or associated with that user entity and, when the user entity starts or enters a proposed transaction in a fiat currency, then the data-analysis environment retrieves or looks up an exchange rate between the non-fiat item type and the fiat currency, and automatically calculates how the transaction could be completed, in whole or part, using the non-fiat items at the prevailing exchange rate.

### Key Feature T: Priority of Payment

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to store for a publisher the specific order in which the available stores of value in their service proposition should be credited or debited, based on the attributes of the transaction and/or the attributes of the available stores of value.

### Key Feature U: One Card

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii)is configured to store for a publisher multiple different available stores of value in their service proposition that may be credited or debited for a transaction;
(iii) is configured to process the transaction on receipt of a message from a single user controlled item, such as a payment card, a smartphone, a computer, and to then allocate the transaction to one or more of the available stores of value to be credited or debited for the transaction, based on the attributes of the transaction and/or the attributes of the available stores of value.

### 2. Overview of Functionality

Whilst much of this specification focusses on the underlying technical architecture of the HyperLayer system, it may help if we start by explaining the functionality that flows from this architecture, to give some practical, real-world context.

### About HyperLayer and HyperJar

HyperLayer is a platform that (amongst other things) converts a traditional bank account into a smart wallet without requiring any modifications to the legacy, core banking technology that implements that traditional bank account. HyperLayer includes, as noted above, a rules engine 25 that processes, in real-time, user-defined instructions that determine where, how and with whom to settle transactions. By breaking the rigid link between payments and fixed accounts that is a feature of today's ledger systems and the core banking technology that runs those ledger systems, HyperLayer introduces next generation functionality to manage value flows between individuals, groups and companies, architected as a middleware layer that interacts via APIs 7 with existing legacy systems designed to handle (with limited functionality) the management of value flows.

HyperLayer technology enables innovative applications in consumer spending, merchant loyalty, corporate cards, supply chain and commercial lending. HyperJar is an example of a smart wallet application and spending card built on HyperLayer and using a number of the innovations referenced in this document.

Areas of Collaboration with Banks Etc.

Many banks and consumer wallets already offer a range of tools designed to enable consumers to take control of their finances. These can include budgeting tools, spending breakdowns, credit scores, rewards, advisory services and guides. Some players have also already enjoyed considerable success with some version of ‘pots’ that allowing consumers to organise their money around the things that matter to them.

HyperLayer can sit on top of any existing system of accounts, integrates with the different payment rails that move value in and out of these accounts, and delivers consumer functionality that turns any banking app or digital wallet into an advanced smart wallet 2 (see next section for more detail on these):
Switch on a 2.0 version of ‘pots’ that offer consumers rich spending functionality
Deliver truly ‘social spending’, unique functionality that is a world-first for banks
Embed a native merchant engagement platform into the bank/wallet payment journey
Offer sophisticated merchant cash advance and hypothecated lending products to SMEs
Capture a greater share of value for the distribution of third party financial products
   These Capabilities Help Banks and Wallet Providers to Achieve their Goals by:
Acquiring and retaining customers and deposits by extending the consumer proposition
Supporting rapid product development and driving engagement in core products
Creating new revenues that increase balance sheet efficiency
Minimising costs and limiting balance sheet by leveraging existing infrastructure

And it does all this without the need to make significant modification to legacy core banking technology.

### 2.0 Version of Pots

HyperLayer allows users (e.g. end customers) to create as many virtual sub-accounts as they like from a single underlying donor account; data defining the donor account and all related sub-accounts are stored in the intent data 21 and/or meta-data module 22 in the data storage module 20 of the HyperLayer data-analysis environment 9. The funds held in the donor account can be distributed across the different (virtual) sub-accounts, which then operate as discrete financial objects in the HyperLayer system. Each sub-account can also be customised to the individual needs of the account owner. They can associate each sub-account with any given project, trade or relationship, linking the relevant suppliers or buyers to each account; this association data is stored in the intent data 21 and/or meta-data module 22 in the data storage module 20 of the HyperLayer data-analysis environment 9.

Based on these links/rules, payments into the donor account are automatically ‘forked’ into the relevant sub-account. Similarly, payments from the donor account are automatically drawn from the relevant sub-account. This allows users to organise spending around their own budgets and goals.

### Social Spending

HyperLayer's virtual sub-account structure enables users to share their sub-accounts (‘Pots’ or ‘Jars’) with friends and family and to delegate authority to them to operate over it, thereby allowing any given group of individuals to budget and spend together. Account owners have fine-grained control to limit what their friends and family can do with each sub-account: they can disable/cap spend; give/withdraw the ability to transfer money out; block the use of that sub-account for a particular set of merchants; restrict spend from that sub-account, so that it can only be used for a particular set of merchants; etc. The data defining this fine-grained control is stored in the intent data 21 and/or meta-data module 22 in the data storage module 20 of the HyperLayer data-analysis environment 9. Data-analysis environment 9 queries this data when any of the friends and family initiate a purchase transaction and the rules engine 25 determines if the transaction is to be allowed or blocked. This form of social spending unlocks powerful network effects for user acquisition, engagement and retention.

### Native Merchant Engagement Platform

HyperLayer also treats merchant vouchers and rewards in the same way as sub-accounts. Users visualise them as distinct financial data objects in their digital wallet 2, and—importantly—can use their value to settle a payment request. Users redeem vouchers and rewards with a single tap of their debit card—there is no need to open a loyalty app, transfer rewards or present a gift card code.

Because HyperLayer can process high volumes of large and complex rule sets using rules engine 25 in real-time at point-of-sale, merchants can structure rewards around arbitrary condition sets that are evaluated at point-of-sale (e.g. users over 30 years old spending £25 or more between 5-7 pm on a Friday). Merchants can also specify that rewards are paid out as ‘merchant money’ (i.e. only redeemable with them) so that loyalty is continually reinforced and retained in the merchant's ecosystem. This is a radical evolution of existing merchant engagement platforms, and one that transforms both the merchants' and the user's own experience at point of sale. Most merchant reward and cash back programmes are loss leaders, subsidized by the banks that offer them. Merchants will pay banks for access to customers via HyperLayer capabilities, creating a new revenue line.

### Merchant Cash Advance

HyperLayer not only records the value of all vouchers—i.e. pre-payments to merchants—held at any point in time and stored in the intent data store 21, but it also captures data on a user's forward-looking financial intent from their use of the budgeting functionality enabled by Pots/sub-accounts. This information is incremental to the historical transaction data used as the basis for traditional merchant finance, and therefore offers an innovative evolution of the cash advance product. For example, a company may have visibility, from the HyperLayer system, that a major customer has committed to spend $X with the company in the future: the customer has created a jar that represents their intent to spend $X with the company. The company can now approach a lender, and (with the customer's consent) can show them that intent to spend $X; the lender could then provide a loan to the company, with some confidence that repayment is likely, given the expressed customer commitment to spend $X with the company. So the prepayment values (the intent data) is shared with lenders so that they can get a view of latent demand and lend to the supplier/merchant at lower rates because they have access to both historic spend data and future demand.

### Hypothecated SME Lending

HyperLayer enables account providers to exercise the same fine-grained control over sub-accounts that its end-users have (e.g. social spending). These controls can be applied programmatically using rules engine 25 to the disbursement of funds lent to SMEs, enabling a complete re-think of the traditional model.

We call this hypothecated SME lending (see above), as it provides a scalable alternative to operational monitoring of the use of funds, reliance on covenants and other manual processes that are otherwise required to manage risk and therefore create overheads that prevent profitable lending. In hypothecated SME lending, HyperLayer's capabilities for sharding (i.e. creating sub-accounts or jars), its rules engine and a priority of payment feature (explained below) are used so that a lender can exert control over where the funds lent to a company can be spent—e.g. just in their supplier chain (i.e. the company creates a jar for all their suppliers, and the lent money is then placed directly into this jar, with a rule that the money in this jar can only be spent to pay invoices from named suppliers. Funds received by the company in the normal course of trade can be routed into different pots according to a priority ordering captured in the data lake and implemented by the rules engine; we call this ‘priority of payment’—e.g. for every £100 received, £25 is used to repay part of the loan as the top priority; £25 goes to pots or jars that can only be used to pay suppliers in the defined supply chain as the next priority, and the remaining £50 goes to general pots than can be used to run the business.

### Merchant Reward Coupons or Vouchers

HyperLayer enables a ‘customer’ (business or consumer) to prepay for goods or services that they will later purchase and the seller or merchant can encourage the customer to both pre-pay for later goods or services, locking in the future sale; they can also offer incentives to bring forward the purchase or increase the value of the purchase using rewards etc.

For example, a user may have a food budget of £200 a week, which they generally spend at Tesco. This £200 represents a forward-looking financial intent; it can be captured by the user opening a sub-account on their wallet app 2 (e.g. which the user can call ‘Tesco weekly shop); data defining this intent for a weekly spend £200 is stored in the intent data 21 store and can, with the user's consent, be shared with Tesco (i.e. a message is sent by the HyperLayer system 5 to Tesco, which is acting as a service publisher 14). Tesco can then choose to incentivise this user, for example by sending them a £10 voucher after each week they do spend £200 or more with Tesco: this £10 voucher is captured in the intent data store 21 and is shown as a data object in the user's wallet app 2. It can be used directly when spending with Tesco. The user can for example set up a rule (captured in the intent data store 21 and applied by rules engine 25) that says that whenever goods are purchased at Tesco, then the Tesco-specific vouchers are used first, and only any excess over the value of those vouchers comes from the Tesco specific sub-account.

This approach can also be used for crowd-sourced funding, where the merchant or supplier uses the prepayments as working capital for their business as an alternative to traditional banking and invoice financing solutions.

### Distribution of Third Party Products

HyperLayer enables banks (and their end users) to exercise control over the access to and disbursement from any given sub-account. This gives banks the ability to capture a greater share of value for the distribution of third party financial products to consumers than they otherwise would.

The native merchant engagement platform, merchant cash advance and hypothecated lending opportunities are examples of this: HyperLayer embeds the ability to redeem merchant vouchers and rewards in the payment journey, allowing banks to participate more fully in the merchant loyalty value chain; HyperLayer's unique hypothecation capabilities allow wallet providers to participate more fully in the lending value chain, even when the balance sheet is provided by third parties.

Similarly, the HyperLayer platform enables innovative product development to support the distribution of other third party products, such as savings, investments, pensions and insurance. For example, sub-accounts can be programmed to sweep funds into an investment product, having been locked to any other form of disbursement, so that a bank or wallet provider can offer partners a branded origination channel operating seamlessly within their own environment. This functionality is based on the ability to capture and store complex rules that define what can be done with sub-accounts; this is stored in the intent data 21 and/or meta-data module 22 in the data storage module 20 of the HyperLayer data-analysis environment 9. The rules engine 25 then applies those rules in real-time. Priority of payment rules are an example of these sorts of rules.

### Benefits for Banks and Wallet Providers

### Acquire and Retain Customers and Deposits

By integrating HyperLayer, banks and wallet providers can develop propositions that target social use cases involving delegated and shared spend, such as Kids Cards, Family Cards and Student Household Cards. As a result, the consumers who participate in these use cases invite their own family- and friend-based financial networks to join, creating a multiplier effect on acquisition and strengthening retention.

### Drive Digital Engagement

Because HyperLayer unlocks both intent-based functionality and social networks, HyperLayer-enabled smart wallets are particularly high-touch applications. This not only significantly increases digital engagement, but also generates completely unique datasets that can be used to support custom-er engagement strategies. A ‘next best action’ machine learning platform applied across a client's spending, budgeting, saving and investing lifecycle can be offered.

### Create New Revenue Streams

HyperLayer enables a major evolution of existing merchant engagement platforms and of traditional merchant and SME finance products. Banks can leverage HyperLayer to create new revenue streams and capture a greater share of value for the distribution of third party product with little or no incremental capital requirement.

### Minimise Costs

HyperLayer is a highly scalable platform to leverage existing account structures. It offers an accelerated product development capability at minimal incremental build costs, without the need to substantially modify existing core banking technology.

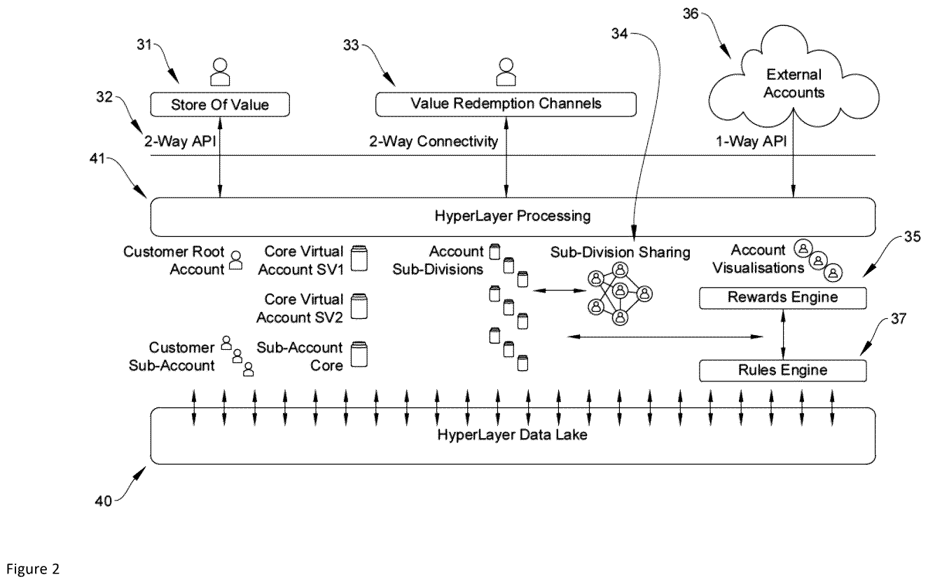

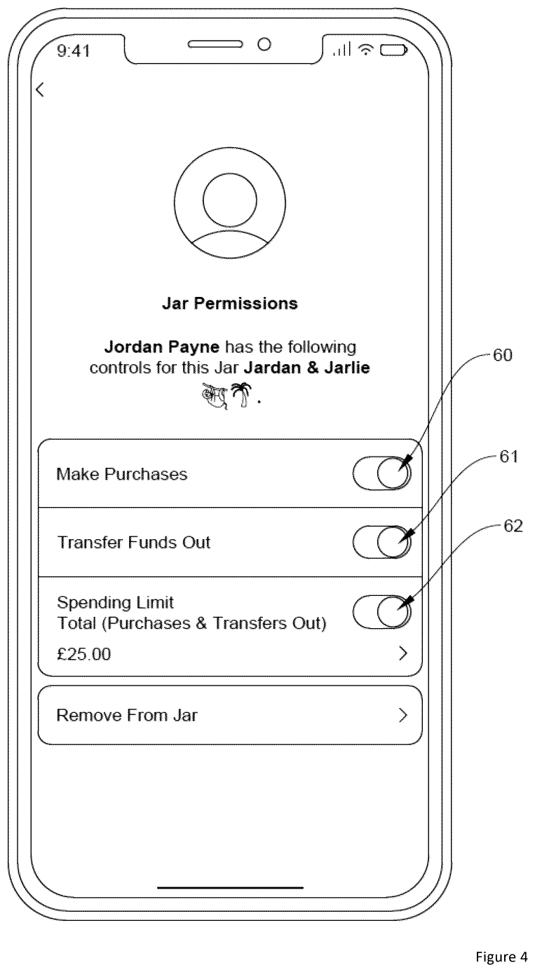

FIG. 2 illustrates another overview of the high-level architecture of the HyperLayer system. Whilst the FIG. 1 schematic of the high-level architecture is more technically detailed, FIG. 2 may nevertheless be helpful. In FIG. 2, we conceptualise the HyperLayer system as made up of a data lake 40, that corresponds to the intent data 21, 24 and meta-data 22 data stores in FIG. 1. It also includes various accounts (the customer root account, sub-accounts and account sub-divisions; the data defining these accounts resides in the data lake 40. The HyperLayer system includes a rules engine 37, that corresponds to the rules engine 25 in FIG. 1, and a rewards engine 35 that processes and allocates rewards: an example could be where a merchant offers a customer a £10 discount if they spend more than £100 with the merchant by a certain date; these requirements are stored in the data lake 40, and the rewards engine 35 works out if that discount should be applied to a transaction, and if should, then the rewards engine 35 applies it in real-time. The HyperLayer system also includes a sharing module 34 that applies sharing rules or permissions that enable different users to have access to a specific sub-account or jar (e.g. read only, or contribute, or spend-see also FIG. 4). The HyperLayer system includes a processing layer 41 that processes all events and constructs messages. External systems that are linked to the processing layer 41 via APIs 32 include a store of value 31 (e.g. a conventional bank account), merchants and other value redemption channels 33, and external reader only accounts 36.

The high-level functions implemented by the HyperLayer system may include one or more of the following:
The system may connect to an external store of value.
An API may be used to connect to the external store of value.
The system has a two-way connectivity with external store(s) of value and the external channels used for redeeming elements in the store of value.
The processing engine has a root-level customer/entity account. This can be linked to multiple external store of value accounts.
All customers may have one core virtual account for each store of value linked to their root or primary account.
Customers can sub-divide their core store of value virtual account into multiple sub-divisions or ‘pots’ or ‘jars’ that each represent a store of value.
Each sub-division or jar may have a unique ID, so that payments from other users can be pointed directly at a jar.
An end-user can create or define sub-account holders that are linked to their root account. This creates a virtual account for the sub-account holder who (with permission) can create sub-divisions like a primary end-user.
An end-user can share a sub-division with any number of other end-users, creating a shared pool of value. The end-user sharing the sub-division is the nominal owner and can permission functionality to other end-users.
Permissions or rules for sub-divisions may be for example: read; message others in the sub-division; add to store of value; spend from store of value; invite other end-users or admin.
All end-users profiles and actions are recorded and/or stored in the HyperLayer data lake or IDL. A rewards engine, with publisher and end-user permission, can query the data lake to build an anonymised cohort matching the specified query for targeting with messages and rewards.
A rules engine is an arbitrary, multi-variant processing service that operates over actions performed by end-users and on transactions as they occur within the system:
   3rd parties such as merchants can set up rules related to rewards and when they are allocated and when they are redeemed.
   End-user can set up rules related to transaction routing, blocking and/or scheduling.
An ‘External Account’ can be added to an end-user's root account. These objects allow an end-user to view the value in an external account, even if they may not be able to directly act on it within the HyperLayer environment. These are useful for when a customer may want to transact with these accounts using one of their stores of value or to initiate an outbound transaction. As an example, the external account could be an energy company account showing the balance owed. The customer can then initiate an outbound transaction in the HyperLayer to reduce that balance.

### Additional Functionalities May be Available, Such as, but not Limited to:

The end-user can spend directly from any sub-accounts or jars of the root or primary account.
‘Indirect’ debit function is available, in which the end-user is able to identify a specific sub-account or jar from which direct debits to a specific merchant are permitted (e.g. electricity supply) and then future direct debits are taken directly from this specific jar, and subject to any rules or pre-set conditions the end-user has defined for this jar or direct debits from this jar (e.g. only permit a direct debit if the amount in this jar exceeds £X). This means the primary or root virtual account then debits when the direct debit is presented by the merchant, but only if the end-user's pre-set conditions are met. This can be seen as an ‘indirect’ debit of the master or root primary virtual account, as well as the bank account to which this account is linked.
The system enables the processing of direct debits on behalf of a specific merchant. The merchant may send a direct debit signal to the system that detects that the end-user does not have a mandate with the merchant but is an HyperJar end-user. The system converts the direct debit signal into an IOU and surfaces this in the application as a debt owed to the merchant and allows the end-user to make part payments over time to pay-down the IOU. Payments may be scheduled by the end-user or made manually. The merchant is notified of all payments received on a scheduled basis (daily, providing end-user details and part payment amounts).
An end-user can spend directly from a merchant-specific sub-account and hence funds can be transferred very quickly from the end-user's account to that merchant, with full traceability and instant confirmation of receipt.
The rules engine can identify an end-user to a merchant (e.g. when they enter a specific store or tap a loyalty card), automatically deduct the purchase amount from the correct jar, such as merchant-specific ledger or jar, automatically apply any promotions or offers for that specific end-user (e.g. hyper-personalised promotions and incentives), automatically update the amount left in the appropriate merchant-specific ledger or jar, and, automatically update the amount left in the overall account.
The end-user can share any jars with friends and family-creating a shared ledger that captures the intent of a group of people, acting towards a shared goal.
Automatic allocation of e.g. salary into different categories of ‘jars’ is enabled and full and instant reporting is given back to the end-user. The system is also able to recommend suitable allocations.
The system is configured to tell a merchant what their likely future spend with a specific end-user will be.
The system is configured to create automatic recommendations for how a merchant can engage with a specific end-user in a way that specific end-user finds appealing.
A merchant is able to define any kind of incentive—e.g. any rules based promotion or discount (e.g. experiential incentives, save-now and buy-later, as well as more conventional % discount or a two for ones etc.) that is specific to an individual end-user or end-users that meet a demographic profile (or meet any other metadata parameters) the system captures. We enable automatic provision of incentives to the end-user who has allocated future spend to defined merchants, e.g. if you allocate your holiday ‘jar’ to TUI (and it could be called ‘TUI’ in the digital wallet) then TUI will give you 5% interest on the balance in that jar. The rules based system can also cover any sort of end-user action we are able to track—e.g. the rule can be ‘if customer does X, then we will do Y’, where X and Y are any steps that the system can automatically track.
The system enables testing and analysis of different incentives prior to the moment when an end-user actually spends their money-so we can very efficiently try different behavioural change approaches (e.g. different types of incentives) at minimal cost to explore what induces end-users (and what their demographic parameters are) to commit to allocating funds to a specific merchant or goal-oriented jar.

An advantage of the system is that it is configured to understand and shape an end-user's intent, and what an end-user may plan to do with their money prior or after they are getting it. A much deeper insight into actual and desired future actions of an entity is provided (e.g. what to spend on, whom to spend it with, and in what circumstances spend will occur). This insight can then be used to discover patterns, reveal anomalies, generate insights, make predictions and provide automated decision-making. This is made possible by allocating an entity's money to one or more specific virtual sub-accounts or jars, with meta-data attached to each jar, and executing meta-data dependent analysis. This analysis may also be made in real time.

By defining one or more features of an entity's future intent, such as an end-user's intent, the system is able to capture and/or influence any actions of the end-user much earlier than the actual point of sale, i.e. at the moment of intent e.g. when the end-user starts the process of deciding what to spend their money on and may well be most open to influence and direction. The time of the actual sale transaction may therefore be later- and possibly far in the future.

An advantage of the system is that it makes it easier for an end-user to discover, articulate and also commit to a specific Intent, e.g. through gamification and other behavioural change triggers. The system also provides a way for changing a customer's behaviours.

Another advantage is that an end-user's account can be hyper-personalised based on the end-user's intent. The data-analysis environment includes a data record for a root or primary virtual account for the end-user. The end-user is then able to define any future spend sub-accounts as they want, each specific to their future spending intent. The sub-account may be a ledger entry recorded in a database or a virtual sub-account or a digital ‘pot’ or ‘jar’. This primary or root virtual account is sharded into multiple virtual stores or digital ‘pots’ or ‘jars’ by attributing specific meta-data to funds etc. associated with each digital jar-so a digital jar is a virtual partition of a core virtual account. All input to and output from the jars and the primary virtual account is solely through the data-analysis environment.

### 3. Overview of the Wallet Provider Application

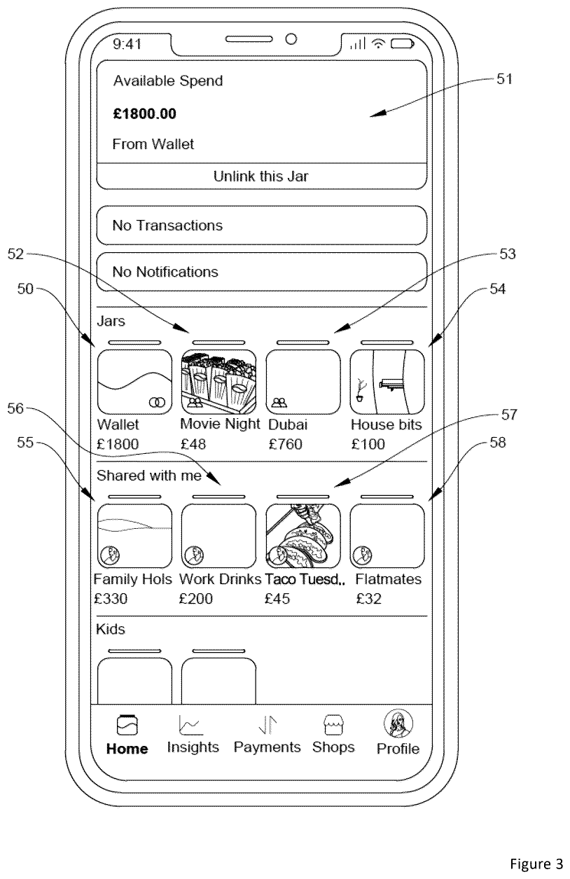

The following FIGS. 3-10 include provide screenshots of the HyperJar's end-user wallet app that is designed to make spending-money go further by helping everyone plan, budget, share and control their funds and by delivering easy access to highly valuable rewards and services.

FIG. 3 provides a screenshot of a page of the end-user wallet app that enables an end-user to open as many sub-accounts or jars as they want and to spend directly from any jars.

The end-user first downloads the wallet app to their smartphone, and then has to transfer money to the wallet from an external store of value (e.g. a conventional bank account). In this example, the end-user has transferred £1800 into the wallet sub-account or ‘jar’ 50. This amount is available to spend using a dedicated HyperJar debit card, or the wallet can be linked to a different payment system, such as Apple Pay, so that when the end-user pays for something using Apple Pay, then the amount automatically debits from the HyperJar wallet. The wallet app always displays the amount 51 that is available to spend from the wallet jar (this is money that has not been allocated to other jars). The end-user wishes to better manage their spending, and sets up specific sub-accounts, or jars, for the following categories: movie night (current amount available in this jar £48); a holiday to Dubai (current amount available in this jar £760); house bits (current amount available in this jar £100). These amounts could have been transferred from the wallet jar manually by the end-user, or could have been transferred automatically using rules applied by the rules engine: an example could be where the end-user's monthly salary is paid into the conventional bank account, but every month £2000 is automatically transferred to the wallet jar, and £50 a month automatically transferred to the movie night jar, £100 a month automatically transferred to the Dubai holiday jar, and £50 a month automatically transferred to the house bits jar. This way, the user can ensure that they are automatically saving for the important things (both short term, like regular movie nights, and long term, like a major holiday), and also gets much better control of their spending.

Another example: the end-user might be concerned that they are spending too much at their local pub; they can set up a ‘pub’ jar, put into it from their wallet jar what they think is a reasonable amount for a monthly spend at the pub, and set up a rule that any spend using their HyperJar debit card at that pub automatically debits from the ‘pub’ jar. Using HyperLayer capabilities, the HyperJar wallet can analyse each payment request made using the HyperJar debit card for the 4 digit MCC (merchant category code); for bars it is 5813. So every payment request with MCC 5813 is automatically linked by the HyperLayer rules engine to the ‘pub’ jar and, if there are sufficient funds in that jar, payment is authorised and the value of that pub jar is automatically decreased by the payment to the pub. If there are insufficient funds in the pub jar, the end-user could set up a rule that the payment should be declined, forcing the end-user to pay using another means, or they could set up a rule that the payment is made from the pub jar to take the amount in that jar to zero, and the unpaid excess comes from the wallet jar. They then have complete visibility on what they are spending, and can try to modify the amount they are drinking to keep withing the budget they have set themselves.

FIG. 3 also shows how ‘shared jars’ are possible: shared jars are jars that are accessed by several people, forming a ‘Social Spending Group’. The point of a shared jar is for a group of people to come together and build up a sum of money for a specific purpose that they all participate in. Four shared jars are shown: family holidays 55 (amount available is £330); work drinks 56 (amount available is £200); Taco Tuesday 57 (amount available is £45); flatmates 58 (amount available is £32). Each user of the HyperJar wallet may have manually transferred money from their wallet jar to one of these shared jars, or money may have been transferred automatically using the rules engine.

FIG. 4 provides a screenshot of a page of the end-user app that shows the permissions or rules for a shared jar called ‘Jardin & Jarlie’ for one end-user, Jordan Payne. Jordan has permission. to make purchases 60, to transfer funds out 61 and is subject to a spending limit 62 of £25. These rules are stored in the intent data store and are applied to transactions affecting this ‘Jardin & Jarlie’ jar by the rules engine.

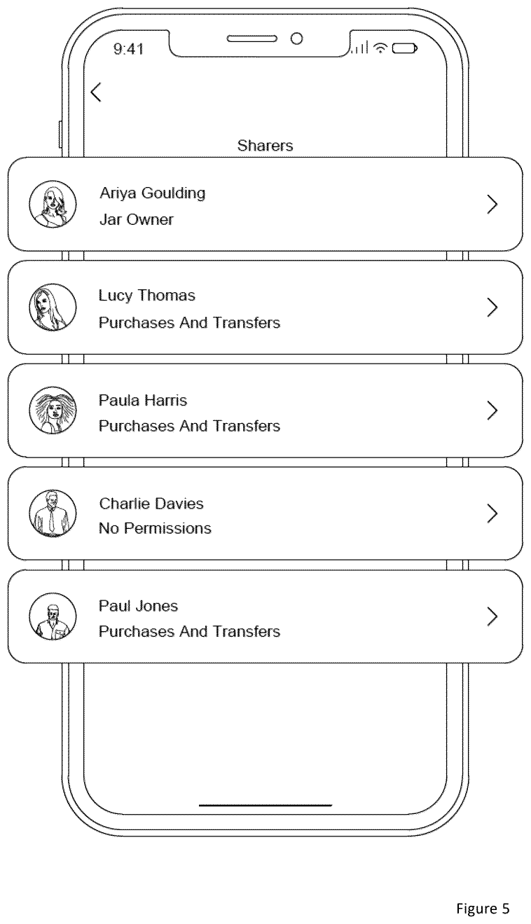

FIG. 5 shows how the wallet app can display all the members of a shared jar, and the permissions that apply to each of them. Each shared jar can be shared with any number of users such as friends, family or kids, with each user having a set of permissions or rules as provided by the jar owner. Jar permissions may include for example the authorization to make purchase directly from the jar, the authorization to transfer funds out of the jar, a maximum spending limit, with each permission being associated with a specific time period or time limit. These rules or permissions are stored in the data lake and applied by the rules engine to permit or block transactions affecting the shared jar.

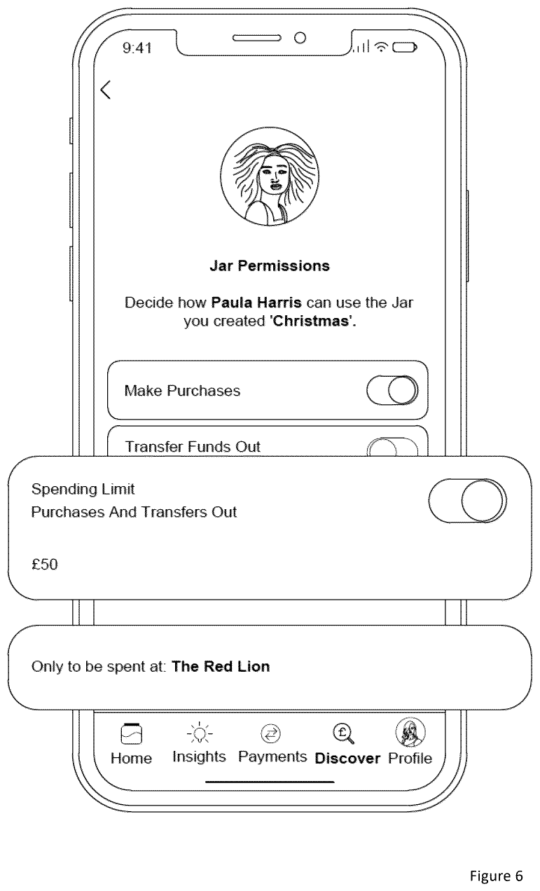

As shown in FIG. 6, the jar owner may also require that a user only use the available fund at a specific merchant. In this case, the jar creator is able to decide how Paula Harris can use the shared jar called ‘Christmas’: in this case, Paula Harris is able to spend from this jar only at a pub called The Red Lion, and can spend a maximum of £50 there. The shared jar may also be used to set limits and goals as a group. These rules or permissions are stored in the data lake and applied by the rules engine to permit or block transactions affecting the shared jar.

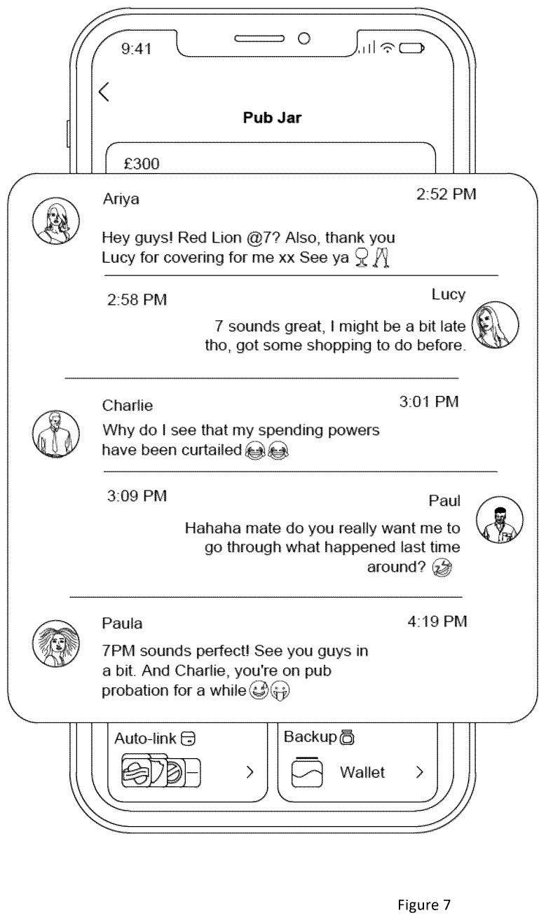

As shown in FIG. 7, the HyperJar wallet app also enables messaging in shared jar in order to drive active engagement. HyperLayer is essentially also providing a form of messaging middleware, sending messages to and receiving messages from legacy banking systems and legacy payment systems. HyperJar use the HyperLayer messaging capabilities to provide all members of a shared spending group, i.e. users who are all linked to a shared jar, with the ability to send messages that are linked to that shared jar. In FIG. 7, a shared jar called ‘Pub Jar’, can be opened to show a thread of related messages from several members of the shared spending group for that jar.

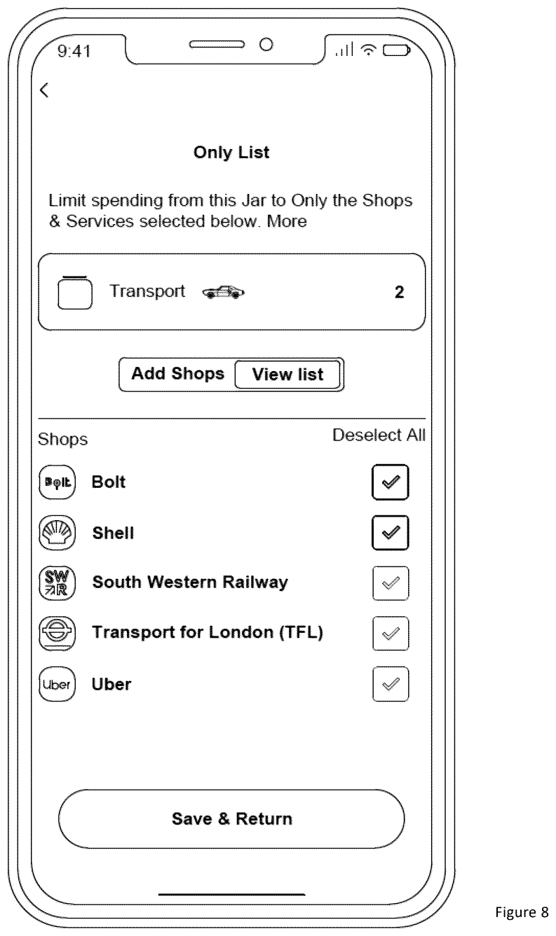

FIG. 8 provides a screenshot of a page of the end-user app that enables an end-user to block or restrict where money in a jar can be spent. The end-user is able to control and automate any financial activity by time or event triggers. In this case, for a jar called ‘Transport’, spending is possible at the five listed entities; two of these (Bolt and Shell) have been marked for deselection from this list.

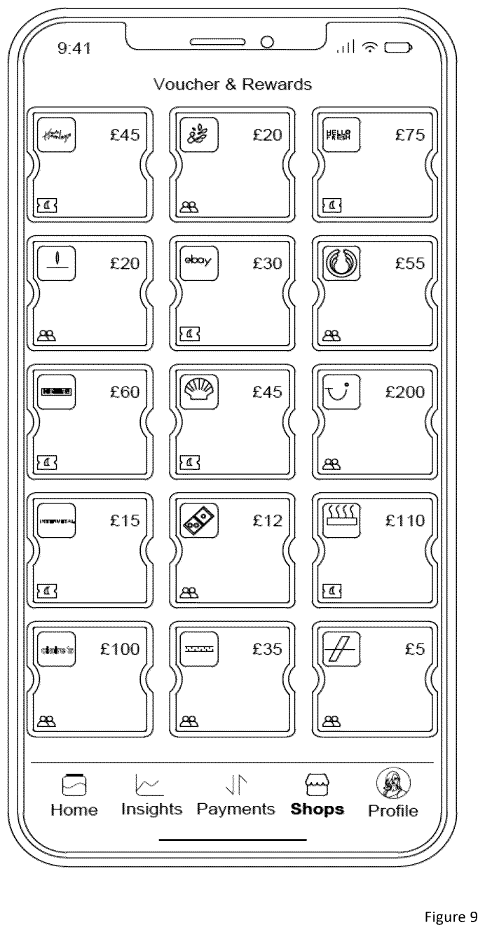

FIG. 9 is a screenshot of a page of the end-user wallet app that displays the merchant loyalty rewards, and vouchers that the user has collected or earned. Each reward includes an icon for the merchant where the reward can be redeemed. When the user buys, using their HyperJar debit card, something from a merchant for which that user already has a voucher or reward, then the voucher can be automatically used as the first priority for payment, with any excess debited from a specific jar, or the wallet jar; this is another example of a rule that can be set up and stored in the data lake, and applied by the rules engine. It eliminates the needs for paper coupons, and makes spending vouchers or coupons automatic and stress free.

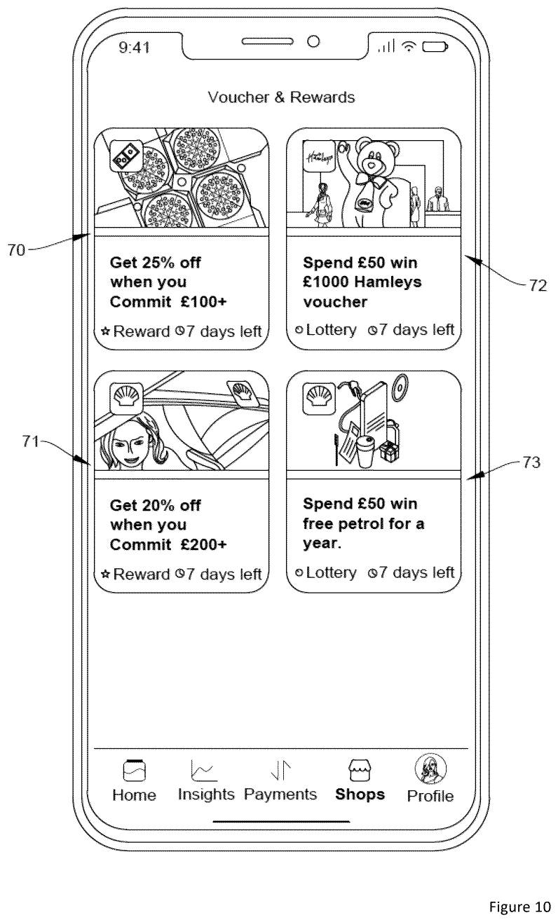

Conventional vouchers and rewards are usually just simple discounts. FIG. 10 shows how far more engaging vouchers and rewards can be designed using the HyperLayer system, leveraging for example the ability in the HyperJar wallet for an end-user to commit to be spend at least a pre-set amount of money with a specific merchant. One voucher 70 is for a £25 discount when the user commits to spend £100 with a specific merchant; this is possible using HyperLayer capabilities because a user can set up a jar that has a rule that it can only be used for purchases at a specific merchant, with the identity of that merchant stored in the data lake; equally, that merchant, can, construct a voucher designed to appeal to that user—in this case, the £25 discount when the user commits to spend £100. So the user can set up a jar for this merchant, place £100 in that jar, obtain the voucher (generally available without charge), and when they spend £100 at the merchant with their HyperJar debit card, HyperLayer automatically verifies the eligibility of the transaction and ensure that it comes from a jar for which a rule is in place that limits spending solely with that merchant (e.g. that rule could be part of the data or meta-data available to the merchant). and at the point of sale, the £25 discount is then automatically applied. Similarly, another voucher 71 is for 20% when a user commits to spend £200. The ability for a user to express their intent and commitment to use a jar solely for a specific merchant, and subject to any conditions set by the merchant and that can be automatically assessed by the rules engine in the HyperLayer system, enables a far greater variety of vouchers to created.

Other examples of discounts do not require a prior commitment or intent to spend with a specific merchant. For example, lottery type rewards are possible, where the user has a chance but no certainty of winning the reward. Voucher 72 specifies that if the user spends £50 at toy retailer Hamleys, they will be entered into a lottery to win £1000. Because HyperJar stores this voucher as one of this user's vouchers and can also track any spend of £50 or more at Hamleys, since this is all part of the data or meta-data for a purchase transaction that is captured in the data lake, the rules engine, can, when it sees such a transaction, send a message notification to Hamleys giving the details of the user and when they spent £50, and the details of the voucher. Similarly, voucher 73 is another lottery that provides for anyone with the voucher and who spends more than £50 with Shell, enters a lottery to win free petrol for a year. Again, this relies on the data that is captured in the data lake, the real-time rules engine able to determine if any transaction meets the conditions defined by the merchant (in this case, £50) but any conditions can be applied (e.g. date, location, type of goods etc.) In all cases, the HyperLayer rules engine, including the defined priority of payment for the HyperJar publisher is assessing transactions in real-time and utilising the appropriate stores of value to approve the transactions.

To re-cap, a seamless end-user experience at the point of sale is provided, with intent being processed in real-time together with highly complex multi-party instructions for a scalable number of users and merchants.

A merchant application also enables the merchant to set up their own rules or permissions. All the rules can be run for millions of end-users and thousands of merchants in real time, in milliseconds, at the point of sale. Active rewards are therefore processed in real-time providing earn and burn in a single transaction.

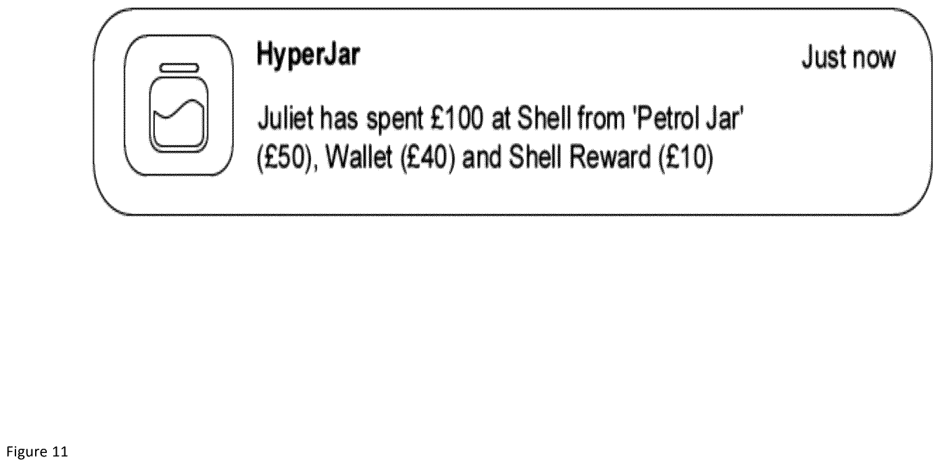

As an example, a user-story is now described in which a shared ‘family jar’ has been shared among multiple users:
Merchant decides to give customers £10 off on their 6th spend over £50 on petrol with that merchant;
HyperJar determines that client A is eligible for the £10 merchant reward voucher by automatically analysing the transaction history data held in the data lake (the meta-data captures all the amount and date and merchants for all transactions for petrol; the rules engine determines that the £10 merchant reward should be automatically sent to client A and client A's data lake and digital wallet updated);
Client A receives the offer with HyperJar with the £10 reward voucher now visible in their digital wallet, and decides to spend £100 and fill up the petrol tank with the reward;
Client A has set up a rule to take the merchant payments from a shared ‘Petrol Jar’;
HyperJar checks the balance and permissions set by the shared ‘Petrol jar’ owner when the time comes to pay for the petrol;
The owner has given permission to client A to use the ‘Petrol jar’ but only for petrol and only for £50;
Client A has set up a rule that says that if there's not enough money from her shared ‘family Jar’ then to take the rest from Client A's wallet;
HyperJar processes the transaction as shown in FIG. 11.
£100 is spent on fuel in this transaction: HyperLayer's rules engine automatically allocates payment to a set of sub-transactions as follows: a £10 reward discount from the merchant, £50 from the shared ‘Petrol jar’, and the remaining £40 from Client A's wallet.

Hence the system is an open-loop system that includes any number of end-users and merchants and that provides a payment channel with 100% attribution.

The API-based modular tech stack provides valuable capabilities to all large customer business, not just banks, such as:
Point of save: deposit money in savings/investment account;
Point of deposit/withdrawal: withdraw to HyperJar spending account;
Point of intent: plan, budget, share and control money-provide advice & services around planning intent data;
Point of spend: purchase desired good or service-provide services around spend data.

### 4. Intent: A Multi-Factor Approach

FIG. 1, discussed earlier, shows how ‘intent data’ 21 is stored in the data analysis environment 9 of the HyperLayer system. We have also given examples of how the HyperLayer system enables intent data to be created and used. For example, we have discussed how a user can commit funds to be spent on a specific activity or with a specific merchant; this is done by the user setting up a jar for that specific activity or specific merchant, and adding a rule that spending is only possible where the spend transaction meets pre-set requirements, e.g. has meta-data that defines the transaction as relating to that activity or merchant. This is one way that the HyperLayer architecture enables users to express their future intent. In this section 4, we will look at ‘intent’ more generally. Appendix 3 has more detail on consumer intent, and Appendix 4 has more detail on merchant intent.

Currently, banks are focused on inputs—deposits and lending—and not on helping people deploy money better. Lending models such as ‘buy now, pay later’ (BNPL) encourage people to be unintentional, e.g. spontaneous in their spending decisions, which can lead to excessive debt. Spending ‘intentionally’ maximises the value and visibility of money, improves financial and mental well-being, reduces unnecessary debt, creates confidence and control. However, being intentional with money is made harder with the digitisation of spending, the decline in use of physical cash, proliferation of subscriptions, easy availability of credit though embedded finance and/or the cost of living crisis. And it requires a data processing architecture that is very different to the conventional core banking technology. The HyperLayer system is that data processing architecture; it aims to help people to deploy money better and to spend, budget or save intentionally.

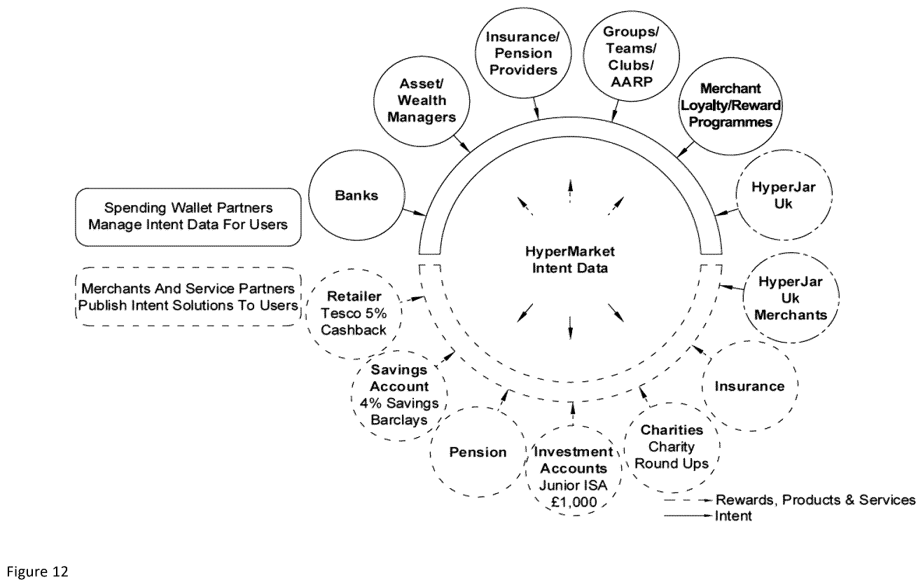

FIG. 12 shows a diagram that illustrates the ecosystem of intent data. The way that the system focusses on INTENT may be thought of as the interaction between each of:
Boundaries and Partitioning;
Sharing;
Control & visibility;
Conditionality.

Note that the HyperLayer data processing architecture makes these interactions possible (see Appendix 1 for the relevant Key Features of this data processing architecture).

We will discuss now each of these four items.

### Boundaries

Intent captures or defines all of the things a person or entity can think of doing with its money before it leaves its ‘boundary’—i.e. where the ‘boundary’ is the edge of the region where money is wholly within the entity's control. So things at the boundary may be ATM cash machines, credit cards, standing orders, direct debits etc. Conventional bank thinking says that everything inside a person (or a company's) boundary is not something they can influence or organise—it sits wholly outside of their IT infrastructure; the conventional IT infrastructure implements money flows from one entity to another—i.e. from one boundary to another boundary—this IT infrastructure does not extend to inside any boundary. But in HyperLayer, we build an IT infrastructure that mirrors or captures what is inside this boundary and this in turn means that the IT infrastructure can capture and track the end-user's intent (e.g. what the end-user would like to do in the future).

### Partitioning

Within a boundary, HyperLayer enables an entity's money to be partitioned into any arbitrary number of shards; this is done by enabling an entity's money to be allocated to specific jars, with meta-data attached to each jar; each jar represents a unique shard.

### Sharing

We can think of a boundary as personal or localised to a specific entity (e.g. a person or company). We can also think of a larger ‘super-boundary’ that extends to every entity that the specific entity might interact with too. In HyperLayer, we build an IT infrastructure that captures and tracks what is inside both the local boundary and also this larger ‘super-boundary’ to enable sharing or transfer of spending capability between individual local boundaries.

HyperLayer allows any jar associated with an entity to be shared with anyone else within the ‘super-boundary’ of that entity. So any number of people can share any number of jars belonging to anyone else, so long as they are all within a common super-boundary; a single entity has full control and visibility.

### Control

Within a localised boundary or across multiple local boundaries, we define the concept of ‘control’: this is the ability of an entity to both determine the purpose for that entity's cash (including specific amounts of cash) and also to ensure that the cash is used only for that purpose; it combines intent with control. A single entity has full visibility on when money is spent and what it is spent on. Hyperjar enables tracking of payments at the merchant, MCC (Merchant Category Code) code and also SKU (Stock Keeping Unit) level—i.e. the HyperLayer system tracks in real-time all proposed transactions at a merchant and can execute meta-data dependent analysis in real-time to determine if the proposed transaction can complete or not, so enabling HyperLayer to give control to an entity over whether a proposed payment for a specific merchant, or class of merchants, or for a specific type of goods or a specific SKU or brand, should actually be processed or not. So HyperLayer can permit spending for example from a specific jar only at a specific merchant (e.g. only at LIDL) or only for fresh fruit and vegetables, or for anything except alcohol, or for specific brands, or for anything apart from specific brands, or any combination of these variables.

Because HyperLayer can implement controls at this level, it means that an entity can give e.g. direct debit or credit cards to anyone, and yet have full visibility and control over their use (e.g. at the merchant, MCC code and also SKU level). So the entity is still the sole legal account holder, but can give debit or credit cards to anyone (including the unbanked, such as children, or to carers, cleaners etc.) and have full visibility and control over their devolved spending. This can also work cross-border-so a charity for example in developed Country X could give debit cards to the unbanked in developing Country Y, and have full visibility and control over what the unbanked spend on. This is also another aspect of ‘intent’-here the intent of the account owner is to contribute directly to the health and well being of unbanked individuals in developing countries whom they have never met.

Because HyperLayer can permit payment from a specific jar solely to a specific merchant, this enables the merchant to establish a relationship with an entity at the point in time when the entity merely intends in the future to spend with that merchant (‘Merchant Intent’)—so an individual can create a jar for holiday savings and commit to spend that with a specific tour operator (say TUI). That in turn enables the merchant to reward or incentivise that commitment (e.g. discounts etc). And it also means that the HyperLayer system is in effect creating ‘Merchant Currency’—i.e. money that is allocated to that merchant (e.g. is meta-data tagged as available to spend only with that specific merchant) and can only be spent some time in the future with that merchant.

### Conditionality

Conditionality is a specific instance of control: it captures an intent that is conditional on some event or trigger—e.g. “If I have £X in a specific jar, then I will save it for purpose Y”; or “If I have £X in a specific jar on date A, then I will allocate it to a different specific jar”; or “If I have less than EX in total, then I will not do Y”.

Conditionality enables sophisticated, personalised security or trust approaches—for example, an end-user might say that proposed payment or withdrawal amounts over £X, defined by the user, to anyone other than specific named accounts or individuals are blocked unless a specific set of actions, again defined or approved by the end-user, are undertaken. So this can be personalised to the end-user's specific needs, because of the flexibility of the rules-based conditionality engine (rules engine 25 in FIG. 1).

Indirect Debit is a function that flows from the conditionality engine in HyperLayer. It enables an entity to permit a direct debit payment to be made only from a specific jar; it can also be permitted to come only from a specific jar and only if the amount in that jar exceeds a given amount, or there are sufficient funds in that jar to meet that direct debit request or for a whatever is in that jar, or some specific amount to go towards part settlement of the direct debit payment request. Merchants greatly prefer direct debit payments, but many bank customers simply don't have a sufficient float to ensure that direct debit payments can all be honoured and so they just rely on paying in response to bills (or late payment demands etc-which is very costly for the merchant). With the Indirect Debit approach, the merchant gets the efficiency of direct debit payments, and more money with less administrative cost than it would get if the end-user instead just waited until it had been chased multiple times, and the customer gets the control needed to ensure that the direct debit payment is affordable, automatically taking account the varied and unpredictable state of their finances.

Intent can therefore be derived from any actions a customer makes using the various levers of the system, such as:
Merchant offers and rewards;
Permissioning others;
Sub-accounts;
Other SoV they connect;
Other financial objects they connect for viewing.

### Some Examples of Capturing Intent are Now Described:

a customer can commit money to a specific merchant and may hold the amount of money in a single account. Therefore, the system is able to determine that the customer intends to spend at the specific merchant at some point as it can only be spent there.
a customer can share their wallet with other people and restrict their spending capabilities using permissions. Therefore, we know they intend to allow these people to have access to their funds and depending on the permissions they grant, where that money can be spent and how much.
a customer can pick up rewards presented by merchants in the ‘store’; this is an indication they have an interest in this merchant and an intent to spend in the future (not as strong as committing money, but still there).
If the reward they pick up is say a stamp card (spend 5 times and get the reward) we can infer that they intend to spend multiple times at that merchant
Forecasting based on pervious behaviour is also built up over time, in order to predict the customer's intent (and possible areas of interest) and therefore nudge them with offers and rewards.

### Open Banking/Open End-User

As a comparison, conventional banks have huge and complex legacy banking IT systems and it is very complex to alter their core technology. The HyperLayer system constructs what is in effect a virtual environment in which several technology improvements (technology improvements in data analytics, machine learning, zero-trust architectures and in customer on-boarding and account personalisation) can be implemented and explored, and offered to the customers of a large banking incumbent, yet without having to alter the core technology of that incumbent-instead, there is a simple data connection from the HyperLayer system to the customers' accounts, running on the legacy banking system, and all the innovation and experimentation can then occur within the HyperLayer environment. So the HyperLayer environment acts as a middleware, insulation or abstraction layer, with the core legacy banking technology now insulated from the environment, the HyperLayer environment, in which the IT systems implement several features (e.g. capturing end-user intent in customer defined virtual ledgers or jars, the conditionality engine which enables rich and responsive rules-based payments and merchant intent etc). This enables banks to embrace emerging technology and to understand end-user requirements rapidly: better understanding the entire customer journey through the perspective of the customer—the ‘open end-user’, yet without having to re-design their core technology or indeed go through the pain and complexity of executing the design and implementation of these new technologies.

### 5. Cloud Infrastructure and Deployment

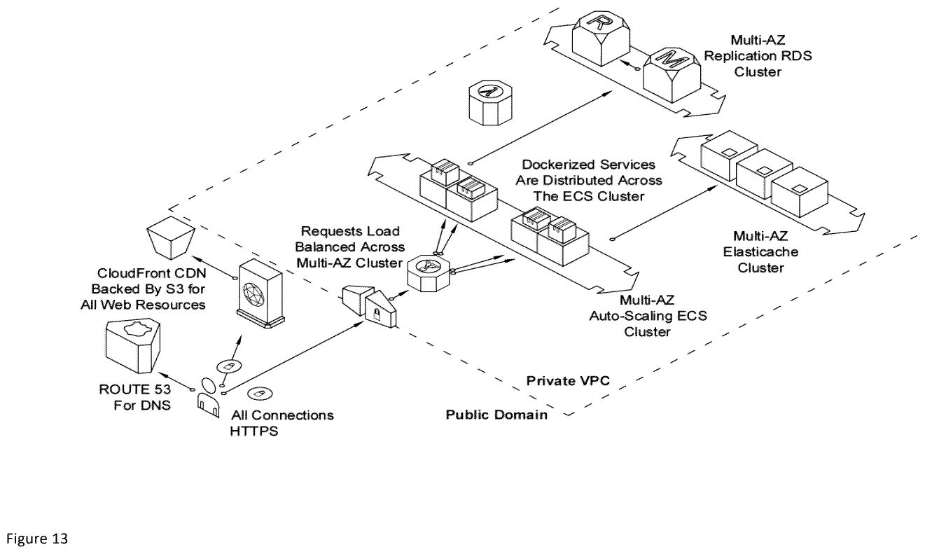

FIG. 13 is a diagram illustrating a high-level view of a possible cloud computing infrastructure, such as AWS. Some subtleties are hidden. In the example provided, all services are within a private cloud (VPC). All public access is HTTPS to an API Gateway which forwards to a private Load Balancer. All layers are independently scalable horizontally and vertically.

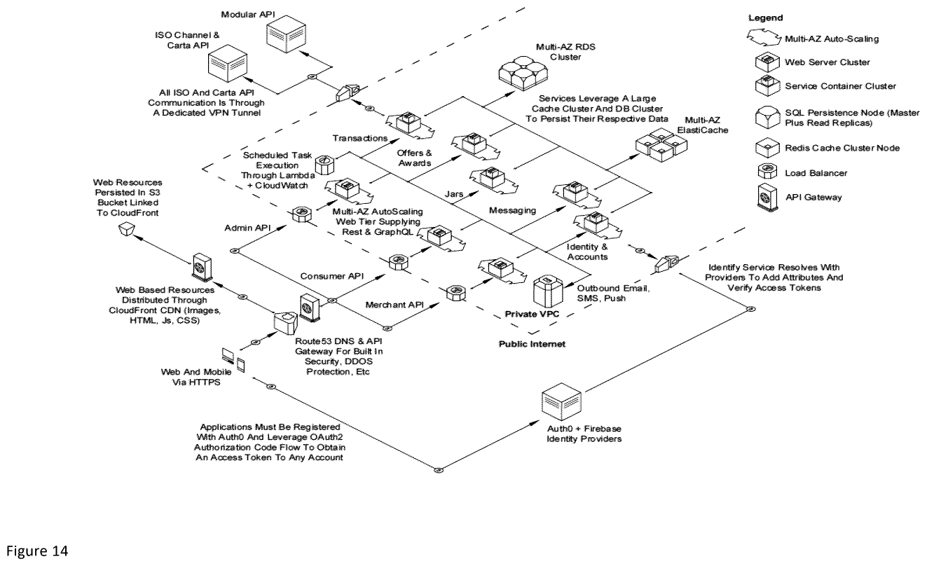

FIG. 14 is another diagram illustrating a more detailed view of the cloud computing infrastructure, in which each service can sit within its own cluster and is scalable on its own.

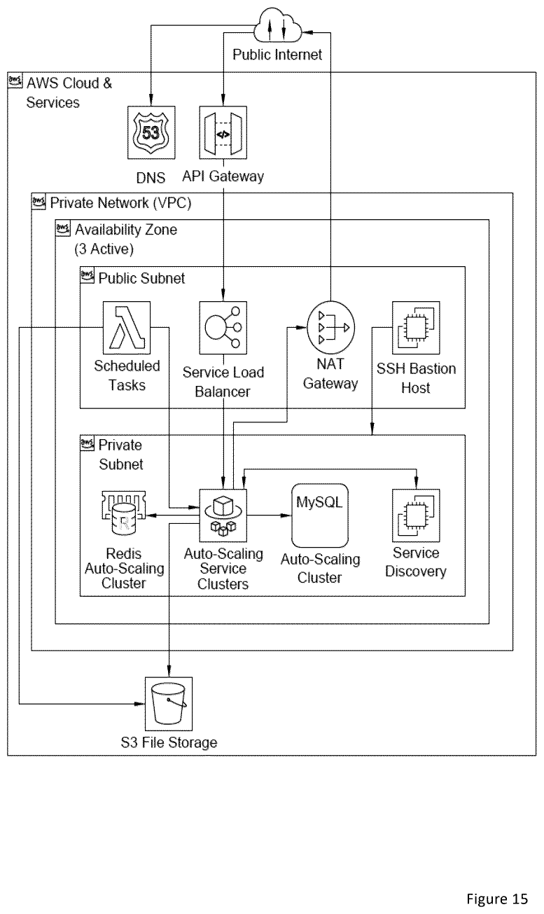

FIG. 15 is an overview diagram illustrating the VPC configuration. A single VPC setup is provided in EU-WEST-1 (Ireland) region of AWS. Within this VPC, there are three active Availability Zones for high availability within the region. Each availability zone is split into a public and private subnet. The only access to the private subnet is through the public one. All services run within the private subnets to shield them as much as possible. Each service also has it's own security group to further limit exposed ports and allowed CIDR ranges for communication

A cloud monitoring service may be used to actively monitor many facets of the system including, but not limited to:
Monitor CPU, Memory, and Storage across each service;
Monitor API endpoints from the server's perspective for response times, HTTP error counts, 99th/95th percentile;
Inner code components report custom metrics around processing time and volume of data;
Any other data collected from the cloud computing infrastructure services;
Log collection/aggregation from all our services;
Initiate recurring/scheduled tasks like data exports, data imports, lambda functions, etc.

### 6. Use Cases: HyperLayer Examples

We now describe several use cases.

The purpose of the following use cases is to describe how the various components of the system interact to provide the overall service to customers. The list is not intended to be exhaustive and, importantly, individual use cases can be combined to create composite user experiences that utilise a range of the services in more complex ways.

For all use cases, it is assumed that a customer has completed registration. This takes place by the customer undertaking the registration process to become a Primary customer. During the sign-up process HyperLayer registers the customer with a Store of Value provider (or multiple) (e.g. a bank, crypto exchange etc.) to generate account details for the customer to use for paying into their Store of Value. The app that the customer uses is the HyperJar wallet; the related physical payment card is the HyperJar card.

### We May Refer to the Following Actors:

Contact: a person known to the customer and whose details, in the form of email and/or phone number, is stored in the customer's phone.
Crypto Exchange: a store of value provided by a third-party that holds digital currency that can be used to conduct transactions.
Customer: an individual or business that has an account in the HyperJar system.
Merchant: a third-party providing goods or services to a Customer, and who also has a relationship with HyperJar, and takes payment for the goods or services at the point of sale.
Payment Card: a physical or virtual card issued by HyperJar to the Customer.
Primary Customer: a Customer who has on-boarded to the service in their name. Depending on the services they require, they may or may not have had their details confirmed.
Secondary Customer: a Customer that has a sub-account created for them by a Primary Customer and sits below the Primary Customer's primary account.
Transaction Processor: a third-party processor connected to a Value Redemption Channel. There may be multiple Transaction Processors involved in the redemption of an amount from a Store of Value. E.g., in the Mastercard world a “card” transaction occurs between the merchant and the card issuer, where there is one Transaction Processor that has the relationship with the Merchant and one Transaction Processors has the relationship with the Customer.

### Some General Notes on the Use Cases Examples Provided in the Following Paragraphs:

In most cases, the Store of Value will be a currency-denominated bank account. Therefore, HyperJar will issue the customer with a bank account number for them to use.
The Core Virtual Account linked to a Store of Value is called a Wallet.
Account sub-divisions are ‘shards’ from a Core Virtual Account linked to a Store of Value. These can be visualised in any way. The current HyperJar app has these visualised as Jars and vouchers.
Vouchers have a monetary value that can only be spent at a specific Merchant and are purchased by a Customer or given to the Customer as a gift.
Sub-division sharing allows a Customer to share an account sub-division (Jar or Voucher) with any number of other customers.
In the use cases, where transfers between jars are concerned, there is no funds movement unless there is a transfer between Customers. If a Customer is transferring money from their wallet to another one of their jars, this is a journal entry made by HyperLayer in the Customer's Core Virtual Account for that Store of Value.
For the sake of brevity, not all of the details and actions are repeated in each use case. The reader should assume that a detailed explanation in an earlier use case is the same way an action works in subsequent use case descriptions.
For merchant controls on jars, ‘Only’ settings means that only the listed merchant(s) can use the funds in the designated jar. ‘Never’ settings means that the merchants in the never list cannot spend and funds from a designated jar.

### The Following Use Cases are Described:

Customer planning;
Shared planning & spending;
Transaction routing;
Scheduled payments;
Sub-accounts;
Merchant control;
Interactive direct debit;
In-direct debit;
ISA account visualisation;
rewards;
Crypto exchange usage;
Multi-store of value rules.

Note that the above defined terms are generally not capitalised in the following text.

### Customer Planning

A customer wants to plan their personal spending by splitting their funds into different pools of money to be used for different spend categories. They don't want to be able to spend more on their takeaway meals but want a bit of leeway on petrol. The customer transfers funds from their external bank account to the account details provided by HyperJar. The Store of Value communicates with HyperLayer to notify HyperJar that funds have arrived. HyperLayer notifies the customer that funds have arrived in their core virtual account via a push notification. The customer creates account sub-divisions so they can split the amount received into different jars—e.g., Groceries; Petrol; Takeaways etc. to plan their future spend (the customer can create these sub-accounts at any time including before funds have arrived). Because they want a bit of leeway on petrol, they set their petrol jar to allow funds to be taken from the wallet if there is not enough money in the petrol jar. For all other jars they do not allow this.

When the customer goes to a merchant, they link their payment card in the HyperJar app to the jar they want to pay from so they know they cannot spend more than they have planned for. The transaction processor(s) route the spend transaction to HyperJar for approval. The transaction is received via the value redemption channel and passed to HyperLayer. HyperLayer checks the settings for the customer (including where the card is linked to) to see if the spend can be approved, if there is sufficient funds in the linked jar (and if set, from the wallet like in the case for petrol), or declined if not.

### Shared Planning & Spending

A customer is part of a group of parents that want to buy their children's teacher an end of year gift from the John Lewis department store and want an easy way to collect the funds.

The customer creates a jar called ‘Teacher's Present’ and in the jar settings chooses to share it with the other parents. The customer can see which of the parents in her contact list already have HyperJar and sends them a link to the jar. One parent asks the other parents if they have HyperJar and a couple of them say yes; she shows them the QR code for the jar and they scan it in their HyperJar app and are added as sharers. For those that don't have it she asks for their numbers to send them a WhatsApp link to download HyperJar and join the jar.

For each sharer in the jar, the customer sets permissions to restrict what they can each do. The parents agree that the customer and one other can purchase the present, so the customer blocks all transfer and spend activity for the group and enables one other to spend only. Just to be extra sure the customer also adds John Lewis to the only list so that the funds in the Jar can only be spent at John Lewis. All of these settings are processed by HyperLayer into the Rules Engine.

Each of the 10 parents add £20 each so the jar holds £200, and the parents agree to buy a dining set. By chance one of the parents is in a John Lewis branch and there is a flash sale going on. She messages the shared jar with a picture of the dining set and the sale price of £150. The group agree she should buy the set, but she does not have ‘purchase permission’. The customer changes the permissions on the jar so she can spend from the jar. She links her HyperJar card to the shared jar and buys the dining set.

Because there is £50 left in the Jar the parents agree to share the money amongst them. The customer presses the ‘Reconcile’ button. The rules engine instructs HyperLayer to send £5 to each of the parents Wallet and the Teacher Present jar is closed.

### Transaction Routing

A customer wants control how much they spend on Amazon every month and not allow themselves to overspend.

The customer creates an Amazon jar and sets up auto-linking so that all Amazon spends are taken from this jar automatically. They also ensure that there is no backup payment source set. Every month they put £100 into the Amazon jar on the first of the month. These details are stored in the rules engine.

During the month, every Amazon transaction they make takes funds out of the Amazon jar until the jar either has no funds available or insufficient funds for the purchase the customer is trying to make.

### Scheduled Payments

In order to automate the on-going management of the transaction routing use case detailed above, the customer uses the scheduled payment feature to automatically transfer the £100 into the Amazon jar on the 1st of the month. They also realise that they will have a big electricity bill to pay in January so don't want this Amazon transfer to happen in January. The customer utilises the payment settings on the Amazon jar to set up a monthly schedule to transfer £100 from the wallet on the 1st of the month from the wallet if the wallet contains at least £200 and the month is not January. The rule is stored in the rules engine. On the 1st of December the rules engine triggers and checks the balance in the customer's wallet. The wallet contains £300 so £100 is transferred to the customer's Amazon jar. On the 1st of January the rules engine triggers and checks the balance in the customer's wallet. The wallet contains £370 but does not pass the month check so no funds are transferred to the customer's Amazon jar.

### Sub-Accounts

A customer lives in a house with their partner and their child. Whilst the customer is the only wage earner, the partner and child do most of the household shopping. Therefore, the customer wants to enable their partner and child to spend the household budget. The customer opens the HyperJar app and creates two sub accounts linked to their GBP Store of Value by entering in their details. The details are sent to HyperLayer which generates accounts and associates a QR code with each one. The partner and their child download the HyperJar app and scan their respective QR codes from the customer's app, creating the binding between the accounts and generate virtual cards into their respective Apple digital wallets. Both the partner and the child have a core wallet account and can create their own jars from this. The customer transfers funds from their wallet to their partner and child's wallet so they can start to use their virtual cards straight away. The customer also sets up scheduled payments to their partners and child's wallets on a monthly basis, so they do not have to remember this.

### Merchant Control

A customer wants to give their child the ability to buy their lunch at school, but make sure they don't spend all their money at the local sweet shop or spend any money at unhealthy fast-food outlets. The customer creates a sub-account for their child and creates two jars for them. They call one of the jars Lunch and the other one Sweets. They also block the child from creating any additional jars. In the Lunch jar they set this so it can only be used at the School café and allow spend transactions to also spend from sub-account wallet if there aren't sufficient funds in the Lunch jar. In the Sweets jar they set it so that the maximum spend in any 7 day period is £5 and also add a number of well-known fast food chains to the Never list so that the child cannot use any of their balance in these outlets.

### Interactive Direct Debit

A customer wants to use the direct debit service for their utility bill to benefit from the cheaper prices but is worried that they will lose control of their funds. In some months they may not have enough funds in their account to make the payment and still have sufficient funds left for their other essential purchases. The customer sets up the direct debit with the utility company to use their HyperJar account details. When the mandate is set up, the Store of Value notifies HyperLayer of the mandate being received. HyperLayer sends a push notification to the customer to inform them of the mandate and asking to confirm it is correct and which jar they want to use for the direct debit to be taken from. The customer creates a new jar called Utilities for the direct debit.

The utility company submits a direct debit request into the BACS system. This is received by the Store of Value who then notifies HyperLayer that a direct debit request has been received for the customer. HyperLayer sends a notification to the customer informing them of the direct debit request (who it is from; for how much) and what they want to do. The customer can accept the direct debit and allow the funds to come from the Utilities jar; ask that the funds be taken from a different jar or reject the direct debit request. The customer does not have enough funds in their Utilities jar but has the additional amount in their wallet to approve the direct debit and instructs HyperLayer to take the funds from the Utilities jar and the remaining balance from the wallet.

### In-Direct Debit

A utility company has lots of customers who do not pay by direct debit and has to send out payment reminders and red letters to chase for payments. They want to implement a new digital version of payment collection so they can be in an interactive dialogue with their customers.

The utility company becomes a merchant on the HyperJar system and wants to use the in-direct debit service to create the digital channel with their customers. The utility company notifies their customers of this new service and encourages them to become HyperJar customers. When a utility company customer becomes a HyperJar customer, HyperLayer notifies the utility company of this via an authentication channel. At the next payment run where the customer will be billed, the utility company creates a direct debit request for the customer. The Store of

Value notifies HyperLayer that a direct debit request has been received for the customer. HyperLayer confirms that there is no direct debit mandate for the customer and that the merchant is set up for the in-direct debit service. HyperLayer creates an IOU between the merchant and the customer that the customer can see when they open their HyperJar app. The customer can now make partial payments against the IOU to payback the outstanding amount over time, rather than in a single payment, to help the customer manage their budget.

### ISA Account Visualisation

A provider of ISAs (a UK ‘Individual Savings Account’) wants to digitally engage with their customers to encourage top up payments to be made. The ISA provider becomes a merchant on the HyperJar platform and as part of their on-boarding an integration is created between HyperLayer and the ISA platform so that the HyperJar app can call the account details of a customer from the ISA provider. The ISA provider notifies their customers of the new service and encourages them to become HyperJar customers. When a customer of the ISA provider becomes a HyperJar customer, the customer can connect to their ISA account via a HyperLayer authentication. When the customer opens their HyperJar app, HyperLayer makes a call to the ISA platform to obtain the values of the ISA's held by the customer and displays these in the HyperJar app as an external financial object. The customer decides they want to make micro-payments to their ISA so sets up a round-up feature so that every card payment they make over £10 is rounded up to the nearest £5 with the extra value being transferred to their ISA. These details are stored in the rules engine. Daily, HyperLayer may create a notification report for the ISA provider detailing the round-up amounts for each of their customers and makes a single financial transfer for the total amount to them.

### Rewards

As a merchant I want to be able to influence existing and new customer behaviour by incentivising what they do and how they do it, and I want to do this prior to them making a purchase. The merchant utilises the HyperJar merchant portal to define a set of criteria for a reward. The criteria can be based on any event or sequence of events they choose. They set the criteria as “for a commitment of more than £100 at least 30 days before a purchase takes place, they will provide the customer with a 5% reward voucher on the committed amount to use on a spend of over £40. The reward is stored in the rewards engine. The merchant portal is then used to query the HyperJar data lake to proactively message customers with the offer. A cohort is created for the message based on the customer's geographic location; age band; historic spend pattern; and balance. The merchant distributes the message to the customer's inbox via HyperLayer.

Customer A receives the message from the merchant and takes up the offer by purchasing a voucher with the merchant for £200. Customer B does not receive the message but sees the merchant offer in the shops area of the HyperJar app and takes up the offer by purchasing a voucher for £120.

After 45 days, customer A goes to a merchant location and makes a purchase for £75. When the transaction reaches HyperLayer, the rules engine processes the transaction and confirms that the transaction meets the defined criteria for the offer. The rules engine applies a £10 reward and deducts £65 from the customer's £200 voucher, leaving them with £135 to spend with the merchant.

After 32 days, customer B goes to a merchant location and makes a purchase for £30. When the transaction reaches HyperLayer, the rules engine processes the transaction and determines that the transaction does not meet the defined criteria for the offer. The rules engine deducts £30 from the customer's £120 voucher, leaving them with £90 to spend with the merchant.

Five days later customer B goes to a merchant location and makes a purchase for £60. When the transaction reaches HyperLayer, the rules engine processes the transaction and confirms that the transaction meets the defined criteria for the offer. The rules engine applies a £6 reward and deducts £54 from the customer's remaining £90 voucher, leaving them with £36 to spend with the merchant.

### Crypto Exchange Usage

An individual holding Bitcoin with an exchange wants to be able to spend their holdings at any merchant that accepts Mastercard. HyperJar is connected to the exchange as an alternative Store of Value. The individual becomes a HyperJar customer and connects their exchange account to create a core virtual Account holding their Bitcoin value. The customer makes a purchase at a merchant and pays with their HyperJar card. HyperLayer receives the transactions and determines that the customer has set their account to pay with their Bitcoin balance.

HyperLayer messages the exchange to get the latest exchange rate, converts the transaction price into Bitcoin equivalent and verifies that the customer has sufficient Bitcoin balance to make the payment. If there is sufficient Bitcoin balance HyperLayer instructs the exchange to debit the customer's Bitcoin balance and credit HyperJar's wallet at the exchange. HyperJar responds to the merchant approving the transaction.

### Multi-Store of Value Rules (Priority of Payment)

An individual holding Bitcoin with an exchange wants to be able to spend their holdings at any merchant that accepts Mastercard if the value of Bitcoin is above $50,000. If the value of Bitcoin is below $50,000, they want to only use fiat currency. HyperJar is connected to the exchange as an alternative Store of Value. The individual becomes a HyperJar customer and gets a bank account and also connects their exchange account so that they have two core virtual accounts, one holding their Bitcoin value and one holding their GBP value. The customer sets up a rule in their HyperJar account to always try and pay with Bitcoin first if the value of a Bitcoin is greater than $50,000 else to pay with their GBP account. The rule is stored in the rules engine.

On the 25th May the customer makes a purchase at a merchant and pays with their HyperJar card. HyperLayer receives the transactions and determines that the customer has set their account to pay with their Bitcoin balance first. HyperLayer messages the exchange to get the latest exchange rate and is told that the rate is $47,500. HyperLayer checks the rules engine and determines that the customer wants to use their GBP account to pay at this rate. HyperLayer checks the balance in their GBP wallet and determines there is sufficient funds to make the payment, debits the customer's wallet and responds to the merchant approving the transaction.

On the 26th May the customer makes a purchase at a merchant and pays with their HyperJar card. HyperLayer receives the transactions and determines that the customer has set their account to pay with their Bitcoin balance first. HyperLayer messages the exchange to get the latest exchange rate and is told that the rate is $51,500. HyperLayer checks the rules engine and determines that the customer wants to use their Bitcoin account to pay at this rate.

HyperLayer converts the transaction price into Bitcoin equivalent and verifies that the customer has sufficient Bitcoin balance to make the payment. If there is sufficient Bitcoin balance HyperLayer instructs the exchange to debit the customer's Bitcoin balance and credit HyperJar's wallet at the exchange. HyperJar responds to the merchant approving the transaction.

The customer amends their Bitcoin processing rule to add a condition to spend a maximum of £100 of Bitcoin in any one transaction and use their GBP for any balance outstanding. On the 27th May the customer makes a purchase for £150 at a merchant and pays with their HyperJar card. HyperLayer receives the transactions and determines that the customer has set their account to pay with their Bitcoin balance first up to a limit of £100. HyperLayer messages the exchange to get the latest exchange rate and is told that the rate is $50,100. HyperLayer checks the rules engine and determines that the customer wants to use their Bitcoin account to pay at this rate for the first £100. HyperLayer converts the transaction price into Bitcoin equivalent and verifies that the customer has sufficient Bitcoin balance to make the £100 payment. If there is sufficient Bitcoin balance HyperLayer checks there is sufficient balance in their GBP account for the remaining £50. If there is sufficient balance in both Stores of Value, HyperLayer instructs the exchange to debit the customer's Bitcoin balance and credit HyperJar's wallet at the exchange, debit the customer's GBP wallet, and respond to the merchant approving the transaction.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Appendix 1

Key Features in one implementation of the invention include the following. Note that any of these twenty Key Feature can be combined with any other compatible Key Feature.
Key Feature A. High level architecture
Key Feature B. The digital wallet
Key Feature C. Consumer spending intent
Key Feature D. Auto allocating a transaction to a jar
Key Feature E. Dynamic, rule-based, real-time analysis of a proposed transaction
Key Feature F: Direct payment from a data object
Key Feature G: Shared Jars
Key Feature H: Shared Jar messaging
Key Feature I. Delegated Permission/devolved spending
Key Feature J. Reconciliation
Key Feature K. Supplier Messages
Key Feature L. Merchant Specific Jars
Key Feature M. Merchant Intent
Key Feature N: Merchant Rewards
Key Feature O: Merchant Matching
Key Feature P: Merchant Money
Key Feature Q: Indirect Debit
Key Feature R: Intent based lending
Key Feature S: Cash proxies
Key Feature T: Priority of payments
Key Feature U: One card

There following text includes a re-cap of aspects of the specific implementation, HyperLayer, as well as generalisations.

### Key Feature A: High Level Architecture

The HyperLayer system, shown in FIG. 1, comprises a data-analysis environment which includes or accesses a data store that stores data and meta-data for one or more data objects that represent a store of value (‘data objects’) that are created by an entity. The Intent Data in FIG. 1 is an example of a data store. We may also use the term ‘data lake’ to refer to data stores: the User Intent Data Lake (UDL), HUDL (HyperLayer User Data Lake), MUDL (Merchant User Data Lake) or CUDL (Controller User Data Lake) are other examples of data stores that capture user data.

HyperLayer provides rich functionality around data objects we have described as ‘Jars’: a Jar can be a sub-account and can be surfaced in a digital wallet app (see Key Feature B below). Jars are typically created by a user to define and capture spend for a specific category and are shown as icons in a digital wallet app (e.g. a user could define Jars for grocery shopping, for utility bills, for holiday savings etc etc). The available amount of money in each Jar is shown in or next to the related Jar icon, making it fast and intuitive for the user to know how much is available to spend; payments in and out of Jars can be subject to rules stored in the data lake and applied by the rules engine: for example, a user could have their monthly pay check paid into a main bank account, and for a set amount to be transferred from that main bank into specific Jars each month, to aid budgeting. A user can spend directly from a Jar; there can be inbound payments directly to a Jar; merchants can link to a Jar, so that spend from that Jar is possible only with a linked merchant; any Jar can be shared with anyone else, with user defined permissions and controls applied by the rules engine; analytics of Jars, shared across multiple users and merchants is possible. Controlling the amounts that can be spent from a Jar is possible using rules stored in the data lake and applied by the rules engine, as is controlling overflows to other Jars; full time based control, and event based control is possible too.

The HyperLayer architecture includes an API layer that links the data-analysis environment to data publishers (e.g. merchants, banks) and data readers. An example: take a user's Jar that is set up for all grocery shopping. Let's say the user shops regularly at the Sainsbury's grocery chain and the user decides to set up a Jar in their wallet app labelled ‘Sainsbury's’. This grocery retailer could be given rights to read this Jar label via the API layer and can hence infer that this is a user who intends to shop regularly at Sainsbury's. This grocery retailer could be given rights to write to this Jar, via the API layer, for example providing a copy of shopping receipts, as well as rewards and coupons and other incentives. The HyperLayer architecture enables seamless sharing of relevant and permissioned data between consumers and merchants.

### We can Generalise to:

A computer-implemented system configured to provide data processing services to an entity, the system including:
(i) a data-analysis environment, which includes or accesses a data store that stores data and meta-data for one or more data objects that represent a store of value (‘data objects’), such as data objects that are created by the entity; and
(ii) an API layer that links the data-analysis environment to (a) a digital wallet publisher, and to (b) a service publisher that publishes data to, and receives data from, the data-analysis environment.

### Key Feature B. The Digital Wallet

As shown in FIG. 1, the HyperLayer system 5 connects, using an API layer 7, to a digital wallet (divided into a back-end wallet provider 3 and a wallet provider application 2, or digital wallet app). The digital wallet app 2 includes a user interface (see FIGS. 3-10) that displays user-selectable icons that represent a data object; we have earlier referred to these sub-accounts as ‘Jars’. Jars 50 can be described by permissions, that describe who can and cannot transact with a specific Jar, and can also be described by rules that describe whether a predefined transaction affecting the Jar is permitted or blocked. These permissions and rules can be stored as meta-data in the Intent Data store or data lake 21, 24, or some other data store, and can be used by the rules engine 25 to determine, automatically and in real-time, if a proposed transaction is allowed or blocked. In HyperLayer, transactions can occur directly at the Jar level; with most conventional digital wallets, transactions occur at the bank account level. But with rules and permissions at the Jar level, a user can see, for example, the value of their money in a specific Jar dropping when a permitted transaction debits from that Jar; likewise, the user can see in real time when an attempted transaction relating to a specific Jar is blocked.

One example: a user can have their primary bank account with a conventional bank: this conventional bank acts as a service publisher 14, publishing the balance and transactions for that bank account into the HyperLayer system 5 using messages that conform to the API layer. The user can, in the digital wallet app 2, generate a number of sub-accounts or Jars (see FIG. 3) that better reflect how they would like to manage their money: for example, they could have Jars for each of groceries, coffees, travel, mortgage, and utilities to enable more accurate budgeting. The ‘groceries’ jar could be limited to being used for payments only to a specific supermarket (defined by its unique MID code); that might be useful if the user is looking to earn rewards from that supermarket and so the user sets up a ‘permission’ (stored as intent data 21, 24) that if debit card payment is made from their account, then the rules engine 25 ensures that it debits from the Jar specific to that supermarket. The user can set up a broad range of rules that determine if a specific transaction type is permitted or blocked (e.g. who can spend from that jar, what merchants or other service providers can transact with that jar, what goods or services can be bought using that jar, the circumstances when the jar can be used): for example, let's say the user wants to share a Jar with their children, but doesn't want them spending from that Jar in a pub or bar; then, any transactions that are linked (via the bar-specific MCC) to that Jar will be automatically blocked in real-time.

### We can Generalise to:

A computer-implemented system configured to provide data processing services to an entity, the system including:
(i) a data-analysis environment which includes or accesses a data store that stores data and meta-data for one or more data objects that represent a store of value (‘data objects’), such as data objects that are associated with the entity; and
(ii) an API layer that links the data-analysis environment to (a) a digital wallet publisher, and to (b) a service publisher configured to receive a message defining a proposed transaction from the data-analysis environment, such as a payment transaction relating to the data object associated with the entity;
(iii) a digital wallet app, such as a smartphone or desktop app, that exchanges data with the data-analysis environment and where the digital wallet app includes a user interface that displays one or more user-selectable icons or items that each represent a data object in the data store;
   and where the data-analysis environment is configured (i) to analyse data or meta-data in the message defining the proposed transaction to allocate that proposed transaction to the relevant data object in the data store and, if the transaction is allowed, then (ii) approve the transaction and initiate the response to the transaction proposer, (iii) to automatically alter the value of the relevant data object and (iv) to automatically alter the value of the data object as shown by the digital wallet app, and if the proposed transaction is not allowed, then (v) decline the transaction and initiate the response to the transaction proposer.

### Key Feature C. Consumer Spending Intent

We've seen in the preceding section how a user can define specific Jars—in the digital wallet example, these Jar can be sub-accounts of a main bank account. We have seen also that any arbitrary rules or permissions can be associated with any Jars; for example, rules or permissions can define for a user: (a) what they intend to spend on; (b) where they intend to spend; (c) when they intend to spend; (d) who they intend to spend with; (e) how they intend to spend. This in effect captures enables the system to capture the consumer's spending ‘intent’.

### We can Generalise to:

A computer-implemented system configured to provide data processing services to an entity, the system including a data-analysis environment which:
(i) includes or accesses a data store that stores data and meta-data for one or more data objects that represent a store of value (‘data objects’);
   and in which a data object is created, selected, defined or modified by the entity to represent a future intent or an intended future action, namely one or more of: (a) what they intend to spend on; (b) where they intend to spend; (c) when they intend to spend; (d) who they intend to spend with; (e) how they intend to spend.

### Key Feature D. Auto Allocating a Transaction to a Jar

We have seen earlier, in the digital wallet context, that a transaction can be allocated directly to an appropriate Jar. For example, say the user has set up a Jar for grocery purchases from the retailer Sainsbury's; that retailer has a unique MID code and when the user presents their debit card to pay for groceries at Sainsbury's, that transaction is automatically allocated to that specific Jar: the user can see, prior to the transaction, the money available in that Jar to spend at Sainsbury's, and can see in real time the transaction appearing against that specific Jar, reducing the available spend for that Jar. This makes budgeting simple, accurate and intuitive. Transaction reclassification, i.e. changing the allocation of a transaction to a different Jar, is also possible.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to receive proposed or completed transaction data from an external digital system, such as a debit card, points/loyalty card, an app running on a smartphone or a webshop, and to analyse the transaction data to automatically allocate the transaction to an appropriate data object by comparing the transaction data with the meta-data for one or more data objects.

### Key Feature E. Dynamic, Rule-Based, Real-Time Analysis of a Proposed Transaction

Current solutions often only enable transactions to be tied to specific, fixed accounts—i.e. users can send or receive money from predefined accounts and transactions follow a predefined path from one account to another. Features may include budget tracking and bill splitting, but they operate within the constraints of fixed account or compatible structures.

In this Feature E, the system enables transactions to be permitted, and/or blocked and/or routed dynamically in real-time based on rules set by the user, which can involve multiple parties and varying needs and/or conditions. The system therefore converts a traditional bank account into a smart account. A rules engine processes—in real-time-user-defined instructions that determine where, how and with whom to settle transactions. By breaking the rigid link between payments and fixed accounts that drives today's ledger systems, the system introduces next generation functionality to manage value flows between individuals, groups and/or companies.

We have also seen earlier, in the digital wallet context, that a transaction can be analysed in real time by the data-analysis environment for compliance with rules; the data-analysis environment can automatically permit or block that transaction. This approach can also operate outside of the digital wallet context: for example, the proposed transaction could be the award of discount coupons in a smartphone app for a specific retailer.

### We can Generalise to:

A computer-implemented system configured to provide data processing services to an entity, the system including a data-analysis environment which includes or accesses:
(i) a data store that stores data and meta-data for one or more data objects defined or selected by that entity and that each represent a store of value (‘data objects’); and where the data or meta-data for a data object defines (a) one or more permissions that describe who can and cannot transact with a data object or a clusters or group of several individual data objects, and/or (b) one or more rules that describe whether a predefined transaction or other event affecting the data object is permitted or blocked; and
(ii) a rules engine that is configured to automatically and in real-time analyse a proposed transaction relating to a specific data object, against the permissions and/or rules stored in the data store, and is configured to automatically send a message or signal that results in the proposed transaction being automatically allowed or blocked.
   Key Feature F: Direct Payment from or to a Data Object

The HyperLayer system does not require (unlike other digital wallets) amounts in a sub-account, like a savings jar, to be moved first to a general jar or wallet before that amount can be spent; instead, HyperLayer enables a transaction (e.g. credit or debit) to be allocated directly to any Jar in real-time, so removing the need to first complete the movement to a general jar or wallet. We have also seen (see FIG. 3) that the cash available for spending directly from a Jar is displayed, again in real-time, in the wallet app, next to that Jar. So in HyperLayer, not only can a user spend directly from a Jar, but the new value of that Jar is immediately shown next to the Jar in the wallet app.

One important type of transaction is the payment transaction; we have also described this above in the digital wallet app context, but it is not limited to that context. For example, the proposed transaction could be the redemption of awards or discount coupons in a smartphone app for a specific retailer. As these awards or coupons are data objects, just like Jars, the payment transaction can be made directly, automatically and in real-time using these awards or coupons against these data objects, with their changed status (e.g. any residual value) immediately shown in the wallet app.

### We can Generalise to:

A computer-implemented system configured to provide data processing services to an entity, the system including a data-analysis environment which:
(i) includes or accesses a data store that stores data and meta-data for one or more data objects that each represent a store of value (‘data objects’);
(ii) is configured to analyse in real time a payment transaction to determine if it relates to a specific data object and to analyse any applicable rules or permissions for that data object; and, if the rules or permissions allow the payment transaction, to then process and record the payment transaction against that specific data object in real time.

### Key Feature G: Shared Jars

In HyperLayer, Jars are not necessarily personal and for the exclusive use of the named account holder or holders: because of the rich and flexible data-analysis environment, it is possible for that environment to define permissions and rules to enable third parties to use Jars belonging to someone else. For example, a group of friends (a Social Spending Group) go out for an evening of drinks: one of them sets up a Jar for that evening, and gives all friends access rights to view that Jar, pay into that Jar, and make payments directly from that Jar.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
   and in which a data object is created, selected, defined or modified by the entity to represent a shared data object that one or more third parties, identified by the entity and whose identities are recorded in the data store, are able to view and/or to transact with.

### Key Feature H: Shared Jar Messaging

Shared Jars can be very useful in the social context, e.g. where a group of friends set up a shared Jar relating to some shared event, and all friends have access rights to view that Jar, pay into that Jar, and make payments directly from that Jar. Messages can be sent within this group of friends (or Social Spending Group), so that HyperLayer becomes not just a payment system, but a social network.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
   and in which a data object is created, selected, defined or modified by the entity to represent a shared data object that one or more third parties, identified by the entity, are able to view and to transact with, and the identities of the third parties is stored as data or meta-data in the data store;
   and in which the data-analysis environment enables messages relating to the shared data object be sent between the entity and the third parties.

### Key Feature I: Delegated Permission/Devolved Spending

A parent can set up a Jar specifically for the use of one of their children: this Jar is a sub-account from the parent's main bank account. The Jar is filled with regular weekly pocket money from another of the parents Jar's and is permitted to be used solely by a named child, and for purposes defined by rules (e.g. no alcohol or cigarettes); the parent can also view and also transact from that Jar. The child is given a HyperJar debit card that is set up solely to debit from this Jar—i.e. it is not for a separate bank account in the child's name. The child can now pay for things, apart from alcohol and cigarettes, and those debit transactions debit automatically from this Jar. Equally, a user could set up a sub-account from their main wallet Jar for a cleaner, nanny etc. and provide them with a HyperJar debit card that is set up solely to debit from this Jar, with any user-defined rules or permissions (e.g. transactions only with specified retailers and for specified categories of goods). Another valuable use case is for an adult child with a parent with dementia: the adult child could set up a sub-account from their main wallet Jar for their parent and provide them with a HyperJar debit card, again with user-defined rules (including spending limits) or permissions, all selected to give the parent independence but without exposure to inappropriate spending.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable the entity to create, select, define or modify a data object to give a third party entity the ability to perform actions in relation to the data object that are delegated by or devolved by the entity to that third party entity, such as initiating a payment transaction from that shared object.

### Key Feature J: Reconciliation

For shared Jars used by Social Spending Groups, the data-analysis environment can automatically perform allocations or reconciliations—for example, where the Jar for a holiday is created by one person, and three other friends join the holiday, then the spend for all four people on that holiday can be allocated to that Jar: at the end of the holiday, the data-analysis environment aggregates the total spend, allocates that spend equally to all four, and makes a reconciliation request for re-imbursement to the three others.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable multiple entities to share a data object for a shared transaction or event;
   and in which the data-analysis environment is configured to automatically reconcile or allocate sums, e.g. after the transaction or event has concluded, among the multiple entities, according to rules or conditions as agreed by the multiple entities.

### Key Feature K. Supplier Messages

We have seen earlier how messages can be routed to a specific data object—for example, if a user has a Jar for petrol spend, then messages, such as current pricing or discounts, can be sent to that Jar and so appear in a relevant context, making that message far more engaging. For supplier messages, such as rewards or incentives, being able to message a customer in a way that is specifically relevant to that customer is very useful, for both supplier and customer: for example, say a customer is having to budget very carefully: they set up a Jar called groceries and all grocery purchases come out of this Jar. With HyperLayer, a grocery retailer is able to send a message to that customer that can appear together with their grocery Jar, e.g. listing 50% reduced items in that customer's local store.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable a supplier to create rules relating to one or more of the data objects, the rules being stored in the data store;
(iii) includes or accesses a rules engine that is configured to automatically apply those rules when determining if data messages are sent and displayed in relation to the data object or objects.

### Key Feature L: Merchant Specific Jars

A merchant can lock spending from a specific Jar through a rule that says only a transaction with a MID code for that merchant is permitted from that Jar. For example, a customer could set up a Jar specifically for the retailer Sainsbury's, and be rewarded with discounts or coupons for doing so: that Jar can be locked so that only transactions with Sainsbury's are permitted.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’); and the meta-data for a data object defines which third party merchant or merchants are permitted to transact with the data object.

### Key Feature M. Merchant Intent

We have described earlier how HyperLayer can capture consumer spending intent—e.g. (a) what they intend to spend on; (b) where they intend to spend; (c) when they intend to spend; (d) who they intend to spend with; (e) how they intend to spend. This defines, from the consumer's perspective or point of view, their individual spending intent. HyperLayer enables this data (subject to appropriate consumer consents) to be seen from the merchant's perspective too, and hence capture the collective intent of their many consumers.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’), such as money; and
(ii) is configured to share, with one or more merchants, one or more of the following types of intent-related data, which are collected into a queryable database or data set that is stored in or is accessible by the data-analysis environment: what the user intends to buy using a specific data object; who the user intends to spend their money with, using a specific data object; when the user intends to spend their money, using a specific data object; any transaction entered into by the entity using a specific data object with the merchant or other merchants, such as what was purchased, when it was purchased, where it was purchased, and whether any reward or incentive was used in the purchase.

### Key Feature N. Merchant Rewards

We have seen earlier how a user can set up a Jar that is specific to a single merchant; that merchant can reward that user for committed future spend—e.g. a user intends to save £2000 for a holiday, and commits to buy that holiday from British Airways by setting up a British Airways specific Jar and to automatically transfer a minimum of £50 per week into that Jar from their salary Jar. British Airways can now reward that user with say a 20% discount, or other incentive, perhaps a cash incentive, such as a £400 cash payment into that Jar. Reward calculation based on variables is also possible—e.g. % discount based on spend, randomised rewards, rewards that grow over time (hypothecation). Reward conditions can be defied by the merchant so that the rewards are only offered to a specific consumer demographic, or for whom consumer behaviour, tracked by the data-analysis environment, meets specific criteria.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to enable a merchant to define one or more rules for awarding rewards or incentives, the rules being stored in a rules engine in or accessible by the data-analysis environment; and the data-analysis environment is configured to use the rules engine to determine whether to automatically award those rewards or incentives to a data object that satisfies the rule(s).

### Key Feature O. Merchant Matching

The HyperLayer system can automatically identify a merchant that a user is transacting with (e.g. by analysing the MID meta-data for that transaction). Merchant matching can support a variety of useful functionality, such as merchant rewards.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to analyse a proposed transaction to automatically identify a counter-party or origin of the proposed transaction, such as a specific merchant that the entity is transacting with.

### Key Feature P. Merchant Money

Merchants can create non-fiat stores of value, such as rewards points, and the monetary value of these can become very significant. We have seen earlier how an airline could provide a £400 cash payment into a Jar that was locked specifically for spending solely with that airline; the £400 cash could be conventional cash, but can also be thought of as entirely synthetic, non-fiat money too, since it can only be spent with that airline.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) enables the creation, supply, or purchase of, non-fiat currency linked with a specific merchant or group of merchants, such as rewards points or vouchers, and stores these as data objects;
(iii) is configured to analyse in real time a payment transaction to determine if it relates to one of the data objects stored in step (ii) above, and to analyse any applicable rules or permissions for that data object; and, if the rules or permissions allow the payment transaction, to then determine the value to be exchanged, then process and record the payment transaction against that specific data object in real time.

### Key Feature Q. Indirect Debit

Direct debit payments are popular with suppliers for many reasons; but for some consumers, especially those on a tight budget, they can be opaque and problematic. Many consumers dislike direct debit obligations since they can lead to their bank accounts becoming overdrawn. HyperLayer enables the user to make future payments to a merchant to progressively pay off an amount that would otherwise be claimed as a direct debit.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to receive a direct debit request from a specific merchant and, when there is no data record, stored in the data store, of the entity agreeing to accept a direct debit from that merchant, to meta-tag the amount of any direct debit as a debt that the user entity owes to the specific merchant and to store that meta-tag to enable the user entity to automatically make future payments to that merchant to progressively pay off that amount.

### Key Feature R: Intent Based Lending

We have seen earlier that with HyperLayer, consumers can commit to spend with specific merchants—e.g. by having Jars locked to those merchants. A merchant can also have viewing rights so that it can see the amount of cash in the Jar allocated to that merchant; it can aggregate this committed spend and this can be useful for the merchant's financial (e.g. revenue recognition) and credit position.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’); in which the meta-data defines the entity's future intent or spending plans with a specific merchant;
(ii) is configured to generate financial and/or credit evaluation data for that merchant that automatically uses or takes into account the meta-data that captures the future intent or spending plans of that entity.

### Key Feature S: Cash Proxies

We have seen earlier how HyperLayer enables a merchant to provide rewards, points, crypto tokens etc. to a consumer, and the consumer can redeem against a purchase. In some cases, the value of merchant rewards (especially with crypto tokens) can be associated with fiat currency, but can fluctuate. HyperLayer enables a consumer to set up sophisticated rules in which the data-analysis environment retrieves or looks up an exchange rate between the non-fiat item type and the fiat currency, and automatically calculates how the transaction could be completed, in whole or part, using the non-fiat items at the prevailing exchange rate. For example, the consumer could have several different crypto token types available in various Jars; the consumer could set up a rule which provides for transactions (e.g. of a specific type) to be paid for in crypto, using the token with the highest fiat conversion rate at the time of the transaction, as a form of cash proxy.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to store a data record for the amounts of one or more non-fiat items owned by or associated with that user entity and, when the user entity starts or enters a proposed transaction in a fiat currency, then the data-analysis environment retrieves or looks up an exchange rate between the non-fiat item type and the fiat currency, and automatically calculates how the transaction could be completed, in whole or part, using the non-fiat items at the prevailing exchange rate.

### Key Feature T: Priority of Payment

We have seen earlier that the rules engine in the HyperLayer architecture enables transactions to be subject to routing (directing a transaction in whole to a particular data object-such as: ‘take my Salary and put it in my income jar’); and separation (splitting a transaction to several different data objects-such as ‘take my salary and put £500 into my general wallet jar, £500 into my rent jar and £500 into my food jar and ordering (cascading a credit/payment in or debit/payment out through a set of pre-defined data objects using a pre-set priority list until the entire amount has been allocated-such as (for a company that has taken out a loan) ‘take any trade income and as the first priority allocate 25% to the loan jar (that automatically re-pays the lender the entire amount of the loan jar each month), then take 25% and allocate that to a taxes and VAT jar, and then, as the lowest priority, allocate the remainder to a general wallet.

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to store for a publisher the specific order in which the available stores of value in their service proposition should be credited or debited, based on the attributes of the transaction and/or the attributes of the available stores of value.

### Key Feature U: One Card

HyperLayer publishers can use the principal of ‘one card to rule them all’ in that at the point of spend, the customer can use a single payment device (card, phone, payment instruction etc.) to access multiple publisher products expressed as stores of value within the HyperLayer system. This is automatic and powerful because the HyperLayer service can draw from many stores of value and, based on rules, different amounts etc. and across different providers.

As an example, if a publisher allowed a consumer to connect their HSBC Credit Account, their NatWest Current Account, a ‘buy now pay later’ service, and their Nectar Card (which are examples of publisher products that are expressed as stores of value within the HyperLayer system), the customer could use the HyperLayer rules engine and the priority of payment to set out different purchasing rules across these (these rules are stored in the data lake and implemented by the rules engine). So the customer could define the following set of rules for HyperLayer to store in the data lake: When I make a purchase at Sainsbury's, always use available Nectar point first and if the remaining amount to be paid is over £100, take £100 from my NatWest account and any remaining amount from my HSBC Credit account. So the HyperLayer system will then, in real-time, analyse each transaction to determine if it is a payment transaction with Sainsbury's (using meta-data in the payment request, such as the merchant ID number); if it is, then the rules engine will split and allocate the transaction according to the pre-set rules and, assuming there are sufficient funds, permit the transaction to proceed and transfer the funds to the Sainsbury's payment processor. Similarly, instead of automatically applying rules which had been previously defined or set, the customer could manually choose to override these and elect, at the point of sale, which one or more of their available, multiple stores of value are to be used, even though the customer is presenting just a single card or other user-controlled item at the point of sale.

So HyperLayer can, based on the user's choices,
1. Act on limited transaction attributes in terms of transaction amount and transaction location (i.e. the merchant)
2. Direct the transaction to a single source of value
3. Limit access to sources of value from a single entity—i.e. one bank

### But in Addition, HyperLayer can Also:

1. Take account of temporal factors at the time of the transaction such as the current balance of a store of value at the time a transaction is proposed (if my wallet has less than £500, use my available credit for any transaction over £100)
2. Access stores of value from multiple sources and of multiple types for a single transaction (points, credit line, debit balance), including those that have been shared with the person undertaking the transaction (if my wallet has less than £500, for any transaction over £100, use any vouchers or rewards available, then up to £75 from my wallet and then take any remaining balance from my savings account)
3. Access sources of value from any number of entities (if my wallet has less than £500, for any transaction over £100, use any vouchers or rewards available, then up to £75 from my NatWest wallet and then take any remaining balance from my HSBC savings account)

### We can Generalise to:

A computer-implemented system configured to provide data processing services to an entity, the system including a data-analysis environment which:
(i) includes or accesses a data store that stores data and meta-data for one or more data objects defined or selected by that entity and that each represent a store of value (‘data objects’);
(ii) is configured to store for a publisher multiple different available stores of value in their service proposition that may be credited or debited for a transaction;
(iii) is configured to process the transaction on receipt of a message from a single user controlled item, such as a payment card, a smartphone, a computer, and to then allocate the transaction to one or more of the available stores of value to be credited or debited for the transaction, based on the attributes of the transaction and/or the attributes of the available stores of value.

### Sub-Features

Each of the Key Features above can be combined with any one or more of the following compatible sub-features; any sub-feature can be combined with any compatible other sub-feature.

We Organise the Sub-Features into the Following 15 Categories:
The Data Store
Data objects
Meta-data
Digital Wallet
Transaction processing
Rules
Sharing
Messages
Merchant specific.
Merchant Rewards
Fraud and AML Monitoring
Indirect debit
Reconciliation
Intent based lending
Use cases
Underlying segmented data structure

### The Data Store.

The system including any Key Feature and/or any sub-feature in which the data store includes data sets, or data lakes, which define, for a user, financial intent regarding transactions and data objects.
The system including any Key Feature and/or any sub-feature in which the data store includes data sets, or data lakes, which are organised into one or more of the following groups: consumer personal; system internal; controller; merchant.
The system including any Key Feature and/or any sub-feature in which the data store includes data sets, or data lakes, which define one or more of: permissions; allocation; validity; event handling.
The system including any Key Feature and/or any sub-feature in which the data-analysis environment is configured to enable data exchange, via an API, and a message layer, between (i) one or more of the data sets, or data lakes, and (ii) a digital wallet system.
The system including any Key Feature and/or any sub-feature in which the data-analysis environment is configured to enable data exchange, via an API, and a message layer, between (i) one or more of the data sets, or data lakes, and (ii) an external banking computer system.
The system including any Key Feature and/or any sub-feature in which the data-analysis environment is configured to enable data exchange, via an API, and a message layer, between (i) one or more of the data sets, or data lakes, and (ii) an external merchant computer system.
The system including any Key Feature and/or any sub-feature in which the data-analysis environment is configured to enable data exchange, via an API, an event processor and a message layer, between (i) one or more of the data sets, or data lakes, and (ii) an external payment processing computer system.

### Data Objects

The system including any Key Feature and/or any sub-feature in which a data object defines a start or end point for a transaction, where a transaction is any form of a transfer of value between data objects, or any change in the value of a data object.
The system including any Key Feature and/or any sub-feature in which a data object relates to or defines a transaction, including a planned or intended future transaction.
The system including any Key Feature and/or any sub-feature in which a transaction is directed or routed to one or multiple data objects.
The system including any Key Feature and/or any sub-feature in which a transaction is split and then directed or routed to multiple data objects.
The system including any Key Feature and/or any sub-feature in which a transaction is split and then directed or routed to multiple data objects, based on an analysis of the metadata attached to each data object.
The system including any Key Feature and/or any sub-feature in which a transaction is itself, or is directed to, a data object, and a defined set of transactions is a derived data object, and the data-analysis environment is configured to analyse or process derived data objects for the purpose of one or more of: analytics; alarms; events; rules; synthetic accounts.
The system including any Key Feature and/or any sub-feature in which a data object is a collection of separate data objects or a collective data object.
The system including any Key Feature and/or any sub-feature in which a transaction relating to a collective data object is split up and applied separately to data objects that make up that collective data object according to a pre-set priority.
The system including any Key Feature and/or any sub-feature in which a data object is in or associated with several collective data objects.
The system including any Key Feature and/or any sub-feature in which a data object is a personal financial data object that (i) is structured or selected by an entity consumer to enable the entity to plan, budget, share and control their finances and (ii) includes or is referenced by meta-data defining the personal financial object.
The system including any Key Feature and/or any sub-feature in which data objects are financial objects, such as bank accounts, savings accounts, ISA accounts, reward point schemes, synthetic accounts, or any other value representation.
The system including any Key Feature and/or any sub-feature in which the data-analysis environment enables visualisation of a data object, as well as clusters or groups of several individual data objects.
The system including any Key Feature and/or any sub-feature in which a data object is a digital jar or other discrete object with a discrete user interface icon, stored in a digital wallet.
The system including any Key Feature and/or any sub-feature in which a data object is a ledger entry, e.g. recorded in a database.
The system including any Key Feature and/or any sub-feature in which a data object is a virtual or synthetic sub-account.
The system including any Key Feature and/or any sub-feature in which a root or primary virtual account data object is linked to a single account number and/or a single physical card.
The system including any Key Feature and/or any sub-feature in which a root or primary virtual account data object is linked to a credit card, debit card, QR code or any other payment channel.
The system including any Key Feature and/or any sub-feature in which data objects are stored within the data-analysis environment or are stored externally to the environment but are accessible to the data-analysis environment.
The system including any Key Feature and/or any sub-feature in which the data-analysis environment enables data and meta-data describing a data object associated with a user to be shared with other entities, such as other users, merchants, financial institutions.
The system including any Key Feature and/or any sub-feature in which, where a data object associated with a user is shared with other entities, then the data-analysis environment provides the user and the other entities with a view or point-of-view of that data object that is specific to, and can hence vary, between the user and the other entities.
The system including any Key Feature and/or any sub-feature in which the data-analysis environment enables a reward, voucher, gift or incentive redeemed or used by a consumer to be linked to that consumer and shared with the provider of that reward, voucher, gift or incentive.

### Meta-Data

The system including any Key Feature and/or any sub-feature in which data objects include or are referenced by meta-data.
The system including any Key Feature and/or any sub-feature in which the data-analysis environment is configured to process a transaction, where the transaction is defined by meta-data that enables the transaction to be linked to a data object.
The system including any Key Feature and/or any sub-feature in which the meta-data defines one or more of the following: how data objects are displayed; how transactions are displayed; tagging; messages.
The system including any Key Feature and/or any sub-feature in which the meta-data defines one or more of the following: what happens to data in the data store when change happens, such as the passage of time or new transactions arise, or new data objects are created.
The system including any Key Feature and/or any sub-feature in which the meta-data for a data object defines (a) one or more permissions that describe who can and cannot transact with an object or a clusters or group of several individual data objects, and/or (b) one or more rules that describe whether a predefined transaction or other event affecting the data object is permitted or blocked.
The system including any Key Feature and/or any sub-feature in which at least some of the meta-data is organised into data sets, or data lakes, which define, for a user, financial intent regarding transactions and data objects.
The system including any Key Feature and/or any sub-feature in which at least some of the meta-data is organised into data sets, or data lakes, which are organised into one or more of the following groups: consumer personal; system internal; controller; merchant.
The system including any Key Feature and/or any sub-feature in which the data-analysis environment is configured to enable data exchange between one or more of the data sets, or data lakes, with a digital wallet system.
The system including any Key Feature and/or any sub-feature in which the data-analysis environment is configured to enable data exchange between one or more of the data sets, or data lakes, with an external banking computer system.
The system including any Key Feature and/or any sub-feature in which the data-analysis environment is configured to enable data exchange between one or more of the data sets, or data lakes, with an external merchant computer system.
The system including any Key Feature and/or any sub-feature in which the data-analysis environment is configured to enable data exchange between one or more of the data sets, or data lakes, with an external payment processing computer system.
The system including any Key Feature and/or any sub-feature in which meta-data for a data object defines one or more rules that describe whether a predefined transaction or other event affecting the data object is permitted or blocked.
   The system including any Key Feature and/or any sub-feature in which a consumer who has created or selected the data object defines one or more of the rules.
   The system including any Key Feature and/or any sub-feature in which a third party to the consumer, (e.g. a merchant, a payment channel such as a credit or debit card company, points scheme, rewards scheme), defines one or more of the rules.
   The system including any Key Feature and/or any sub-feature in which rules are if/then logic defining the circumstances when a transaction is permitted or blocked.
   The system including any Key Feature and/or any sub-feature in which rules are if/then logic defining the circumstances whether a predefined transaction can automatically occur and that define customer incentives or rewards.
   The system including any Key Feature and/or any sub-feature in which rules are if/then logic defining customer incentives or rewards.
   The system including any Key Feature and/or any sub-feature in which rules define time-based customer incentives or rewards.
   The system including any Key Feature and/or any sub-feature in which rules define a merchant's incentives or rewards associated with a consumer committing to spend with that merchant.
   The system including any Key Feature and/or any sub-feature in which rules define which merchants, or which kinds of merchants, can transact with an individual personal financial object.
   The system including any Key Feature and/or any sub-feature in which rules define the kind of goods that can be purchased, with their costs debited against a specific individual personal financial object.

### Digital Wallet

The system including any Key Feature and/or any sub-feature in which the system includes a digital wallet app, e.g. a smartphone or desktop app, that exchanges data with the data-analysis environment and where the data or meta-data for each data object includes a numeric quantity that represents value (‘numeric value’), such as a monetary or financial value, and the system is configured to display the numeric value of one or more of the data objects to enable the entity to plan how to use the value represented by the numeric value.
The system including any Key Feature and/or any sub-feature in which a digital wallet user interface enables a user to enter an input defining one or more of the following types of user data, which are then processed by the data-analysis environment: what the user intends to buy, using money allocated to a specific data object; who the user intends to spend their money with, using money allocated to a specific data object; when the user intends to spend their money, using money allocated to a specific data object.
The system including any Key Feature and/or any sub-feature including a digital wallet user interface with graphical user interface items, icons or labels for one or more of the following categories of data objects that enable the entity to plan, budget, share and control their finances; (a) data objects that represent different spending categories; (b) data objects that represent different saving categories; (c) data objects that represent different data objects shared by other entities; (d) data objects that represent different objects shared with other entities.
The system including any Key Feature and/or any sub-feature in which a data object is different from a bank account in that the entity can create or select multiple different data objects, to enable the entity to create a personalised or customised cluster of these data objects.
The system including any Key Feature and/or any sub-feature in which a digital wallet user interface enables an entity to create or select multiple different data objects in different categories of data objects that enable the entity to plan, budget, share and control their finances.
The system including any Key Feature and/or any sub-feature in which a digital wallet user interface enables an entity to initiate a transaction with an external entity from or to a data object, created by or for that entity, in a manner that automatically alters a numeric value of the data object that represents value.
The system including any Key Feature and/or any sub-feature in which a digital wallet user interface enables an entity to initiate a transaction with an external entity from or to a cluster of data objects, created by or for that entity, in a manner that automatically alters the numeric, e.g. financial, value of the cluster.
The system including any Key Feature and/or any sub-feature in which a digital wallet user interface enables an entity to share access to and use of one or more data objects, created by or for that entity, with other external entities.
The system including any Key Feature and/or any sub-feature in which a digital wallet user interface enables an entity to prevent or mask viewing or access to one or more private data objects, created by or for that entity, with other external entities.
The system including any Key Feature and/or any sub-feature in which a digital wallet user interface enables an entity to determine how data objects, created by or for that entity, are visualised or seen by other external entities.
The system including any Key Feature and/or any sub-feature in which a digital wallet user interface enables an entity to set permissions that define if and how a data object, created by or for that entity, can be seen and used by other external entities (e.g. make purchases, transfer funds in or out, spending limits).
The system including any Key Feature and/or any sub-feature in which a digital wallet user interface enables an entity to permit or block transactions with specific data objects, created by or for that entity, at specific named shops or services, e.g. to permit a data object relating to food shopping to be used to buy items only from specified stores.
The system including any Key Feature and/or any sub-feature in which a digital wallet user interface enables an entity to automate financial activity in relation to data objects, created by or for that user, by time-event based rules.
The system including any Key Feature and/or any sub-feature in which a digital wallet user interface enables an entity to automate financial activity in relation to data objects, created by or for that entity, by trigger-event based rules.
The system including any Key Feature and/or any sub-feature in which a digital wallet user interface displays any one or more of rewards, vouchers, gifts or incentives available to a user from different merchants.
The system including any Key Feature and/or any sub-feature in which a digital wallet user interface displays any one or more of rewards, vouchers, gifts or incentives available to an entity if that entity spends a defined amount with a merchant, and if the entity does spend at least that amount, then the reward etc is automatically provided to an appropriate object, shown in the wallet, for that entity.
The system including any Key Feature and/or any sub-feature in which a digital wallet user interface displays any one or more of rewards, vouchers, gifts or incentives available to an entity if the entity commits to spend a defined amount with a merchant, and if the entity does in fact spend at least that amount, then the reward etc is automatically provided to an appropriate data object, shown in the wallet, for that entity.
The system including any Key Feature and/or any sub-feature in which a digital wallet user interface includes a chat or messaging function to enable a first entity to send chats or messages to other users who share access to the same data objects, e.g. the first entity's objects.
The system including any Key Feature and/or any sub-feature in which a digital wallet user interface enables an entity to construct, view and interact with a collection of data objects, created by or for that entity, where the data objects: (i) are structured or selected by the entity to enable the entity to plan, budget, share and control their finances and (ii) include meta-data defining each data object; and where the digital wallet user interface enables the entity to initiate a transaction with an external entity from or to a data object, in a manner that automatically alters the numeric, e.g. financial, value of the data object.
The system including any Key Feature and/or any sub-feature in which a digital wallet enables a single payment transaction, made with a single payment card or virtual card, to both pay for goods and/or services and also redeem and/or earn rewards, vouchers, gifts or incentives.
The system including any Key Feature and/or any sub-feature in which a digital wallet enables a single payment transaction, made with a single payment card or virtual card, to both pay for goods or services in a manner that is automatically processed in relation to a predefined data object to automatically pay for those goods or services and also to alter the numeric value of that data object.
The system including any Key Feature and/or any sub-feature in which a digital wallet enables a single payment transaction, made with a single payment card or virtual card, to both pay for goods or services in a manner that is automatically processed in relation to a predefined data object, and also to earn or redeem rewards, vouchers, gifts or incentives, in a manner that is also automatically processed in relation to a predefined data object to deliver fully accurate attribution to link a purchase by a specific entity to a specific reward, voucher, gift or incentive used by that entity.

### Transaction Processing

The system including any Key Feature and/or any sub-feature in which the data-analysis environment enables a consumer to initiate a transaction with an external entity from or to a data object, or in a manner that automatically alters the data or meta-data associated with the data object, such as spending directly from or in relation to a specific virtual sub-account or jar.
The system including any Key Feature and/or any sub-feature in which the data-analysis environment enables permissions, that define how a shared data object can be used by an external entity, to be processed in real-time to permit or block a transaction initiated by that external entity.
The system including any Key Feature and/or any sub-feature in which the data-analysis environment enables permissions, that define how a shared data object can be used by an external entity, to be processed by a Point-of-Sale system in real-time.
The system including any Key Feature and/or any sub-feature in which the data-analysis environment enables time-based rules to be defined and to permit or block a transaction depending on whether a time-based rule is satisfied.
The system including any Key Feature and/or any sub-feature in which the data-analysis environment enables trigger-event based rules to be defined and to permit or block a transaction depending on whether a trigger-event based rule is satisfied.
The system including any Key Feature and/or any sub-feature in which the data-analysis environment is configured to process in real time the time-based rules and the trigger-event based rules.
The system including any Key Feature and/or any sub-feature in which the data-analysis environment enables the time event based rules and the trigger-event based rules to be processed at or by a Point-of-Sale system in real-time.
The system including any Key Feature and/or any sub-feature in which the data-analysis environment enables a transaction to be reclassified to one or more different data objects.
The system including any Key Feature and/or any sub-feature in which the data-analysis environment enables a transaction to be reclassified to one or more different data objects and data or meta-data defining the reclassification is preserved across all affected data objects.
The system including any Key Feature and/or any sub-feature in which the data-analysis environment generates data that enables messages, such as advertising messages and offers of rewards, vouchers, gifts or incentives, to be automatically targeted at consumers with data objects that have data or meta-data that indicates potential relevance of those messages.
The system including any Key Feature and/or any sub-feature in which if the data-analysis environment determines that the numeric value of an appropriate data object is insufficient to meet or satisfy a transaction, then the data-analysis environment is configured to automatically allocate some or all of the proposed transaction to another data object or data objects, according to a predefined priority order.
The system including any Key Feature and/or any sub-feature in which the origin of a proposed transaction is determined using a combination of one or more of the following: pattern matching; regular expressions matching; or machine learning.
The system including any Key Feature and/or any sub-feature in which the data-analysis environment is configured to output a confidence score associated with the identified origin of the proposed transaction.
The system including any Key Feature and/or any sub-feature in which, when the confidence score is higher than a pre-defined threshold, the system is configured to check the data store to see if there are any rules and or rewards that need to be applied to the proposed transaction.
The system including any Key Feature and/or any sub-feature in which the data-analysis environment is configured to process and record the transaction against a specific data object in real time to alter a value or balance for that specific data object.
The system including any Key Feature and/or any sub-feature in which the data-analysis environment is configured to enable a transaction that relates to a specific data object to be recorded against that specific data object in real time, so that for example a payment from that specific data object is displayed in real time as altering a value or balance for that specific data object.
The system including any Key Feature and/or any sub-feature in which meta-data for a data object defines one or more permissions that describe who can and cannot transact with an object or a clusters or group of several individual objects and a consumer or a third party creates the permissions.
The system including any Key Feature and/or any sub-feature in which the data-analysis environment is configured to enable a user to transact, e.g. spend, directly from or in relation to a specific data object, such as a virtual sub-account or jar or the primary virtual account and the data-analysis environment only approves a proposed transaction if there are sufficient funds in or attributed to that specific data object, e.g. that specific virtual sub-account.
The system including any Key Feature and/or any sub-feature in which data or meta-data for a transaction is analysed in the data-analysis environment to profile the entity.
The system including any Key Feature and/or any sub-feature in which the data-analysis environment is configured so that any payments relating to a specific data object, such as out from or into a secondary virtual sub-account, are made solely using a digital payment device, such as a debit card or app running on a smartphone.
The system including any Key Feature and/or any sub-feature in which the data-analysis environment is configured so that any payments out from or into a specific data object, such as a secondary virtual sub-account, automatically and substantially immediately alters the balance or value of the linked primary virtual account.
The system including any Key Feature and/or any sub-feature in which the data-analysis environment enables the amount of a value in a transaction to be a calculated amount.
The system including any Key Feature and/or any sub-feature in which the data-analysis environment triggers a transaction to alter the value associated with a source data object to a preset level when a predefined condition is met.
The system including any Key Feature and/or any sub-feature in which the data-analysis environment automatically triggers a transaction from a source data object to a target data object when a predefined condition is met.
The system including any Key Feature and/or any sub-feature in which the data-analysis environment triggers a fractional series of transactions from a source data object to a target data object.
The system including any Key Feature and/or any sub-feature in which, when a proposed transaction data is received, the data-analysis environment is configured to recommend a suitable allocation to one or more jars.

### Rules

The system including any Key Feature and/or any sub-feature in which the data-analysis environment includes or accesses rules that are used by a rules engine.
The system including any Key Feature and/or any sub-feature in which a rules engine determines in real-time if a transaction with a specific merchant should be blocked or permitted, by using a MID code for that merchant and checking data or meta-data related to that MID code that defines what transactions with that merchant are blocked and what transactions are permitted.
The system including any Key Feature and/or any sub-feature in which the rules engine determines in real-time whether to permit or block a transaction for specific types of goods or services by using a MCC code and checking data or meta-data related to that MCC code that defines what types of goods or services are blocked and what types of goods or services are permitted.
The system including any Key Feature and/or any sub-feature in which the rules engine determines in real-time whether a transaction altering the numeric value of a data object should be blocked or permitted, e.g. whether money is permitted to be moved in or out of a virtual sub-account or jar, e.g. to be spent with a specific merchant or on specific types of goods or services
   The system including any Key Feature and/or any sub-feature in which conditionality rules define one or more of the following: merchant name, merchant type, MID code, MCC code, SKU, to hence enable the rules engine to automatically determine in real-time if a proposed transaction that would lead to a debit associated with a data object is permitted or not.
The system including any Key Feature and/or any sub-feature in which the rules engine determines in real-time whether to permit or block a debit or credit transaction that directly affects, e.g. changes the value of a specific data object such as a specific jar.
The system including any Key Feature and/or any sub-feature in which the rules engine implements in real-time a debit or credit transaction from a linked series of data objects, such as jars, according to a predefined priority of payments order.
The system including any Key Feature and/or any sub-feature in which the priority order includes a priority ordered list of different types of stores of value, such as money, then crypto, then rewards, then non-fiat currency or redemption points.
The system including any Key Feature and/or any sub-feature in which the rules engine implements in real-time a debit or credit transaction from a linked series of data objects so that a debit or credit cascades or flows through the linked series of data objects until conditions defined in the rules engine are met.
The system including any Key Feature and/or any sub-feature in which the rules engine determines in real-time whether to permit or block a debit transaction using predefined affordability criteria.
The system including any Key Feature and/or any sub-feature in which the rules engine automatically changes, e.g. rounds up or down, the amount of a payment transaction and attributes the amount of the change to a specific data object.
The system including any Key Feature and/or any sub-feature in which the rules engine automatically allocates a single invoice or payment to multiple data objects.

### Sharing

The system including any Key Feature and/or any sub-feature in which the data-analysis environment is configured to enable a data object to be shared by a first entity with multiple entities, with each entity having rights to perform actions or events that relate to that data object, as permitted by rules stored in or accessed by the data-analysis environment that are under the control of the first entity, such as devolved spending.
The system including any Key Feature and/or any sub-feature in which the data-analysis environment is configured to enable a data object to be shared by a first entity with multiple entities, with each entity having rights for one of more of the following: to read, or pay into, or spend from, that shared data object, or invite new entities to share that data object, in each case as permitted by rules stored in or accessed by the data-analysis environment that are under the control of the first entity.
The system including any Key Feature and/or any sub-feature in which, when a data object is transferred to another entity, the data or meta-data associated with the data object is also transferred to the other entity.
The system including any Key Feature and/or any sub-feature in which, when proposed transaction data is received that meets the rules or conditions of the shared data object, the system is configured to automatically allocate the proposed transaction to the shared data object, e.g. to affect the numeric value of that shared data object.
The system including any Key Feature and/or any sub-feature in which, when a proposed transaction data is received, the data-analysis environment is configured to recommend a suitable allocation to the shared data object.
The system including any Key Feature and/or any sub-feature in which the data object is a clusters or group of several individual data objects.
The system including any Key Feature and/or any sub-feature in which the data analysis environment is configured to provide an entity with a view-only access to specific meta-data linked to a data object associated with another entity.
The system including any Key Feature and/or any sub-feature in which the system includes a data-analysis environment configured to enable a consumer to share any data object, such as a virtual sub-account, with a group of people to create a shared data object, or ledger that captures the intent of the group of people, acting towards a shared goal, where that intent is defined by meta-data stored in the data store.
The system including any Key Feature and/or any sub-feature in which the data-analysis environment is configured to enable a first entity to create, linked to a primary virtual account of that entity, a data object, for a different entity.
The system including any Key Feature and/or any sub-feature in which the data-analysis environment is configured to enable that different entity to create, linked to the primary virtual account of the first entity, another data object for another different entity.

### Messages

The system including any Key Feature and/or any sub-feature in which the data-analysis environment is configured to process data messages that relate to a specific data object.
The system including any Key Feature and/or any sub-feature in which the data-analysis environment is configured to process data messages that relate to a data object that is shared across several entities to enable a chat group associated with that shared data object.
The system including any Key Feature and/or any sub-feature in which meta-data for messages is matched by the data-analysis environment to meta-data for one or more of the data objects when determining if data messages are sent to or visible to any entity that can view the data object.
The system including any Key Feature and/or any sub-feature in which a data object is a contact or group of contacts, and the data-analysis environment is configured to process data messages that are between contacts or groups of contacts.
The system including any Key Feature and/or any sub-feature in which the data-analysis environment is configured to process data messages that are a notification of a change in data in the data store or a change in a data object.
The system including any Key Feature and/or any sub-feature in which the data-analysis environment is configured to process data messages from a supplier, where the supplier is one of the following: a merchant; a service provider; a bank; an asset or wealth manager; an insurance company; a pension provider; a merchant loyalty or reward programme; a group or team or club.
The system including any Key Feature and/or any sub-feature in which the data-analysis environment is connected, via an API, to the data infrastructure of one or more of the following suppliers: a merchant; a service provider; a bank, an asset or wealth manager, an insurance company, a pension provider, a merchant loyalty or reward programme, a group or team or club, to enable the provision of services to entities that extends the scope of that supplier data infrastructure.
The system including any Key Feature and/or any sub-feature in which the data messages relate to rewards, vouchers, gifts or incentives that affect a data object.
The system including any Key Feature and/or any sub-feature in which the data messages relate to data objects that are shared across, or accessible to, several different entities, to enable group messaging that is related to a specific data object.

### Merchant Specific

The system including any Key Feature and/or any sub-feature in which the data-analysis environment is configured to enable a customer to identify a specific data object for which only transactions with a specific merchant, as identified by a MID code, are permitted, and to define one or more rules so that future transactions are completed from or to this specific data object only if the rule or rules are met.
The system including any Key Feature and/or any sub-feature in which the data-analysis environment is configured to enable the creation of a transferrable data object, associated with an amount of value, for which only transactions that meet preset criteria, such as merchant name or type, date ranges, are permitted, and that data object is transferrable between different users, like a voucher or riskless gift card.
The system including any Key Feature and/or any sub-feature in which the data-analysis environment is configured to automatically inform a merchant when a data object is created that is specific to that merchant, as identified by a MID code.
The system including any Key Feature and/or any sub-feature in which the data-analysis environment is configured to automatically inform a merchant what the future spend from a specific customer is intended to be, using data from the data object(s) that is specific to that merchant.
The system including any Key Feature and/or any sub-feature in which the system includes a digital wallet app, e.g. a smartphone or desktop app, that exchanges data with the data-analysis environment and is configured to share with a merchant one or more of the following types of intent-related data: what the user intends to buy, using money allocated to a specific data object; who the user intends to spend their money with, using money allocated to a specific data object; when the user intends to spend their money, using money allocated to a specific data object.
The system including any Key Feature and/or any sub-feature in which the system includes a digital wallet app, e.g. a smartphone or desktop app, that exchanges data with the data-analysis environment and is configured to share with a merchant one or more of the following types of data: any transaction entered into by the user with the merchant or other merchants, including what was purchased, when it was purchased, where it was purchased, and whether any reward or incentive was used in the purchase.
The system including any Key Feature and/or any sub-feature in which the data-analysis environment and is configured to share with one or more merchants one or more of the following types of intent-related data, which are collected into a queryable database or data set: what the user intends to buy, using money allocated to a specific data object; who the user intends to spend their money with, using money allocated to a specific data object; when the user intends to spend their money, using money allocated to a specific data object; any transaction entered into by the user with the merchant or other merchants, including what was purchased, when it was purchased, where it was purchased, and whether any reward or incentive was used in the purchase.
The system including any Key Feature and/or any sub-feature in which the data-analysis environment is configured to store personal profiles and preferences and to build an anonymised cohort of entities that meet criteria defined by a merchant, to enable the merchant to automatically send incentives or rewards targeted at the cohort.

### Merchant Rewards

The system including any Key Feature and/or any sub-feature in which the data-analysis environment is configured to share with one or more merchants one or more of the following types of data, which are collected by the merchant into a queryable database or data set: who gets rewards of other incentives and who does not (e.g. which data objects and their related owning/controlling entities get incentives; when incentives are delivered to a data object; how incentives are delivered to a data object (e.g. which data channel is used); whether an incentive worked or not (e.g. whether it triggered or was used in a transaction).
The system including any Key Feature and/or any sub-feature in which the data analysis environment is configured to enable one or more merchants to define one or more rules for targeting and/or awarding and/or attributing rewards or other incentives; and the data-analysis environment is configured to automatically target, and/or award and/or attribute those rewards or incentives to a data object that satisfies the rule or rules.
The system including any Key Feature and/or any sub-feature in which the data analysis environment is configured to use a feedback loop to learn over time, from targeting, and/or awarding and/or attribution data, how to improve targeting of rewards or other incentives.
The system including any Key Feature and/or any sub-feature in which the system is configured to perform a large number of testing and analysis of different incentives prior to the moment an end-user spends from a specific jar, and to then generate end-users' behaviour models.
The system including any Key Feature and/or any sub-feature in which the data-analysis environment is configured to generate individual recommendations for how a merchant can engage with a specific end-user in a way that the specific end-user finds appealing based on historical transactional data.
The system including any Key Feature and/or any sub-feature in which the data-analysis environment is configured to generate behavioural change triggers, such as using a gamification engine, based on historical transactional data.
The system including any Key Feature and/or any sub-feature in which the data-analysis environment is configured to generate individual recommendations prior to a point of sale, such as at the moment of intent.
The system including any Key Feature and/or any sub-feature in which rules for awarding rewards or other incentives take into account any one or more of the following: merchant loyalty points, longevity with merchant, geo-location data, time stamp data, amount of transaction, or any event or action that relates to the merchant, such as the creation of a data object (i) related to the specific merchant and/or (ii) shared with a number of other user-entities; or the completion of a pre-defined number of transactions; or a pre-commitment to spend a specific amount at the merchant; consumer demographics; consumer behaviour tracked by the data-analysis environment; environmental conditions; merchant specific conditions; specific conditions stored by or accessible to the data-analysis environment.
The system including any Key Feature and/or any sub-feature in which the data-analysis environment is configured to automatically apply any rewards or other incentives (promotions, offers etc.) from a specific merchant for that specific consumer (e.g. hyper-personalised promotions and incentives), to automatically update the amount left in or associated with the appropriate data object.
The system including any Key Feature and/or any sub-feature in which the data-analysis environment is configured to enable one or more merchants to define rules for awarding rewards or other incentives; and the data-analysis environment is configured to automatically award those rewards promotions, offers or incentives to an entity whose future intent, defined in a data object, meets those rules, e.g. whenever money is paid into a merchant-specific virtual sub-account or whenever money is spent with the merchant from that virtual sub-account).
The system including any Key Feature and/or any sub-feature in which the data-analysis environment is configured to enable one or more merchants to define any kind of incentive, e.g. any rules based promotion or discount (e.g. experiential incentives, save-now and buy-later, as well as more conventional % discount or a two for ones etc.) that is specific to an individual consumer or consumers that meet a demographic profile or meet any other metadata parameters the data-analysis environment captures.
The system including any Key Feature and/or any sub-feature in which the data-analysis environment is configured to enable multiple merchants to define any kind of incentive that is common across all the merchants.
The system including any Key Feature and/or any sub-feature in which the rules engine automatically awards or redeems rewards or incentives to an entity whose future intent, defined in or by a data object, such as a virtual sub-account, meets certain rules, and the award or redemption occurs in real-time when the entity commits to a future transaction, or that transaction occurs.
The system including any Key Feature and/or any sub-feature in which the data-analysis environment is configured to automatically award those rewards or incentives to a data object whenever money is paid into a virtual sub-account or whenever money is spent with the merchant from that virtual sub-account or money is placed into a specific data object.
The system including any Key Feature and/or any sub-feature in which data objects defining rewards or other incentives have one or more of the following properties:
   Grows over time
   Awarded at time of event (e.g. instant)
   Awarded on completion of n steps-like a stamp card (on 5^{th} transactions get x)
   Must be used in a specific location (e.g. to incentivise sales at a business at that location)
   Must be used between specific times/by this date (e.g. to incentivise sales at times that are otherwise quiet)
   is a random amount, e.g. prize for completing an event in the system
   a random user is selected for a prize
   is awarded for completing a task (e.g. completing a survey; sharing a reward with a friend)
   follows a merchant
   created with a shared jar with x friends (e.g. to encourage group spending)
   requires spending x amount over y period (cumulative behaviour)
   is a percentage discount for a transaction spend, based on the total amount of the transaction (for example 10% off up to £100)
   are specific and different amounts based on meeting specific rules or conditions (for example, £10 off if transaction is made in-store rather than online, or £10 off if transaction is made between 8 am and noon).
   can be used in whole or part, even in a physical, retail store
   rewards sent to parents are shared with their children to enable parental-consented marketing
   cannot be used by the initial recipient, but can be given away and then used by the subsequent recipient (e.g. driving social referral and gifting)
   increase in value over time
   increase in value over time if shared with others
   deduction or coupon calculated in real-time at the POS
   activates when a user collects a set or series of rewards
   increase as more users collect a reward
   is a money off after a set number of transactions at a specific merchant
   are time-based, e.g. set to only work at a merchant's quiet times
   decline in value over time
   only work on specific dates
   can only be given to friends, groups, or children
   can only be given away as gifts
   are rewards for completing a survey, or watching content, e.g. an advert online
The system including any Key Feature and/or any sub-feature in which the system implements in real-time a distribution of funds received into the externally addressable account (e.g. a bank account) across a series of data objects, such as jars, (e.g. a single debit or credit transaction with a permissioned merchant), according to a predefined priority of payments order; and where the distribution may be based on absolute amounts, ratios of amount received, topping up a data object to a defined amount, or any number of combinations until such time as the received amount has been fully disbursed; the distribution may include rewards or incentives data objects associated with that permissioned merchant, and which are defined with a specific priority.
The system including any Key Feature and/or any sub-feature in which the system implements a reward that grows over time, and dynamically calculates reward value at the point of redemption, using merchant level MID code blocking or routing.
The system including any Key Feature and/or any sub-feature in which rewards are fully or partially transferable on meeting specific rules or conditions defined by the merchant, such as rewards when transferred should be spent at a specific time or geo-location data, or with merchant.
The system including any Key Feature and/or any sub-feature in which the data-analysis environment is configured to automatically identify an end-user to a merchant, such as when the end-user enters a store of the merchant or when a specific card or QR code is used, to automatically apply any promotion or offer for that end-user, and to automatically update the amount left in the merchant-specific jar of that end-user.
The system including any Key Feature and/or any sub-feature in which the system determines in real time at point of sale if a reward is compliant with a set of criteria, such as size of spend.

### Fraud and AML Monitoring

The system including any Key Feature and/or any sub-feature in which the data-analysis environment is configured to generate a risk level associated with each end-user based on historical transactional data from each user.
The system including any Key Feature and/or any sub-feature in which rewards are provided based on the generated risk level of each end-user.

### Indirect Debit

The system including any Key Feature and/or any sub-feature in which the data-analysis environment is configured to receive a direct debit request from a specific merchant and, when there is no data record of the entity agreeing to accept a direct debit from that merchant, to meta-tag the amount of any direct debit as a debt that the user entity owes to the specific merchant and to enable the user entity to make future payments to that merchant to progressively pay off that amount.
The system including any Key Feature and/or any sub-feature in which a direct debit request from the merchant is in a standard data format and is sent over a standard banking system, such as BACS.
The system including any Key Feature and/or any sub-feature in which the data-analysis environment sends a data signal to the merchant that a direct debit request has been accepted.
The system including any Key Feature and/or any sub-feature in which unpaid amounts are configured to be automatically repaid in the future in circumstances defined by a rule.
The system including any Key Feature and/or any sub-feature in which the system is configured to enable a user-entity to input a schedule of payments for the unpaid amounts.
The system including any Key Feature and/or any sub-feature in which the system is configured to enable a user-entity to manually settle the unpaid amounts or part of the unpaid amounts.
The system including any Key Feature and/or any sub-feature in which the system is configured to automatically send an alert to the specific merchant when the direct debit request has been modified.
The system including any Key Feature and/or any sub-feature in which the system is configured to provide the customer related parameters to the specific merchant.
The system including any Key Feature and/or any sub-feature in which the system is configured to notify the specific merchant of the total amount of the debt that is remaining, on a scheduled basis.

### Reconciliation

The system including any Key Feature and/or any sub-feature in which the data-analysis environment is configured to automatically reconcile or allocate any unused amounts after the transaction or event has concluded among the multiple entities, according to rules or conditions as agreed by the multiple entities.
The system including any Key Feature and/or any sub-feature in which the data analysis environment is configured to automatically distribute any remaining money or crypto or rewards or non-fiat currency linked to a shared data object between the multiple entities according to rules or conditions as agreed by the multiple entities.
The system including any Key Feature and/or any sub-feature in which the rules or conditions define the distribution of any unused amounts according to pre-agreed principles of fairness.
The system including any Key Feature and/or any sub-feature in which the rules or conditions prohibit any entity receiving more than they contributed.

### Intent Based Lending

The system including any Key Feature and/or any sub-feature in which the data-analysis environment is configured to generate credit evaluation data for a merchant that automatically takes into account data objects that capture future intent or spending plans of one or more entities with the merchant.
The system including any Key Feature and/or any sub-feature in which the data-analysis environment is configured to consolidate or group all data objects that capture the future intent or spending intent of multiple user entities with the specific entity.
The system including any Key Feature and/or any sub-feature in which the data-analysis environment is configured to generate credit evaluation data for that entity that automatically takes into account the consolidated or grouped data objects that capture future intent or spending intent with that entity.
The system including any Key Feature and/or any sub-feature in which the data-analysis environment is configured to automatically generate a revised credit score for that specific entity, that takes into account the consolidated or grouped data objects that capture future intent or spending intent with that entity.
The system including any Key Feature and/or any sub-feature in which the data-analysis environment is configured to automatically analyse a loan request for that entity, taking into account the credit evaluation data and/or revised credit score.

### Cash Proxies

The system including any Key Feature and/or any sub-feature in which the data-analysis environment is configured to store a data record for the amounts of one or more non-fiat items owned by or associated with that user entity and, when the user entity starts or enters a proposed transaction in a fiat currency, then the data-analysis environment retrieves or looks up an exchange rate between the non-fiat item type and the fiat currency, and automatically calculates how the transaction could be completed, in whole or part, using the non-fiat items at the prevailing exchange rate.
The system including any Key Feature and/or any sub-feature in which non-fiat items includes reward points, Crypto tokens, Merchant Money (i.e. non-fiat currency linked with a specific merchant or group of merchants, such as rewards points).
The system including any Key Feature and/or any sub-feature in which the data analysis environment is configured to apply a pre-defined set of rules or conditions to determine if and how much non-fiat items should be used to pay for the transaction.

### System Architecture

The system including any Key Feature and/or any sub-feature and that includes or accesses a private cloud infrastructure, in which the data processing services are contained with a Virtual Private Cloud (VPC).
The system including any Key Feature and/or any sub-feature and that includes an API gateway configured to receive HTTPS requests from public access points.
The system including any Key Feature and/or any sub-feature and that includes a private load balancer, and in which the API gateway forwards any received HTTPS requests to the private load balancer.
The system including any Key Feature and/or any sub-feature and in which the private load balancer distributes the HTTPS requests across multiple service layers.
The system including any Key Feature and/or any sub-feature and in which each service layer within the VPC includes its own cluster, and in which each service layer is independently scalable.
The system including any Key Feature and/or any sub-feature and in which each service layer has access to its own data store.
The system including any Key Feature and/or any sub-feature and in which each data store encrypts its at-rest data using a unique key.

### Use Cases

The system including any Key Feature and/or any sub-feature in which the data objects track data associated with one or more of the following: a bank; an asset or wealth manager; an insurance company; a pension provider; a merchant loyalty or reward programme; a group or team or club.
The system including any Key Feature and/or any sub-feature in which the data-analysis environment is connected, via an API, to the data infrastructure of one or more entities that publish solutions to consumers, where data or meta-data for the solutions is matched by the data-analysis environment to meta-data for consumers that describes the consumers' future intent or intended future actions.
The system including any Key Feature and/or any sub-feature in which the entities that publish solutions are one of the following: a bank; an asset or wealth manager; an insurance company; a pension provider; a merchant loyalty or reward programme; a group or team or club.
The system including any Key Feature and/or any sub-feature in which the data-analysis environment is connected, via an API, to the data infrastructure of one or more of the following entities: a bank, an asset or wealth manager, an insurance company, a pension provider, a merchant loyalty or reward programme, a group or team or club, to enable the provision of services to customers of the entity.
The system including any Key Feature and/or any sub-feature in which the data-analysis environment is connected, via an API, to the data infrastructure of one or more of the following entities: a bank, an asset or wealth manager, an insurance company, a pension provider, a merchant loyalty or reward programme, a group or team or club, to enable the provision of services to customers of the entity that extends the scope of that data infrastructure to include data objects that are (i) created by the customer to define the customer's future intent or intended future actions, such as to enable the customer to plan, budget, share and control their finances and (ii) track transactions, such as purchases.
The system including any Key Feature and/or any sub-feature in which the system includes a data-analysis environment configured to include digital wallet functionality.
The system including any Key Feature and/or any sub-feature in which the data-analysis environment is configured to enable personal budgeting for future spend across different categories, e.g. shopping, petrol, mobile phone, utilities etc. using data objects, e.g. virtual sub-accounts, that are specific to each category.
The system including any Key Feature and/or any sub-feature in which the data-analysis environment is configured to enable financial contributions to a shared or group social activity and spending on the activity, using a shared data object, e.g. a shared virtual sub-account, associated solely with that activity.
The system including any Key Feature and/or any sub-feature in which the data-analysis environment is configured to enable children's pocket money, by enabling a child to spend directly from a defined data object, but in ways that are controlled in advance by an adult who controls the data object.
The system including any Key Feature and/or any sub-feature in which the data-analysis environment is configured to enable long term savings and pensions, by providing a data object, e.g. a virtual sub-account for savings or pensions, and to enable a customer to set up rules that determine regular payments into that data object.
The system including any Key Feature and/or any sub-feature in which the data-analysis environment is configured to enable testing and analysis of different incentives designed to explore what induces consumers (and what their demographic parameters are) to commit to allocating funds to a specific merchant or data object.

### Underlying Segmented Data Structure

The system including any Key Feature and/or any sub-feature in which the data-analysis environment: (i) includes a data record for a root or primary virtual account for an entity, and also data records for one or more data objects of the root or primary account, such as a UUID or other uniquely defined logical entity, that are defined or created by that entity and are linked to the primary virtual account, the data objects constituting the data objects.
The system including any Key Feature and/or any sub-feature in which the data-analysis environment: is configured to include a multi-level hierarchy of accounts, with a root or primary virtual account at the top level, and data objects at a lower level, and one or more core virtual accounts, each specific to one type of store of value, such as either money, or crypto, or rewards, positioned in-between the root or primary virtual account and the data objects, so that transaction data flows from the root or primary virtual account to a core virtual account and then to a data object.

### Appendix 2: Back End Differentiation: HyperJar

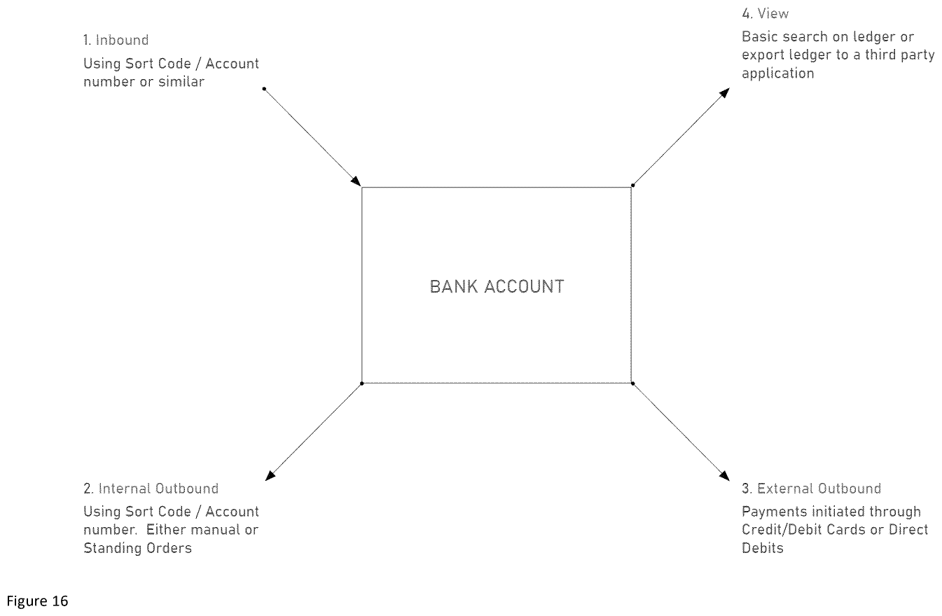

This Appendix 2 describes the HyperJar system in more detail. As shown in FIG. 16, a typical bank account (a store of money/ledger) application offers a consumer four main functions:
Make inbound payments/deposits (1)
Internally generate outbound payments (2)
Externally generate outbound payments (3)
View the underlying transaction ledger (4)

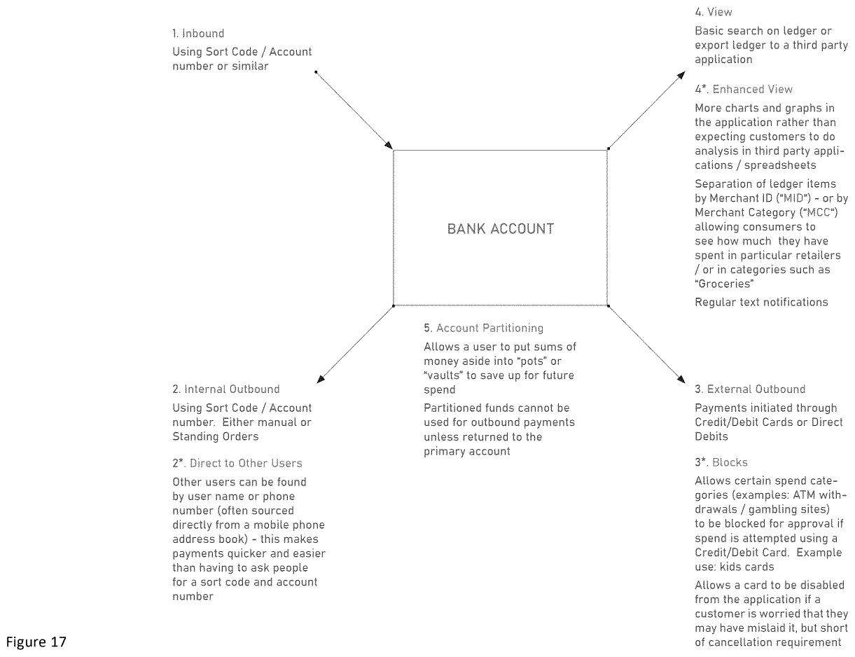

As shown in FIG. 17, most NeoBanks offer minor but meaningful enhancements to the core bank application functions. These come in four main flavours:
Simplified Internal outbound payments (1)
Enhanced views and information (4*)
Account Partitioning (5)
Blocks on certain external outbound destinations (3*)

These features have proved very popular-especially simplified payments to friends. This has also been combined with very simple on-boarding journeys which make the pain threshold for trying the apps very low (for good or for ill). Implementation is relatively straightforward however, and many conventional banks are incorporating these enhancements in their own mobile/digital offerings.

### Unlocking a New Feature Set

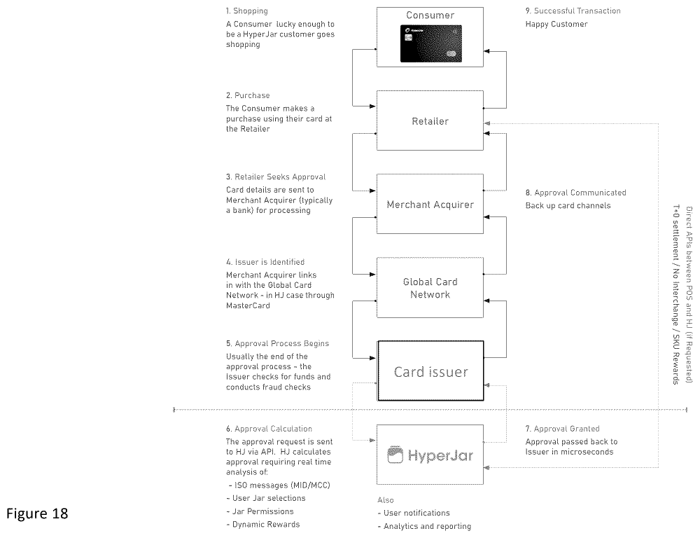

As shown in FIG. 18, HyperJar offers significantly enhanced and highly compelling consumer functionality compared to other NeoBank digital offerings. These features are set out in subsequent sections.

In order to “unlock” the enhanced feature set extremely fine control of the External Outbound Payment Channel is required.

This involves embedding a substantial rule-engine (see rule engine 25 in FIG. 1) into traditional card payment workflows which allow significant calculations to be conducted in real-time on receipt of the payment request signal from the Point of Sale (“POS”) (i.e the point in time of approving the sale, rather than making and changes at the merchant POS terminal) when a consumer is using their payment card-our name for these processes is “PosTech”.

### Multiple Primary Accounts

For Many Consumers, there has Always been a Compelling Use Case for Multiple Bank Accounts:
For separating out savings-either for the rate, or more often to “protect them from being spent accidentally”—the “piggy bank” effect.
For segregated spending (business; household expenses; taxes)
   This has Often been Operationally Fiddly:
Requires opening multiple new bank accounts
Where indirect spend is required-carrying multiple cards and/or opening accounts with different providers

NeoBanks (examples: Monzo, Revolut) have offered a partial solution, allowing Users to quickly partition funds into segregated pockets (examples: Pots; Vaults) within their applications. Their limited functionality creates a number of limitations:
Funds need to be transferred back into the primary wallet for spend—clumsy UX
Effectively the spend-ledger only exists in the primary wallet rather than being associated with the partitioned account—this significantly reduces the clarity of information for analysis and budgeting

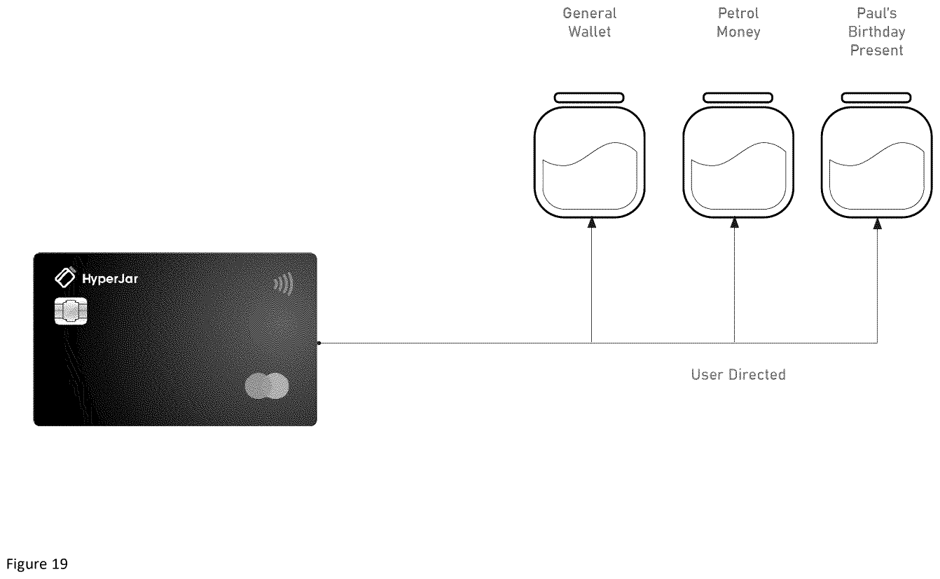

HyperJar allows Users to create an arbitrary number of fully functional accounts (“Jars”), as illustrated in FIG. 19.

A User can simply select which Jar they want the next spend to come from by selecting it in the app (for a single payment or until changed). This means that:
Arbitrary amounts of money don't need to be shuffled back into the primary wallet (example: a Pub Jar—can be selected when one is in the Pub for the evening/morning)
Ledgers are coherent and correct (example: all household spend is clearly logged against the “Household Spend” Jar) rather than just being a big jumble in the main ledgers (Some applications attempt to address this with post spend tagging, however the solutions are often manual and clumsy)
This feature plays extremely well with the other enhanced functions (see following sections)

PosTech is required since limits are different (and for multiple transactions, change with spend) based on which Jar a user is spending from at a given point in time. Every Jar has a unique ID—so payments from other users can be pointed directly at a Jar (examples: collections for a charity event; client payments to a fitness instructor). Payments can be made directly, and Standing Orders can be set up from any Jar.

### Some Fintech Offerings Attempt to Specifically Address Multiple Discrete Accounts:

Open banking data aggregators.
Many-to-one card consolidators

These tend to be relatively clumsy and/or don't properly answer the question: why do you have multiple accounts with different providers in the first place? Whilst there are other reasons for multiple accounts (differing savings rates; points programmes) we believe that a reasonable slice of the rationale is separated payment functions (example: a home and a business credit card) and a requirement for split ledgers. HyperJar directly addresses this user journey in a very clean and simple fashion within a single application.

### Overflow

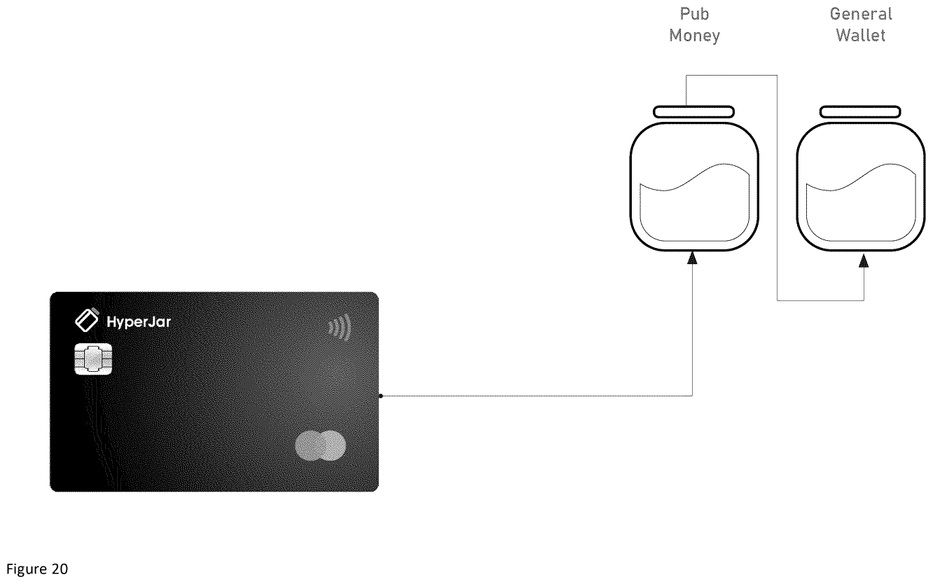

To the extent that spend exceeds the balance of a given Jar, any Jar can have a nominated “Overflow” into any other Jar (or none if selected by the User), as illustrated in FIG. 20. Overflow initially defaults to the primary Wallet (the Users “home” Jar).

Any transactions which are split across Jars are noted in the transaction logs of all Jars in the chain (as associated transactions). Overflow can be used for:
Making sure that embarrassment is avoided at POS if a Jar which has been selected (such as Household Expenses) gets declined due to lack of funds (unless this is the explicit choice of the User)
As such, prevents unnecessary over-funding of Jars—exact budgeting is possible.
Allows for zero-balance Jars which can be used to capture a ledger—this feature plays particularly well with Shared Jars and Reconciliation (see below)

### Other Points to Note:

Chains of more than two Jars are allowed—only really useful when considering combining with other functionality—a “power user” feature
Limits can be set on how much can be drawn from a subsequent Jar (indeed any Jar-see section on Limits below)—effectively an “overdraft”
In the (highly unlikely) event of a circular reference—the loop is terminated at repeat (by definition empty)

### MID/MCC/ISO Directed/Restricted Spend

Every card transaction message (an “ISO”) has an identifier called a Merchant ID (a “MID”) and a Merchant Category Code (an “MCC”).

### This Allows a Processor to Determine:

Who the retailer is (example: Lidl).
What sort of retailer it is (example: Grocer)

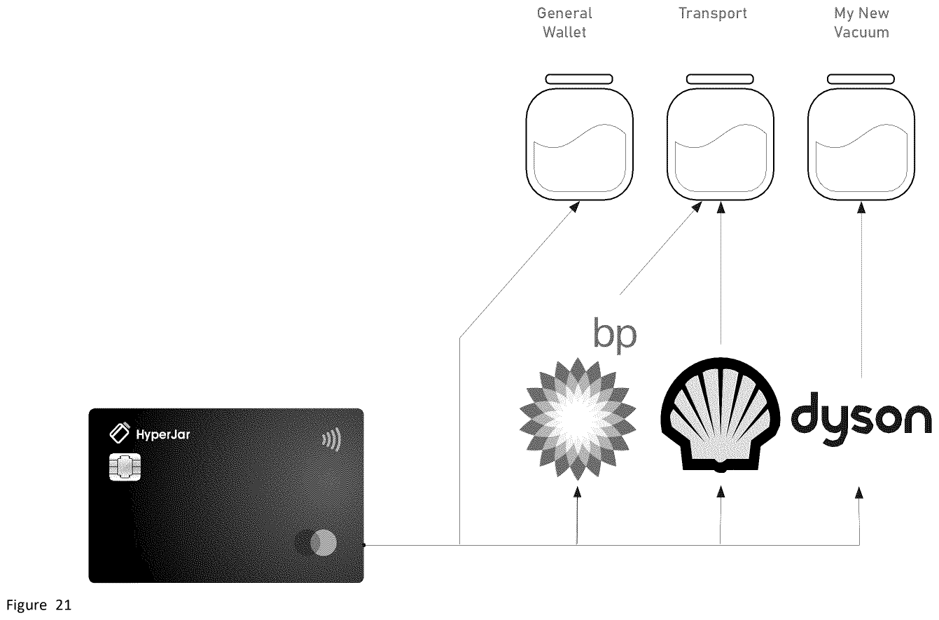

Some apps have basic binary MCC control—i.e. one can exclude Categories (examples: ATM; Gambling)—this is done for security, or for provision of Cards for Children (example: Go Henry). HyperJar allows any MID, MCC or User defined collection of MIDs/MCCs to be directed at a specific Jar, as illustrated in FIG. 21.

This Means that:
Budgeting Jars (such as Groceries) can be automatically debited without requiring a manual change of the active Jar
Users can direct spend from particular merchants into specific Jars (example: My Saturday morning shopping run).
For HyperJar Partner Merchants (“PMs”) this allows our flagship Reward (“Hypothecation”) to be attached to specially locked Merchant Jars (See section on Rewards)

Directed Spend relies critically on PosTech since the available maximum balance in a Jar (or a chain of Jars) needs to be calculated in real time by HyperJar (given the path can be different by Merchant).

We also allow Restricted Spend—this is setting a Jar so that it can ONLY be used at a list of MIDs/MCCs. This allows:
Shared Jars that only work at selected Merchants
PM Jars that can be locked/committed in return for awards-Hypothecation

Requests for MCC Directed Spend are often surfaced in the customer requests section for NeoBanks who have separated accounts but have not been surfaced as functionality to date.

### Payments+IOUs+Messaging

### Some of the Most Popular Features of Modern Digital Wallets are:

Payments to other Users (so they are easy to execute using phone numbers rather than sort codes and account numbers)
Requests for payments from other Users, sometimes associated with splitting of payments (example: for a restaurant meal) between two or more Users
   HyperJar Extends this Model:
Requests for payments (“IOUs”), and obviously payments themselves, can be attached to any Jar—this allows for specific Jars to be created for specific purposes (examples: “Paul's Christmas Present”; “Team Outing”; “Tony's Physiotherapy Clients”)
Every Jar has a unique ID—so Payments can be made/requested without reference to a phone-number (phone number is associated only with the User Wallet—and the Wallet also has a UID). This gives flexibility in directing payments, but also means that a User does not need to give up their phone number to identify themselves for payment if they do not want to
IOUs (attached to the Requestor Jar) have a balance and can have a time counter attached to them—this is in direct response to Merchant feedback for a digital billing wish-list. (example: “You owe British Gas £80 in 30 days”). One of the benefits of keeping a balance attached to an IOU is that a complete payment is not required—an IOU can be paid down in multiple “micro-payments” (see associated note on “Indirect Debits” for why this is a big deal, especially for Utilities)
A full messaging service is included with Payments and IOUs. This can also be specific to a given Jar (example: a charity collection-“Good luck on in Ride London Paul!: Kylie xxx”).
Note that a User can message themselves: essentially allowing them to annotate Jars with text (example: a shopping list)
All messages/payments can be notified instantly on a phone—it is also straightforward to make push notifications to more persistent messaging services such as WhatsApp

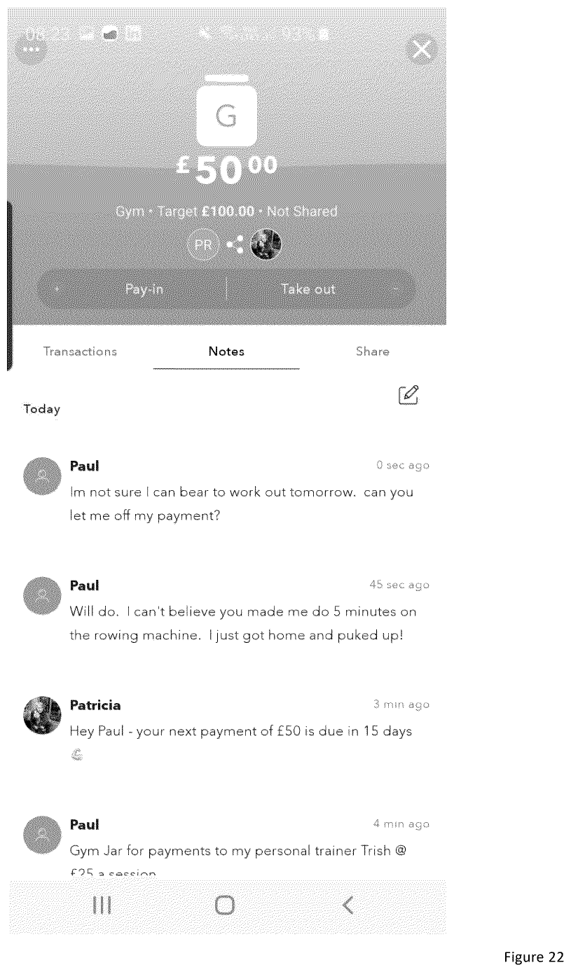

FIG. 22 shows a screenshot of a chat. Messaging at a Jar specific level provides the cornerstone to effective social spending (see next section on Shared Jars)

### Shared Jars

The functions of Bank Accounts are typically designed for single Users. This is a shame because a great deal of spend is increasingly social, within families; groups of friends; clubs; or work colleagues. Social spending has historically driven a number of behaviours:
Couples opening joint bank accounts: both to consolidate spending but also ledgers for budgeting and understanding household spend
Groups requiring common spend opening up a bank account: example: Students in a house share opening up a bank account for payments of household bills which they pre-fund
The Kitty: example: a group of friends going on holiday where everyone chips in £50 in cash and all drink and food is centrally purchased

### These Methods are Clunky:

Opening joint bank accounts is: time consuming; complex; causes a proliferation of payment methods and statements; and is hard to control since all participants typically have equal administration rights (example: One can simply extract all funds)
Using shared cash is hard to manage and reconcile- and is more and more frustrating in an increasingly cashless (and contactless) world

HyperJar dramatically simplifies this with the ability for a given User to instantly share their Jars amongst one or more other Users, with precise control on what people can and cannot do:
Limits (how much any other User can spend)
Read permissions (on Ledger items not generated by any other User)
Messaging read/write permissions
Control of pay-out channels (currently only spend out on cards is allowed)
Administration rights for full joint Jars (essentially full joint accounts-currently disabled)

This functionality is proving extremely popular with our initial group of Users-essentially social spending and budgeting. Sharing also combines extremely well with:
Selecting Accounts: Since Users can select which Jar they spend from, it is possible to point multiple cards to a single Jar (example: a group of friends on holiday, all using their cards to spend from a single Jar “Benidorm 2019”). This is both highly convenient, and allows an entire group activity to be cleanly and automatically logged in a single ledger that all parties can see.
Messaging: allowing groups to mutually spend and message through a single shared Jar (examples: shopping lists; explanations for payments; general chat).
MID Restricted Spend: A User can share Jars with people that can only be used in certain locations (examples: a family Boots Jar; a petrol Jar; a jar that can only be used to pay utility bills). Note: MID/MCC Restricted Spend is a characteristic of a Jar; MID/MCC Directed Spend is a characteristic of a User.
Overflow: A Shared Jar doesn't have to be pre-funded (or over-funded). Sharing a zero-balance Jar still creates a ledger which automatically logs all joint spend-since all payments simply “overflow” to individuals Wallets (or to which ever Jar a User has directed them). Note: Overflows are characteristics of Users. Users can then settle up later (see following section on Reconciliation) using IOUs.

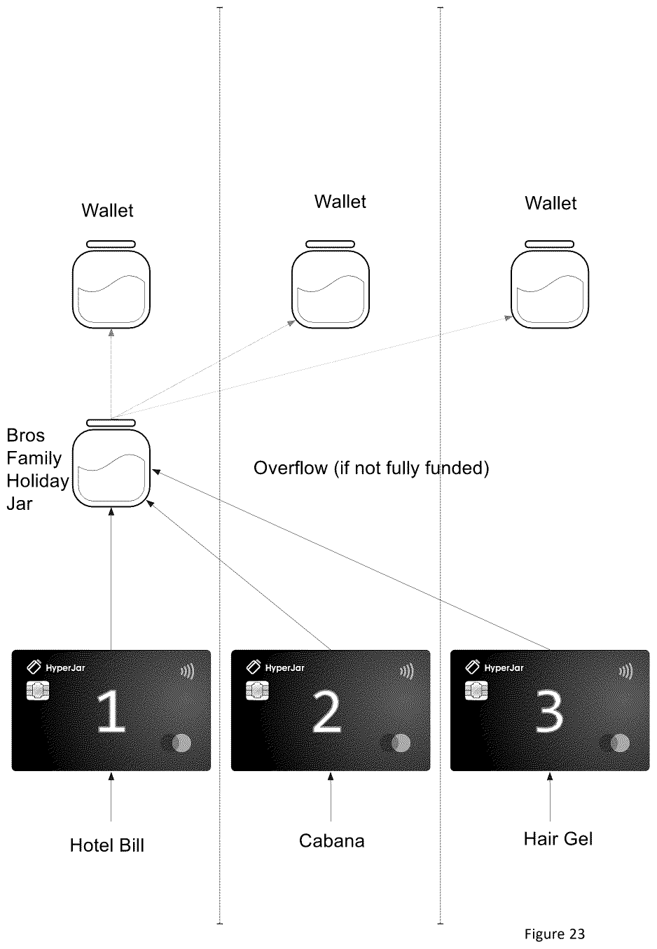

An illustration is provided in FIG. 23.

### Reconciliation

As discussed above, one of the more popular uses of apps is for splitting payments. This tends to come in one of two forms:
Manually selecting one or of more payments in a User's own application (after the event) and then “splitting” them between a number of other Users, a primary use case being the splitting of restaurant bills (avoiding the aggravation of a group all throwing their cards down then having to watch the server practicing their division).
Using one of the increasingly popular bill splitting apps (examples: Splittr; Splitwise).

These are often used for holidays—where everyone manually enters their expenses in a shared ledger—the app does the reconciliation at the end of the trip, and tells everyone what they need to pay (manually)—often with exchange of Sort Code information and so on.

Clearly a level of trust is required in both cases: both, that bills will be settled in the future, and that “errors” (mistaken or otherwise) will not be made.

Shared Jar Functionality Significantly Enhances these User Journeys for Reconciliation:
A group can quickly set up a Shared Jar—in our User testing these tend to persist—example: a group of four friends who regularly dine together
This Jar can be unfunded, partially funded or over-funded (depending on trust).
Any spend can be automatically driven through the Jar by simply making the Shared Jar the active Jar.
This allows multiple spend events (for example: rounds of drinks; household expenses; a stag party) to be automatically logged in their own specific ledgers.
At any point, the owner can ask HyperJar to reconcile the Jar. HyperJar simply calculates net contribution (by looking at deposits, spending and overflow) and sends round the appropriate IOUs.

In this way, the main processes of bill splitting applications can be entirely automated within the HyperJar environment (unlike bill splitting apps which involve multiple manual processes), and there is no requirement for individuals to select and split individual payments (unlike payment splitting functionality which doesn't achieve any netting) but can operate easily on entire ledgers

### Merchant Rewards Engine

Merchants and retailers like to offer current or prospective customers financial rewards in order to encourage behavioural variation-usually to generate long term loyalty or direct encouragement for spot spending.

HyperJar is entirely free for consumers-our business model does not involve direct charges for membership, or indirect charges for lending (such as overdrafts). Instead our model revolves entirely around providing (and being paid for) integrated services for merchants to connect and interact with customers in a GDPR compliant fashion (communications; marketing; surveys; rewards). The most important part of this is our cutting edge Merchant Rewards Engine (“MRE”) which crucially relies on PosTech to operate. The model takes advantage of MID Directed Spend and our ability to calculate payment approvals in real time to allow Merchants (especially physical Merchants) to provide an extended range of Rewards (including all current standard Rewards). The MRE can:
Calculate if a particular Reward is active in real time at POS based on compliance with a broad set of criteria (see below)
Calculate the value of a Reward in real time at POS based on a wide variety of variables (most importantly: size of spend)

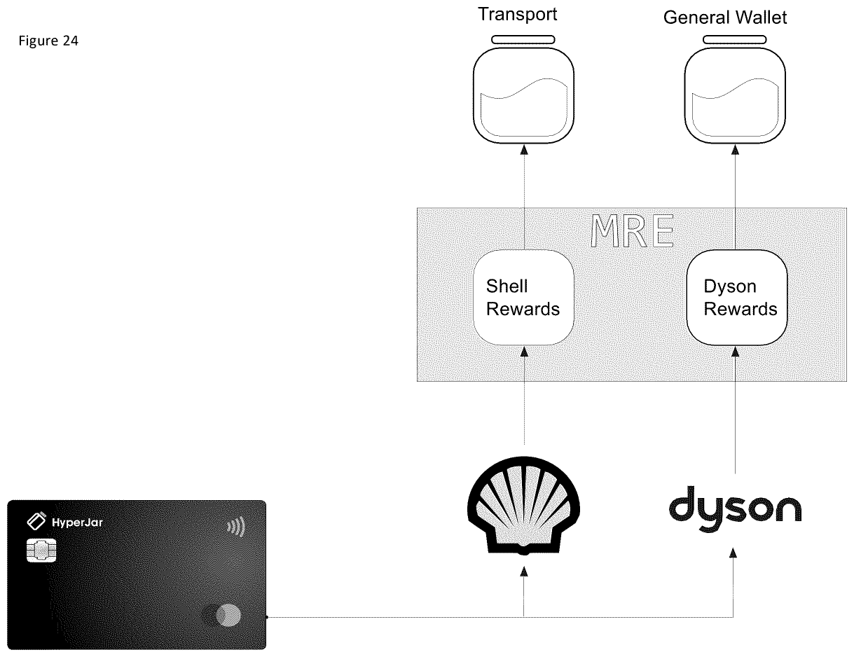

An illustration of the MRE engine is provided in FIG. 24.

Most current reward models operate “after” POS—that is, a Customer gets a certain number of points, or some form of Cashback.

### The MRE Allows for Far More Interesting Rewards to be Offered Such as (Amongst Many Others):

Percentage discounts based on spend-preferable both to the consumer (they need less absolute money and its clearer from a ledger point of view) and the Merchant (attractive VAT consequences)
Randomised rewards (example: one in a hundred consumers gets a free tank of petrol up to £100)
Our flagship reward: Hypothecation—where rewards grow over time

Rewards are essentially temporary ledgers that are included in the calculation of payments when spend occurs. This means that they fit seamlessly into ledgers as shared sources of funds.

### Reward Conditions

Sets of Reward conditions (which are evaluated at POS as either True or False) are used for three events:
Is a Reward visible to a User?
Is a specific Reward Condition (either satisfied or not) visible to a User?
Is a Reward Active? (i.e. it will pay-out)

Conditions that can be set in conjunction with Merchants fall into a number of categories set out below (with examples). Note that all conditions which include personal details are consented not assumed.

### Consumer Demographics

Provided by the Consumer. Examples: Age; Sex; Location
Provided by the Merchant (to the extent that there has been an appropriate additional consent for an account number match). Examples: is a current member of a reward scheme?

### Consumer Behaviour in HyperJar

Historical financial spend (generally; with the Merchant; from a specific Jar)
Current spend at POS in real time
Savings patterns
MID Restrictions or Directions to a Merchant (for Hypothecation amongst others)
Existence of other Rewards (allows for “Jigsaw Puzzle” style Rewards)
Use of features (examples: invited friends; shared Jars; made Merchant specific gifts to others)
Completed Merchant surveys
Agreed to allow Merchants access to incremental data

### Environmental Conditions

Time. Example: Super Saturday discounts
Location: Examples: in particular branches of a store in a town/digital vs bricks and mortar spend

### Reward/Merchant Specific Conditions

Total number of Rewards offered
Total amount of Rewards offered (Example: a £10K campaign)

### HyperJar Specific Conditions

Limits on total number of Rewards
Constraints generated because HJ determines unexpected/abusive behaviour

### Six Initial Payout Models for Rewards are Currently Contemplated:

Fixed amounts of money (example: a £10 pound voucher)
A percentage amount of money (example: 10% off total spend)
Rewards that have grown over time (example: 4.5% AGR on any funds that have been committed to the merchant)
Randomised awards (example: 1 in 1,000 customers gets a free tank up petrol up to £100)
Vouchers/promotion codes/inventory that can be used separately/delivered by the Merchant
Badges that have no direct monetary value but may confer status and be conditions in future awards (example: a gold saver at a given supermarket)

### SKU Codes

If a Merchant directly integrates with HyperJar then it is possible to break out individual items in a spend at POS allowing for highly targeted awards (examples: X % off in this department; £10 off a bottle of Grappa). This functionality currently exists, (often at the till) for some large merchants, but is much more powerful when combined with the other conditions available in the MRE. HJ has con-templated SKU based conditions and payouts in our designs and will implement when Merchants choose to integrate with us (a journey for now)

### Analytics

Analytics are a Popular Enhancement Offered by Many Fintech Apps. Either:
Directly in the Wallet
Indirectly by Aggregators of data sourced from one or more wallets/bank accounts/payment channels using APIs-more often than not provided under European Open Banking regulations to firms registered as AISPs.
   For Both Direct and Aggregators, Analytics Usually Include Some (or all) of the Following:
Breakdown of spend by MID, or by MCC. Example: a User can see how much they spent over the course of say, the last month, with Tesco's or on Groceries
Some ability to manually “Tag” transactions (or MID codes) to allow a User to see how their own categories evolve over time (example: regret spend; household goods)
Some functionally to set budgets/watches/notifications on MIDs/MCCs/Tags to message or flag when spend is over (or under) budget over some time-frame (example: a notification to say that you have exceeded your monthly Gambling limit by £100)
   Aggregators have Limitations:
APIs for AISPs are still clunky; not homogeneous, and rarely run in real time
Simply analysing a conventional primary bank account can be very incomplete because many users do not use debit cards, preferring to use their main accounts for direct debits, payments on credit cards and bill payments to sort codes-none of which are particularly amenable to MID or MCC analysis
How many people actually have multiple bank accounts?
A User has to have two (or more) applications to analyse their spending

Direct analytics in Wallets/Accounts work better than Aggregators if a User can be convinced to drive the majority of their spend directly though the app (by (in a somewhat circular fashion) analytics; or rewards (for most, non existent or rudimentary)

Most conventional bank accounts have recognised that their analytics are lacking and are rapidly building the functionality to catch up. The common limitation of current analytics is they tend to be entirely related to Spend.

The HyperJar ledger in necessarily more complex. Every transaction records (amongst other fields):
Source: If outbound, which Jar (or Jars-including MRE amounts) a payment was made from (as opposed to only originating from a primary Wallet)
Destination: Where a payment has been made to (including another internal Jar, or a Jar which has been shared)
User: Which User initiated the payment-entirely unique to shared Jars
Amount
   This Allows for a Far Richer and More Useful Analytic Framework. For Example:
Scopes: analysing and breaking down spend from specified Jars only (without requiring laborious post spend tagging). Examples: how much am I spending monthly from my party Jar? What is the merchant breakdown in my home improvement Jar? These Scopes are lost entirely if funds need to be moved into a single fungible Wallet before spend occurs. This allows for much more specific spend budgeting (and notifications) than simply looking at MCCs
Balances: An analysis of funds set aside vs. funds spent. Because inflows and outflows (for a specific purpose) can be attached to a single Jar, a real analysis of savings as well as spending can also be produced. This allows for savings budgeting and notification (example: the balance of your shared household Jar is now under the amount you would need to meet your average historical monthly spend)
Social: As discussed, many spending patterns are social. HyperJar makes exploring group spending and saving very straightforward (Example: overall family petrol spend). Note: Jars can be shared as read only with no spend rights-so Jars can be aggregated purely for analytics under a given Scope. This also allows for User partitioning in analytics (examples: relative spend at Boots between different household members; relative contributions into a Jar for the office Christmas party; net contributions to an incidentals Jar). Today most analytics are individual—to look at social savings or spending requires extraction of individual ledgers from different accounts and consolidation in a third party application (for example: Excel)
Rewards: because Rewards (static and dynamic) are intrinsically embedded in a Users ledgers we can provide analytics about overall levels of value that have been delivered/achieved by User interaction with Merchants
Time: How long funds have existed in a given state: committed; shared; budgeted

HyperJar believes that this incremental analytic functionality is highly differentiated. It also allows for far more interesting comparative demographic analysis (i.e. metrics vs. friends/groups/similar people/everyone) to be calculated which we believe we be welcomed (opt-in required for incremental details):
Relative spend breakdowns
Effectiveness of budgeting/saving
Relative ratios showing how a User: saves; budgets; shares; plans; receives incentives; gifts

### Other Functionality

The Following Functionality is Currently being Implemented:

### Scheduled Payments

HyperJar increases functionality of scheduled payments (for example Standing Orders) in the following ways:
Scheduled payments can be set up from any Jar to any other Jar (examples: I want to put £10 a week into my Christmas Jar; I want to pay £50 a week from my Sport Jar to my personal trainer)
Scheduled payments (with limits) can be set up to automatically satisfy IOUs from other Users (example: I will automatically complete any IOU from my friend Matt up to £100)
Scheduled payments can be made up to a target balance set on another Jar (example: once a month, top my family Petrol Jar up to its target balance from my Wallet).

### Multiple Cards

The ability to manage multiple separate cards (physical or virtual) from a single account:
Allows for children's cards to be managed from a parents application (with full restrictions/MID control and so on)
Allows for separate digital and physical cards (for security: you can't lose a digital card)
Allows for disposable cards to be generated (this feature exists in some other applications) in order to make one time purchases from less trusted websites

### Rule Engine Complexity/Smart Contracts

IFTTT Rules to Control Functionality have the Potential to Power Interesting User Journeys:

### EXAMPLES

Once participants have paid in over £1000 to Paul's Birthday Present shared Jar, then notify and unlock spend.
If Jar balance less than anticipated schedule then top the jar up to schedule if there are sufficient funds in the Wallet
If my gas bill is due (checked via external API call) then pay it 20 days later if I have sufficient funds in my shared Utilities Jar

### Conventional Functionality

Apple/Google Pay
Direct Debits (Forked from specific Jars in an identical manner to PosTech)
Faster Payments
Direct control (and therefore payments in) from primary bank accounts

### Card Administration Portal

Because the extended functionality is unique, HyperJar has built a bespoke administration portal for both User and Merchant interaction—the Card Administration Portal (“CAP”) which is a central hub for:
Customer services
Reporting and Business intelligence
Merchant services administration
Fraud and AML monitoring

CAP is a user-friendly, web-based interface which utilises bank grade security protocols and industry standard user access to ensure customer data is secure, while allowing for a remote team of customer service representatives (“CSRs”—currently a staff of ten) to log in from any location. Functionality is compartmentalised, meaning CSRs and management can only access functionality reflective of their role in the organisation. All actions undertaken by staff are permanently logged. CAP does not contain any payment data that can be potentially used to defraud customers. A customer PAN, CVV and PIN are not accessible to CAP users and are stored at a PCI compliant issuer processor.

### Customer Services

When a customer queries a particular transaction it is imperative that the customer service representative (CSR) must have a complete overview of a customer's account in an easy-to-digest manner. CAP allows our agents to locate and access a customer's account using a variety of search terms. CSRs can view a customer's overall balance, jar balances, all transactions that have taken place on the account, personal information associated with an account, the number and type of jars they have created and whether these are shared. CAP is integrated to a customer live chat, combining our in-house functionality with market leading customer service tools.

### Reporting and BI

CAP serves as a central repository for data originating from partners and also data accumulated in the HyperJar ecosystem. Administrators have a complete overview of HyperJar data which can be accessed via a Dashboard screen or downloadable reports. (in development) The dashboard includes:
Programme performance statistics (card sales, volume of transactions, funds loaded to accounts, transaction heat maps)
Merchant partner statistics (volume of sales, volume of funds committed to the merchant, number of merchant jars created, rewards campaign statistics)
Administrative statistics (customer service data, stock reports, data of lost and stolen card)

### Merchant Services

HyperJar merchant partners can create and configure Reward campaigns to drive user acquisition and behaviour using the CAP interface. This is currently managed through CAP in-house but is scheduled to be rolled out directly to our PMs in six months. CSRs have the capacity to add a merchant MID should a transaction from a merchant partner originate from an unknown MID.

### Fraud and AML Monitoring

The compliance team has read access to all customers inbound and outbound transactions. Each customer has an associated Risk level. High risk individuals are closely monitored for suspicious transactions (customer accounts can be frozen using CAP). Team member can associate notes with individuals which are permanently stored against a user's account but can only be viewed by other members of the compliance team to prevent ‘tipping off’.

### Conventional Features

Customer identification and search tools
Viewing/updating customer KYC/details/statuses
Real-time transaction logging
Internal audit logging
Fraud and AML tools
Filtering of transactions by type/merchant and date
Activity feed with full breakdown of events that have taken place on an account
Application management queues
Creation of real time program performance statistics dashboard
Card-holder balance adjustment interface
Integrated to customer live chat.
Live chat in-App with first response rate in less than 40 seconds

### HyperJar Specific Features

Full control, permissioning and ledger visibility for all forms of Jar and Reward—with permissions view (who is the owner, spending permissions and participants)
Management of transactions split across multiple Jars and Users
View of jar currently linked to card
Ability to set/modify MID controls
Ability to create and administrate merchant rewards campaigns

### Appendix 3: Consumer Intent

Spending is an Asset Class: Most people in financial services are very surprised by this statement. Why? Financial services firms focus primarily on consumer assets which can be monetised through management (primarily: pensions; investments; deposits). Conversely, helping people spend well is not only hard to monetise, it also reduces attractive financial opportunities (examples: expensive credit; unnecessary deposits)

### In Reality not Only is Spending an Asset Class, it is the Asset Class:

UK total expected lifetime earnings are £23.8 trillion
Discretionary household income represents 65% of income, so £15.2 trillion
All conventional UK consumer assets total £15.5 trillion. Financial assets are only £10.7 trillion.
The average person in the UK has £17,365 in savings, and the average UK retirement pension pot is £37,000. The lifetime average individual spend, on the other hand, is £1.5 million, and the total UK discretionary household spend is half a trillion pounds every year.

It is therefore our contention that consumer spending is a universal, under-serviced and widely misunderstood asset class. Deploying money well has huge inherent value, both in financial terms, but also for broader well-being.

The flip-side of this, deploying and spending money badly is orders of magnitude more negative than almost any other form of poor financial management. There are so many ways to get it wrong, and they are proliferating, not decreasing:
Over-spend: Accidental spending due to poor planning or visibility; making big purchases at the wrong time; under-estimating the long-term cost of an item, or how multiple items add up. A couple of rounds of unintentional gin and tonics can easily wipe out all of the interest earned in a savings account in an entire year.
Overdrafts: often entered into by accident; highly expensive for consumers, great for banks.
Credit: sometimes unnecessary; not seeking out the cheapest provider; not refinancing mortgages; running credit balances whilst having positive deposits in current accounts; only making minimum payments
Over-payment: failure to capture discounts; buying from the wrong channel; payments for convenience; utility selection error
Subscriptions: unnecessary spend on services or memberships that aren't used. Brits on average waste £30,000 in their lifetimes on monthly direct debits that are not used4.
Penalties: for not paying bills on time
Missing money: Failing to get benefits, refunds or compensation due
Fraud: getting ripped off-especially online
Sharing: lack of visibility of where ones money is spent by family, friends and other people who one devolves spend to; failure to capture money which is owed by ones network (for example: recovering money after paying for a group meal)
The average Brit is wasting up to £250 a month with bad money habits- and 60% of us admit to having them. Half a million workers took time off in 2022 due to their financial well-being, leading to 4.2 million lost days and a cost to employers of £1.56 bn. Studies in the US have showed that poor financial literacy can cost an individual around US$2000 a year.

### According to the Money and Pensions Services, in 2022

One in four people had less than £100 in savings to fall back on, and one in six had nothing at all.
9 m people often borrowed to buy food or pay for bills
22 m people said they don't know enough to plan for their retirement.
5.3 m children didn't get a meaningful financial education (Financial Capability Survey).

Clearly some demographics are more adversely affected than others by the fiscal and emotional costs of mismanaging money, but it is a universal issue.

### The Solution: Financial Intent

People should control spending as well as they are able. We call this skill being intentional with money. People who are good at this are very clear about, and manage their Financial Intent carefully.

Financial Intent Means Thinking about, Planning and Organising Your Money:
What do you intend to spend it on?
Where are you planning to spend it?
When are you going to spend it?
Who are you spending it with, or asking to spend on your behalf?
How do you intent to spend it?

When we do something with intent, we do it with an objective, with resolve and with purpose. Few positive things are achieved unintentionally: Intent is a good thing. Some people have always managed to be very intentional with their spending. To do this, many different tools have been used: spreadsheets; sticky notes; reminders; budgeting tools; memory and iron discipline; but most of all, good old fashioned physical cash. However lots of trends are changing how people spend, and it is harder than ever to be intentional.

### Financial Intent Today

In 2023, the challenge for people to spend intentionally is orders of magnitude more difficult than it used to be. Financial services innovations and the economic environment are making it harder, not easier:
Digitisation: The erosion of cash (55% of UK payments in 2011, only 15% in 2021) has taken with it lots of the features of physical money that help people with financial intent:
   Separation: The ability to easily allocate money to different purposes. ‘This £30 is for the baby-sitter’, ‘£10 for the children's pocket money’. In fact there has been a recent trend for “cash stuffing”: taking funds out of bank-accounts and putting them in envelopes so that they can't be spent by accident (bank accounts are unordered first-in-first-out (FIFO) ledgers which are very easy to overspend from.
   Visibility: the physicality of money-its ‘reality’ with tap-and-pay its far easier to spend (and overspend) without realising exactly how much you are spending and/or what you have left to spend. Frictionless payments are very convenient but have consequences about how people stick to budgets
   Devolved spending: the ability to manage others who spend on your behalf is harder when goods being purchased are digital. This results in the proliferation of intra-bank account transfers and the popularity of simple P2P payment applications. Recovering unspent funds and monitoring usage is now far more challenging. Cash-once the primary tool for managing delegated spending—is increasingly ineffective, and has never been a good solution for visibility or control.
Cost-of-living crisis: Annual inflation rose from 8.8% to 9.2% between January and February 2023, at highs previously seen around 30 years ago. Budgeting and value are more important than ever—as is being, and feeling, in control
Credit proliferation: UK consumers are borrowing about £1.5 billion a month, split roughly 50-50 between credit cards and other loans. Methods for obtaining credit are increasingly frictionless and delivered at the point-of-sale. At the time of writing the annual growth rate for all consumer credit is just under 7%. Products like pay-day loans, BNPL, rising contactless limits, and e-commerce embedded into social media have business models at least partly predicated upon our short-comings. People frequently make bad choices, especially with money and many “innovations” in the financial services sector are geared to encourage these.
Glamour: Debt products have been re-configured in marketing from their historical meaning of vulnerability to confidence, adventure, spontaneity and self-actualisation.
Complexity; and channel expansion. It is increasingly difficult to monetise your spending footprint and maximise value across the sprawling landscape of merchant rewards and offers.
Fraud: There has been a huge rise in online fraud, phishing, and password fatigue. In 2022, UK citizens lost £4 billion to fraudsters.
Demographics: As the exodus of cash from the economy accelerates, digitally disenfranchised cohorts suffer an outsized negative impact on their ability to manage intent. Some functionality for intent is already being digitised, and proving popular (more straightforward P2P payments; rudimentary separation of funds into separate accounts). However, these features are part of new digital offerings which are rarely targeted at, or taken up by, groups such as the elderly; children; the less well off; or people operating in the gig economy.

### Financial Intent Needs to be Digitised

The most logical place to build tools for managing Financial Intent is embedded in digital wallets. But why isn't it happening in any systematic way?
Technology: Implementation is difficult, especially given legacy technology stacks and large established pre-existing customer bases.
DNA: Banks are focused on originating deposits, making loans, and facilitating payments (the point-of-deposit or POD, and the point-of-sale or POS). For the simple reason that this is where their revenue is made, this is core DNA. This has three implications:
   No obvious financial motivation to “go first” on provision of intent based functionality. Quite the reverse, many banks participate in embedded finance and prefer digital payments to cash in general, for both interchange fees, data, and the ease of handling.
   A complete focus on the individual (because individuals deposit and borrow) which creates an effective blind spot when it comes to collective functionality. For most people, effective planning and spending needs to be done collectively, not individually—over 70% of UK households have more than one member10
   Banks focus on people who deposit and borrow. This group intersects with, but has different demographics from, the group of people who spend. There are 29M wage earners in the UK, but 63M people who spend. Large segments of the non-earning population are not a priority for current wallet providers, both in terms of targeting but also in terms of product design
   Merchants: every spending journey has an end point- and this end point is more often than not a merchant or a utility. In order to build a truly effective intent based wallet, close co-operation with the retail sector is required. This doesn't usually fit into the thought processes and skill sets of consumer financial services businesses.

This means that what happens between input and output, the point-of-intent or POI, has largely been ignored up till now and a typical current account remains unstructured, like keeping all your possessions in one pocket. Objects get mixed up so it's hard to find the thing you want when you need it, and to remember everything you have in there.

“You can't trust your bank account. Your bank account lies. When you check it, it only shows you a simple snapshot of the scene that day” Martin Lewis, Money Saving Expert on “Piggy-banking: The trick to Budgeting”

We conducted our own primary research of 500 UK adults aged 25-54 in June 2019 who bank online or on mobile, and found that:
42% think their bank account is unhelpful for planning and budgeting
Of the 45% who'd tried budgeting apps, over half said it made no difference, or gave up

Expressing financial intent doesn't just create monetary value. It enhances mental, emotional and even physical well-being. The US behavioural scientists, Dunn and Norton12 outline several major benefits of deploying your money with intent. One is positive anticipation.

Intent creates measurable neural activations that are good for you. One is the confidence of being in control, of having visibility over your future, of making sense of the world.

The other is that allocating money to a future purpose can make the money feel almost free, or ‘found’, when it is time to spend it. It is a positive inverse of the credit card dynamic: you go through the ‘payment-pain’ early, take it off the bottom line. This is the double dopamine of making money feel like it can be spent twice: once at the point of expressing intent, and once at the actual point of spend.

So spending intentionally not only maximises money's value and potential but boosts self-esteem and confidence. Exercising financial intent will give you “happy money”.

### HyperJar: Happy Money

HyperJar is the first wallet which systematically digitises intent, from the ground-up in the most useful and relevant place to do it: a digital wallet.

Intent forms all of our DNA and forms the bedrock of our business purpose. We have learned from behavioural science and from adjacent categories such as mobile gaming and fitness apps and applied them to our product. Examples include positive feedback loops, chunking habits into small steps, social consensus, and variable rewards. HyperJar enables people to be financially intentional in a digital world, democratising an investment mindset with tangible rewards. This maximises the value and visibility of money and contributes to personal well-being and confidence. Facilitating more financial intent and more ‘happy money’ is a project of great economic and social value. This is implemented by allowing users to define multiple intent based rules for different tranches of money in their own Personal User Data Lake (PUDL). HyperJar takes a user's PUDL (and any associated publisher or controller UDLs) and digitally executes these instructions on their behalf.

We have built our product specifically to deliver against the five pillars of Financial Intent (as set out above):

### What

### Separation

Allow multiple separate fully managed financial objects within one ecosystem
Unlimited, fully dynamic sub-accounts (visualised as Jars) linked to one card. Spend directly from any Jar by manually linking or by auto-linking any set of merchants to any Jar (example: please make all my spend at Waitrose and Tesco come out of my Grocery Jar)
Direct inbound payments into specific Jars
This is unique payment technology: a digitised equivalent of ‘cash envelope stuffing’ or jam-jar budgeting to control impulse- and over-spending

### Where

### Rewards

Multiple objects can be published in the ecosystem
This includes our merchant vouchers and rewards engine 2.0.
This allows seamless provision of merchant incentives to consumers entirely inside of HyperJar with no requirement to carry paper vouchers or present QR codes

### Whom

### Sharing

The ability to share any Jar with multiple other users (friends; family; kids; house-mates)
Spin-up and spin-down shared sub-accounts for any occasion, recurring (household bills) or a one-off (a holiday)
Set permissions, limits and controls as a group,
Share the parts of your financial life with others that you want to, without the clumsy and commitment-heavy structure of joint accounts
Send messages inside of any Jar-like a WhatsApp® group for payments
We are in the process of implementing full shared analytics and automatic in-app reconciliation for shared Jars.

This is all completely unique payment technology

### How

### Control

Restrict Jar use to specific merchants (Only and Never lists)
Limit amounts, payment methods and transaction visibility
Define where funds come from if a given Jar is exhausted (or decline payments for self control)
This level of control and protection over spending (self and devolved) is unique to HyperJar, and cannot be managed with cash

### When

### Full ITTT Automation

Full time based automation of transactions between Jars and other financial objects (inter-as well intra-account)
Sweeps, round-ups and round downs
“When I can” payments to allow for multiple
micro-payments to exhaust financial liabilities (such as utility bills). This forms part of our novel “Indirect Debit” product suite
full event driven transaction generation (along side alarms)

### Appendix 4: Infrastructure Overview

### Core Structure

### Core Processing

The core processing engine has been built around a micro-services architecture using a “Command Query Responsibility Segregation” (“CQRS”) design model.

### Key Service Presentation Made Via APIs Using the Following Stack:

### Core/Server.

Java, Spring (Boot, Cloud), Docker, Redis, Elastic Search, AWS
   iOS
Swift

### Android

Kotlin

CQRS separates the functions of data manipulation commands and data reads, allowing independent processes to be scaled and for each service to maintain, or simply cache different views of the same data. CQRS services can also maintain independent indexes which allows tuning optimization to significantly improve response times and processing efficiency.

### The Main Services are:

### Command Side

Consumers: handles KYC, e-money account setup, Card management, consumer settings, etc
Merchants: handles merchant specific settings and Award creation/management
Jars: handles user membership, financial actions for a single jar (auth, capture, deposit)
Transaction Processing: handles the higher order transaction work-flow and processing (money movement between jars and real world)
Award Engine: handles executing events and award sequences based on actions occurring within the system

### Query Side

Transaction Log/Ledger: full ledger of financial events
Profiles: consumer, merchant profiles
Financial Objects: Jars/bank accounts/other attributes
Award/Offer Store: listing of awards and offers plus visibility control over what a single consumer can see

### 3rd Party Integration Services

Transaction authorisation channel
Card Management Provider
Banking Services Provider
KYC Provider

### Third Party Providers—Examples are Now Described.

A card-scheme approved issuer/processor is a payment card transaction authorisation channel, or recipient of transactions related to the HyperJar card. The key requirement is the ability to outsource third party transaction authorisation in real time so that the HyperLayer PosTech can be used in the authorisation process. This is because most card approvals are straightforward so can be managed entirely by the processor so the situation never arises. HyperJar is different—live processing of complex rules lies at the heart of many of our core features.

### The Transaction Authorisation Channel Performs Five Primary Functions for HyperJar:

Card issuance: when a consumer on-boards, HyperJar sends an account and card creation request to the transaction authorisation channel. An account is created and the consumer record is assigned to a card personalisation file. Each day, the card personalisation file is sent to the card manufacturer for production and sending out via mail.
PCI Compliance: To avoid HyperJar needing to become PCIDSS compliant, the transaction authorisation channel “pseudonymise” the card details that are passed to HyperJar for transaction processing
Fraud/Velocity checks: as part of transaction processing, prior to sending the authorisation messages to HyperJar, the transaction authorisation channel performs fraud and velocity checks and actions based on the outcome.
Card validation: During authorisation processing, the transaction authorisation channel checks the card settings; PIN and CVV details before passing the authorisation message to HyperJar, rejecting any that fail these checks
Settlement file receipt: the transaction authorisation channel receives the settlement files from the payment network processor (such as Mastercard) and reformats these for delivery to HyperJar.
   These Services are Performed within Four Key Processing Flows:
Onboarding: During the on-boarding flow, the consumer is asked to add their personal details and select a PIN for their card. HyperJar call the transaction authorisation channel API and pass these details across. The transaction authorisation channel responds with a pseudonym for the account and a confirmation that the card creation request was successful.
Card management: Within the HyperJar the consumer can request to see their PIN; freeze their card; and enable/disable foreign transactions. These requests are sent to the transaction authorisation channel via the card management API. In addition, the CAP system also uses the card management API service to change the status of a card account and to block or request replacement cards
Authorisation: When the cardholder uses their card in a merchant location the transaction needs to be authorised by HyperJar as HyperJar acts as the account of record in relation to payment amounts. The authorisation request is routed across the card-rails via the various participants (merchant; merchant acquirer; payment network processor) to the transaction authorisation channel. The transaction authorisation channel performs their fraud and card checks and if passed, routes the transaction to HyperJar for approval.
HyperJar checks the transaction to determine the merchant and any associated consumer preferences for processing:
   Does the consumer have any settings for the merchant or merchant category?
   Do the settings allow for the transaction to be approved?
The value of rewards or awards that are valid for the transaction.
Once these checks have been performed, HyperJar responds to the transaction authorisation channel and this feeds back across the card-rails to the merchant.
Settlement: the transaction authorisation channel makes the settlement files available on a working day basis within an SFTP folder. HyperJar downloads the files and stream process these against the consumer accounts, updating and adjusting transactions where necessary. The value of a settlement transaction can differ from the original authorisation transaction, so during settlement file processing, the original authorisation transaction is identified and marked as settled.

### Know Your Client (KYC)

HyperJar uses eKYC, Video KYC and document verification services that are integrated into the core system. During the consumer on-boarding process name, address and date of birth details are submitted via API to the KYC provider for verification on a 2+2 basis where they seek to corroborate the person at the specified address with two providers. A pass response is typically received in under 30 seconds. In the event that one of more checks fail, either a review of fail response is returned. In this instance the consumer is asked to upload either a proof of ID and/or proof of address.

Proof of ID can be automatically processed, but proof of address may be reviewed manually. Where the consumer can not be automatically on-boarded, the App shows their on-boarding status and what the next steps are. eKYC is the fastest way to on-board consumers. If it fails, we can fall over to video KYC and if that fails the current process can take 24 hours to receive back a response to documents being uploaded. The video-selfie/ID check process in App is also the primary method for young people and for those that have not lived at their current address for very long (e.g. under 18; recently moved to a new address; or want a virtual card).

### Agency Banking Services

HyperJar uses agency banking services and give access to the Faster Payments Service (“FPS”), BACS, and the direct debit service. After the consumer has passed KYC and their card account has been set-up, an API call is sent to the agency banking services provider to create a sort code and new account number. Once set-up, the consumer can deposit funds into their HyperJar account using FPS, with the funds arriving in seconds. Consumers can also load funds into their HyperJar account from most major UK banks using the in-app PISP service

### Security & Resilience

HyperJar utilise a variety of approaches to ensure the systems are highly available, secured against malicious attack, and risk of data loss. The main approaches used at an infrastructure level are:

HyperJar Services are Deployed within a Virtual Private Cloud (“VPC”):
All inbound ports are blocked except HTTPS and VPN
All outbound ports are blocked except for those required to communicate to external services.
   Employees Obtain Access into the VPC Through a VPN
   Each Service has a Security Group which Controls Network Access:
Security groups control the network traffic internally within the VPC
Security groups restrict Inbound and outbound port ranges and can be limited further to IP ranges, or resources within another security group.

### Each Service is Bound by a Service Specific AWS IAM Role:

Provides access to other AWS services
Controls which operations are allowed for each service
Along with specific security groups, limiting each service's server to simply what they are allowed to limit the attack service of a hacker should they get into the VPC. Once they get into the VPC they are then exposed to a second layer of services which each have their own protections and if they can compromise one, they only obtain access to that one, not all others.
   Each Service has its Own Datastore and the Datastore Only Allows that Service to Communicate With it:
Datastore can be SQL, document, KVP. Implementation is not important but if there are additional security measures added by the datastore, we also leverage those. E.g. SQL databases require username/password. We use username & password on top of restricting server access through security groups and roles.
Datastore separation allows for only specific servers to communicate with a datastore to ensure no other service (inside the VPC) can alter any data.
Datastore access is controlled through security groups and IAM Roles if supported to limit server access
   Each Datastore Encrypts its at-Rest Data:
Keys for at-rest data are contained with AWS KMS (key management system).
There is a unique key per datastore
Access to each key is controlled through AWS IAM (Identity and access management)

### Each Datastore has its Own Backups:

Backup policies differ per implementation type
Backups occur as often as feasible (full backup daily, incremental snapshots no less than once an hour). AWS RDS provides roughly a 5 minutes window for restore points through snapshots
Backups are be kept in multiple AWS regions in case of catastrophic issues in a single region

### Each Service Leverages a Central Controlled Configuration Store to Maintain Configuration and Secrets:

### Sensitive Data not Stored on Server Hard Drives.

Any secret is encrypted within the parameter store and the encryption key is stored within AWS KMS.
AWS EC2 Parameter Store is used for this functionality.

Each service cluster runs the latest Amazon AMI to ensure the latest security patches are in use: Services are also deployed within Docker, adding another layer of separation from the servers and hard drives themselves.

### Deployed Modules are Monitored for Correct Functioning (Custom Monitors and Dynamic Analysis Tools):

All deployments run within auto-scaling groups which can detect service failure and automatically restart it.
All code runs within containers which also restart if they go down.
Custom monitors check for availability and send alerts if there are problems Cloudwatch is used to monitor down conditions or “outofresources” conditions to take automatic action through the auto-scaling group
Datadog gathers detailed live info from services and generates alerts in Slack if there are problems

The methodologies and approaches above are supported by cross-functional business practices to ensure security is built from the ground up within the organisation.

### Connection

All data flows require a connection (i.e. TCP not UDP).
Both ends of all connections involving HyperJar must have a PKI digital certificate provided by a ‘reputable and secure’ certificate authority
HyperJar will always check the authenticity of the remote digital certificate
Third parties that connect to HyperJar must check HyperJar's digital certificate (to make sure it is valid and is indeed HyperJar).
Third parties that HyperJar connects to should request and check HyperJar's certificate and check it. This is less usual, but possible under TLS 1.2
Utilise Certificate and Public Key Pinning to prevent MI™ attacks.

### Appendix 5: Hyper Jar Direct Pay

The purpose of this Appendix 5 is to provide an overview of HyperJar Direct Pay and how it works. The standard payment initiation device for a merchant redemption with HyperJar is an open-loop, card-based method, either in physical form or in virtual form as an Apple Pay/Google Pay token. This approach maximises acceptance and minimises the technical requirements for the merchant as it uses the existing card acceptance infrastructure. However, a downside of this approach for the merchant is the frictional costs imposed by the card scheme infrastructure through the merchant service fee, charged by the merchant acquirer. This fee covers both the acquirer servicing costs and the interchange fees passed to the card issuer and vary according to the transaction volumes processed by the merchant. Typically for a UK based merchant the merchant service fee is in the range of 0.4-1.0% of the transaction value

### Low Cost Alternatives

Mobile wallet-based services, such as HyperJar, offer alternatives to open-loop, card-based redemptions and therefore remove the service fee element for the merchant, reducing payment processing costs by using a lower cost alternative.

### Direct Pay

The HyperJar Direct Pay service utilises the mobile app on the consumer's device as the payment initiation/confirmation device. At checkout, there is an option to pay with HyperJar which triggers the payment flow. Different flows apply depending on whether the transaction is face-to-face or online.

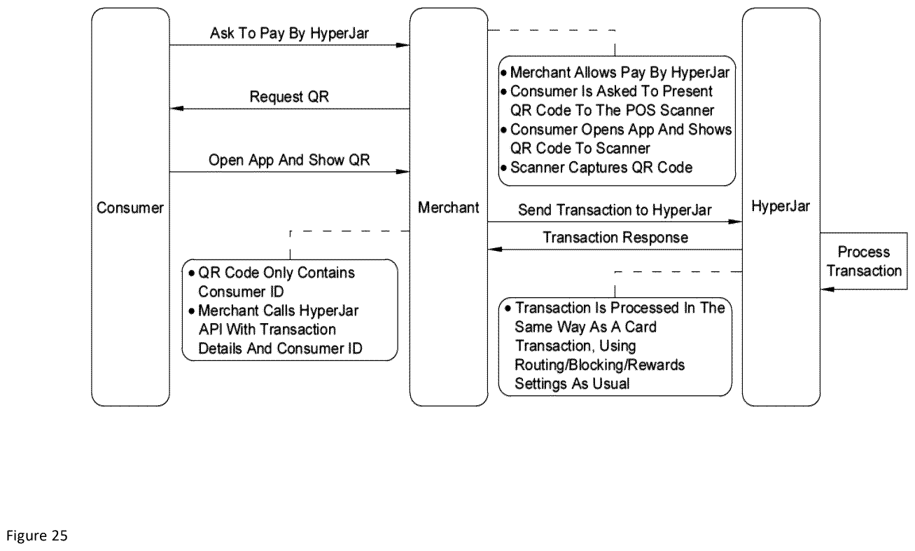

FIG. 25 shows a diagram illustrating when the transaction is Face to face.

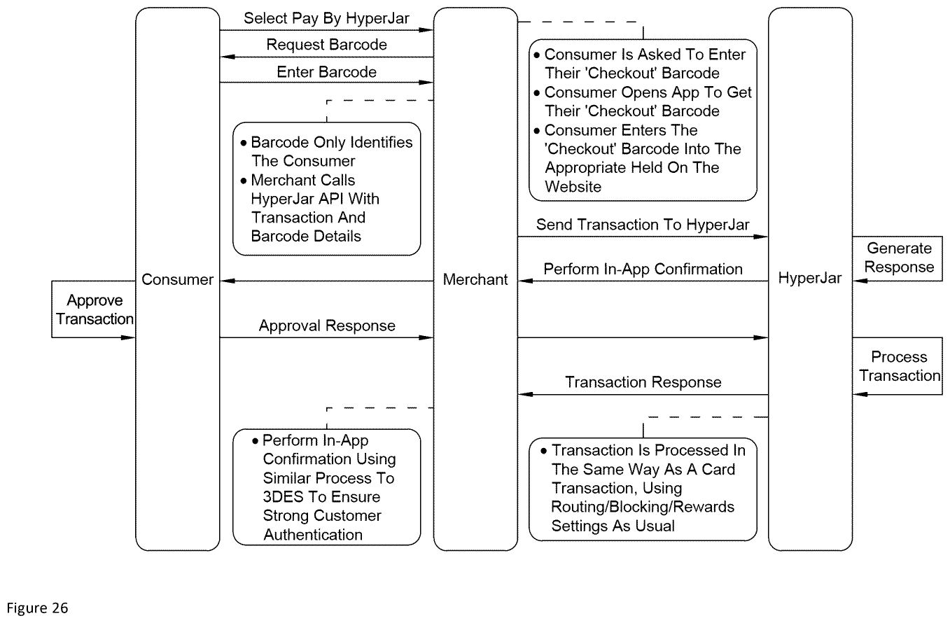

FIG. 26 shows a diagram illustrating when the transaction is made online.

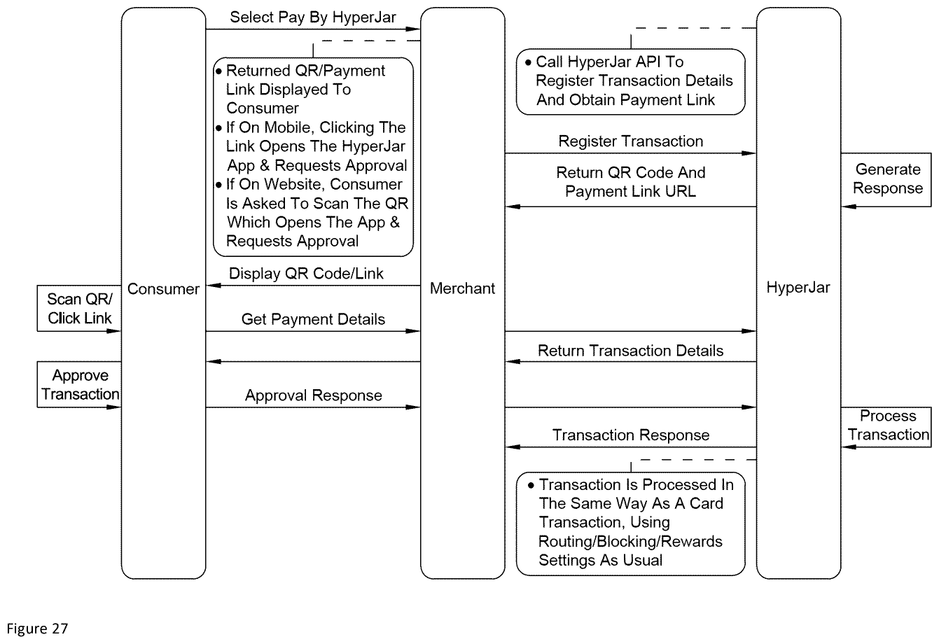

FIG. 27 shows a diagram illustrating when the transaction is used online or in-store where no QR code/barcode scanner is available (Mix-Mode).

### Merchant Requirements

In all cases, the merchant needs to modify the checkout process to call the HyperJar API to initiate the transaction flow and, in many cases, this will require the involvement of third-party providers of POS/Checkout services where these are used as part of payment processing. Transaction reversals/refunds are initiated by the merchant using the consumer ID from the QR/Barcode, original transaction identifier and amount. Funds are instantly credited to the consumer account when processed. QR codes/URLs returned are one-time use to improve security, similar to open banking. Merchants using the on-line method will be able to store payment details for a customer if the customer approves this. Approval will be a secondary flow either following a transaction (i.e. following approval, a merchant asks if you want to save your payment details) or as a standalone flow (i.e. when adding a payment method to an account). In both cases an enduring token will be generated tied to that merchant. Where enduring tokens are created, these will be visible to the consumer in their HyperJar app and they will be able to cancel them in the app. When an enduring token is cancelled, HyperJar will notify the merchant via an API call.

### Settlement Account

Transaction amounts for approved transactions are credited to a specific settlement account for each merchant as they occur. This allows for future ownership change where the merchant takes direct control of the account when volumes are sufficiently high. Values can be either gross (including rewards) or net of rewards, the latter being used where there is full API integration, including SKU level rewards. Where HyperJar controls the Settlement account, a single payment will be made to a nominated merchant account periodically, on a schedule agreed with the merchant. Transfers will be accompanied by a detailed transaction list to enable reconciliation.

### Appendix 6: Reward Taxonomy

### Introduction

The HyperJar rewards engine 2.0 has been designed from the ground up after extensive feedback from our merchant partners. Its function is to give them state-of-the-art targeting, execution, attribution and campaign optimization. Merchants can incentivize defined customers cohorts in multiple ways, to produce desired behavioural outcomes.

It Allows Rewards to be Designed which:
Are targeted at any merchant defined cohort of users; at specific times; and meeting overall campaign parameters
Can be acquired by users either:
By picking them up in the explore section of the app
By automatically being given them by a merchant (suitably permissioned)
By some predefined action, such as buying a reward, or spending money with the merchant
Can have an arbitrary list of logical conditions under which the reward is deemed as valid at point-of-sale
Can have various forms of payouts which can be static or calculated at POS.

### Examples

A fixed amount (example: £10)
A percentage amount of spend (example: 10% of spend)
A dynamic increasing amount (an amount based on how long the reward has been held-our flagship Expander (a.k.a. AGR) reward
A dynamic decreasing amount (see the Dutch reward)
A variable or random amount (see the Gambler and the Fire Cracker)

Are treated in the system as first class financial objects so (if required and allowed) can be transferred and shared

### The Taxonomy

The List Set Out in this Note is a Basic Top-Level Taxonomy of Rewards:
Many of these rewards are derived from
pre-existing successful reward types out-in-the-wild. That is: some variation of them has already been done, either in the retail sector or the gaming sector-they just haven't been implemented beautifully and seamlessly inside a digital wallet
The list below is not remotely exhaustive, and clearly many of the reward types can be combined in various ways (some great, some not so great).
Part of the beauty of the HyperJar ecosystem is that various classes of rewards can be discreetly A/B tested in a straight forward and private manner. One of the challenges which our merchant partners have is the difficulty (or impossibility) of personalisation of reward strategies to different cohorts of their audience because:
It's technically impossible
It's socially impossible to show different visible offers to different people or in different origination channels
This note makes no judgement on the social appropriateness of certain types of rewards which are designed to encourage spending. Where the line should be drawn in terms of encouraging consumers to spend too much is not ours to police. We would observe that, under our current model, HyperJar operates as a debit card, not a credit card. So that any funds on the card have to already exist.
Why the names? Simply looking at sets of activation rules can be complex and dry, we are taking a leaf out of the gaming industry models by naming reward classes in a memorable way.
   Lockups (a.k.a. Money-On)
Collection: Vouchers can simply be purchased by Users (and remain cash collateralised), but in terms of Rewards and behaviour, a close bed fellow of Vouchers are rewards that have a simple cash payout which can only be used at a given merchant (or group of merchants).
Payout: Simply the face amount. The balance can either be set to be paid only once (up to the value of the goods spent) or can be set to be consumed over time (so the balance can be paid down with multiple visits to a merchant)
Behaviour: Lockups can form the basis of many different more complex rewards, however we would make three points:
Although Lockups (Money-On) can be seen as functionally almost identical to Money-Off it is perceived as, and feels different by consumers. In HyperJar, we present Lockups as an asset with a balance (which for example: is added together with and purchased Vouchers) rather than a future deduction from a purchase—it feels more like money.
Although paper, and latterly QR code vouchers have existed for a long time, wallet based rewards at POS have evolved to be almost entirely cashback. This is due to technical limitations around implementation. Being able to limit future rewards to consumption with the issuing merchant is clearly far superior because it extends the loyalty loop by dramatically increasing the probability that a consumer returns to the merchant (to use Lockps). Cashback doesn't have this characteristic at all. lockups have the benefit of a far cleaner more interesting user journey.
Clearly as a proxy for cashback, Lockups can be issued on spend for consumption at the next shop, generating a time gap between earn and burn. This is interesting to encourage repeat visits, however often cashback is simply a proxy for discounting. Allowing Lockups to be consumed directly at the POS is essentially direct discounting and simultaneous earn and burn. This is a cleaner and much more VAT efficient form of discounting than cashback.

### Expander (a.k.a AGR).

Collection: attached to the purchase of any merchant specific Voucher by a User. This can either for someone else (a Gift) or for the User to spend on themselves
Payout: The value of the award grows over time based on the balance of merchant specific Vouchers owned by the User. This Annual Growth Rate (or AGR) essentially mirrors interest.
Behaviour: The Expander is a complex example of a class of Voucher purchase-based rewards. The purpose of having a time-based accruing pay-out is:
To engender comparison with conventional savings account. The AGR is directly comparable (and higher than) the interest rate provided on a bank-account. This makes the reward far more experiential and a much clearer exchange of value. The user is exchanging loyalty for a fantastic savings product
To encourage and early adoption at the point-of-intent, far earlier in the marketing cycle than POS based rewards
The combination of the factors above generates a new and highly attractive form of loyalty-generating early and continuous engagement with the loyalty loop. We have determined that Expanders are particularly suitable for two forms of merchants: (i) utility like merchants (examples: groceries and petrol stations) who want to increase share-of-wallet (shop where you save); and (ii) merchants where there is channel choice for large future purchases (examples: holidays and new phones) where offering a customer a material early benefit can lock-in future spend
Targets a particularly interesting demographic by encouraging savings and planning (Save Now Buy Later)

### Jigsaw

Collection: Activates the define payout when a User collects a series of sub rewards (such as pieces of a jigsaw).
Payout: any (see below)
Behaviour:
High engagement, designed to be fun
Requires multiple visits for collection-so suits merchants who are amenable to multiple visits
Can have different payouts for different combinations of sub-rewards bringing the excitement of a large pay-out (see the Gambler below)
If transferability is enabled, can generate strong social effects (collecting together, doing swaps). Some of the negative effects of this (people selling pieces on e-bay) can be mitigated eliminated because incremental rules can be structured by the merchants

### Stamp

Collection: Money-on that activates after a set number of visits. This is already popular in many coffee chains which tend to execute this by having an piece of card which gets “stamped” every time a customer buys a product and can then be redeemed. Obviously with HyperJar there are no requirements for cards; training staff in-store; or annoying delays at the till whilst people scramble around in their (physical) wallets
Payout: any (see below) but Money-On very attractive
Behaviour: Encourages repeat visits (by effectively spreading discounts out over time). The fact that the pay-out gets closer may have both positive (visit more likely as it gets more real) and negative ramifications (since it resets)

### Gambler

Collection: The gambler can be any reward with a randomised payout function. For a simple example simply assume it can be picked up. These are more appealing to many people than level payouts (examples: premium bonds; scratch-cards; lotteries; rewards to “get our whole shopping basket for free)
Payout: Can be statistically generated or predefined (payouts have been allocated but are discovered at POS-similar to a scratch-card model). Allows for a merchant to offer a small number of big prizes
Behaviour:
Many consumers often prefer the chance of a larger payout rather than the certainty of a smaller discount
This is especially true for smaller ticket items where flat payouts of small absolute amounts can be very underwhelming
An interesting example of this form of behaviour surfacing in the retail sector (and combining random payouts with savings) is the Walmart Prize Savings program

### Santa

Collection: Granted to a parent (or grandparent) but restricted to payout only for children. No direct collection by children, it has to be transferred from their parents (or adult contacts). This is an elegant way to do consented targeted marketing to minors within the HyperJar framework
Payout: any (see below)
Behaviour: any (can be any form of reward), however the social/family aspects of this reward may:
engender a feeling that it is more special
encourage family members to top-up

### Saint.

Collection: Granted to a User but restricted to only
payout either:
For other people
Up to a limited amount, where then the balance can be given away AND the limited amount condition applies to others
Payout: any—but only pays out when given away (in whole or in part)
Behaviour:
Creating social referrals
Encouraging gifting
For Saint rewards which can be repeatedly regifted the opportunity to generate substantial social viral effects. The reward could be very substantial amount to a student (for example), call it £50k, where the personal spending limit was £100. Then the only option for the student is to break the chain or push the residual reward into their network (fantastic for HyperJar acquisition as well).

### Timelord

Collection: any
Payout: any, but only at specific times defined by the merchant
Behaviour: can drive any desirable time-based behaviours:
Only works during quiet-times for merchant (examples: restaurants; gyms)
Can attempt to capture and encourage spend at certain times of year (example: Christmas)
Can add personalisation (example: Birthdays)

### Flash-Mob

Collection: Given to multiple users. Can be shown to specific groups or to everyone
Payout: Highly social reward (very popular in the gaming industry) where the payout variously:
Only happens if enough people claim the reward
Increases in value as more and more people claim the reward
Increases in value the more and more people
achieve an activity level (such as buy a coffee)
Behaviour: Viral. People love being part of an event. Fantastic for social media style campaigns

### Party

Collection: Only for shared Jars under certain conditions
Payout: Any—but payment must come from the shared Jar (preferably one that has been mutually funded)
Behaviour:
Drive channel choice for groups (example: a reward for groups to buy lunch at Deliveroo)
Drive volumes or numbers of users (examples: a reward that only works if four or more friends participate, or when overall spend hits a threshold)
form of reward can be extended out to many different group behavioural types. Examples: aggregate amount saved up, aggregate amount of vouchers purchased (there is an obvious charity dimension to this)

### Mindreader

Collection: targeted at specific cohorts of interest to a merchant based on available segmentation data.
Payout: any form of payout conditional on:
Filling in a merchant survey
Watching merchant content
Linking in a loyalty or merchant account
Giving marketing consent
Behaviour: For merchants to gather new data, or like HyperJar data to their own data-lakes. HyperJar can be a fantastic channel for data gathering if done appropriately and carefully. We have seen some great examples of consumer networks being incentivized to provide data collectively in this way.

### Unicorn

Collection: very rarely available in the merchant discovery section of the app. Or only available when a rare event presents itself (for example a fish swimming in a jar)
Payout: any, but usually substantial
Behaviour: Engagement:
Drives users to engage with merchant pages or the merchant discovery section of HyperJar to see if the Unicorn is there
Finite numbers of Unicorns which get counted down. Like a sale with only a few nice TVs
Certain times where a Unicorn may appear. Like periodic or black Friday discounts on Amazon. Or waiting to availability of new Playstation 5 stocks at the Sony store

### Dutch

Collection: any
Payout: a payout which declines over time and/or expires when a certain number of other Users have spent the reward
Behaviour: Much like the famous Dutch Auction this is a study in FOMO. Get customers to come and use the reward quickly before it goes away—but make the decline and/or expiry unknown

### Firecracker

Collection: any
Payout: unlike the Gambler where the payout is uncertain—the Firecracker has a known payout but it changes at a predefined frequency. It is essentially a single reward which changes state.
Behaviour: Consumers watch the payout function and feel good if they spend during a “high” window

### Appendix 7: Merchant Intent

### Background

### Why Rewards and Loyalty Schemes Exist

Broadly Speaking, Merchant Incentives Offered to Customers have Three Goals:
Acquisition: A discount, experiential reward or other offer designed to bring in a new or lapsed customer.
Retention and growth: Rewards designed to increase the value of the customer, by one of the following means: increasing average basket size; up-selling to higher margin products; increasing frequency of transaction; keeping the customer loyal over time. Known as RFM: Recency, Frequency, and Monetary value.
Data: Identified sequential customer transaction data sets fulfil multiple middle and back-office functions such as optimised stock management or enabling commercial partners to profile audiences and target more efficiently.

### The State-of-Play Today

A great experience and a well-designed incentive schemes can make consumers loyalists, or even advocates, for brands, however in 2023, the challenge for CMOs in driving consideration, conversion and loyalty is arguably harder than ever:
Poor User Journeys: Current merchant reward/loyalty offerings are often complex and dated: plastic (or paper) based gift cards with business models based around breakage; multiple separate low engagement loyalty schemes and physical cards filling up purses and wallets; annoying QR-code based user experiences at the till; cash-back which requires sign-ups or appears in accounts months later; plug-ins and web extensions. Customers have to navigate multiple retailer loyalty apps each with their own log-in.
The average consumer belongs to 17 “loyalty” programs. Approximately 70% of established loyalty programs fail to deliver value and there is significant consumer fatigue with both points and discount-focused mechanisms.
Commoditisation: Rewards programmes have become commoditised, awarding (rather than rewarding) customers points based discounts in exchange for permission to collect and utilise data.
Rather than rewarding “loyalty”, they are focused upon rewarding card ownership. Consequently they are failing to deliver sustained behavioural change, becoming data-plays that drive margin management and positioning utility rather than engagement and relationships.
Saturation: Points-based programmes and discounts have reached saturation, so are often no longer a source of differentiation (example: over 70% of UK loyalty programme members are also enrolled in competing programmes)
Opacity: PwC, working with 15 UK businesses with a total annual UK digital ad spend in excess of £100 m, found that 49% of this money went to intermediaries, and one third of that 49% (or £15 m) was completely untraceable.
Complexity: There has been an explosion of single-retailer loyalty schemes (Tesco Club Card leads the way). This creates a proliferation of key personal information—from contact details to payment cards-across databases at multiple retailers, all of whom are being trusted not to lose or abuse it.
Attribution: Increasingly difficult for digital commerce with the increasing understanding and enforcement of GDPR; Apple blocking third party cookies; and consumer education.
Consumers: increasingly informed; better connected; always on. Consumers are looking for convenience; simplicity; personalisation and experiences rather than simply across the board discounting.
Cost: Race to the bottom price discounting. Increased CAC (up 60% in 5 years) due to 3rd party cookie and Apple tracking changes.

Point-of-Sale (POS) cash-back is particularly illustrative of the issues. Targeting is very crude: cash-back businesses simply publish offers to as large an audience as possible in the hope of maximising transaction volumes to increase payments. Value can be given away very easily—and there is limited evidence that it creates genuine loyalty or behavioural change. Cash-back attracts a deal-hunter cohort that goes where the cash-back is: it can generate short-term revenue for a merchant, at a cost, but limited long-term loyalty and growth.

### HyperJar

Optimised merchant rewards are not a ‘one size fits all’ model. The value, cost and mechanics of incentives vary hugely by retailer category, customer behaviour and demographics. There is a huge opportunity in helping merchants deploy marketing funds more specifically—in helping them be more intentional with their valuable marketing spend.

In relation to rewards and gift cards (vouchers), we see merchant intent as a close cousin of consumer intent, namely, when merchants give incentives to consumers they want fine resolution on:
Who: gets incentives and who doesn't.
When: are incentives delivered (example: not just at the POS)
How: incentives are delivered and in what sort of channel (example: paper vs. digital)
Why: was the campaign done, and more importantly did it work?

HyperJar provides a channel where merchants can build their own intent data sets (a Merchant User Data Lake or MUDL) to achieve very detailed answers to these questions.

The logical place for a retailer/consumer reward interface is the digital wallet. We believe that this is minimum “table stakes” for any successful proposition today, and can be extended in numerous ways to build consumer-merchant service propositions (the e-wallet, as a highly efficient form of media investment is already a well-established concept in some geographies such as Asia)

Since Wallets are Payments Channels, as Marketing Channels, they can Deliver:
Frequency of engagement.
High mental and physical availability.
Contextual relevance.
Fantastic targeting and 100% attribution.
Omnichannel ‘synapse’: marketers no longer have to think about online and in-person payments as separate.
Accelerated journeys though consideration, conversion and loyalty.
Seamless, relevant value exchange.

HyperJar provides all of this, and more. Thanks to our payments and retail technology, we deliver uniquely powerful functionality in three areas; Targeting; Execution and Attribution (TEA). These four elements of our Rewards Engine allow for almost limitless typology.

### Targeting

We enable targeting based around a combination of demographic data, historical spend (at merchant; competitors; or within category) and are wired up for integration with other data sources as and when we receive them (e.g. geo-fencing/permissioned integration with pre-existing loyalty programmes/SKU level information). Most importantly we provide unique insights through in-app behaviours:
Social: because our wallet allows users to save and spend together it provides for rich, 1st party social, household & network data. Ability to target groups or have customers share offers within their network.
Intent: the allocation of money to either user-defined Jars (‘Grocery’, ‘Clothes’, ‘Holiday’); the purchase of our 2.0 gift cards: HyperVouchers; or via engagement with specific merchants through only, auto-linking and favourating features creates unique intent data. Customers can be reached and incentivised further up the marketing funnel, where it is cheaper and less crowded than at POS. Purchase intent is increasingly hard to spot in the ‘digital wild’ due to regulatory changes on tracking. In HyperJar it is the purpose of the product.

### Execution

### Activation

Users can collect rewards either in our discover page or be automatically awarded: however collect is a key engagement signal and an emerging market standard). Similarly vouchers can be purchased; held or gifted; and merchants can add rewards for incremental incentivisation.
We can implement almost any rules-based reward from unconditional to triggers associated with any event up to, and including POS and we can attach rewards from multiple retailers in the consumer HyperJar wallet creating a hub effect and cross-merchant cost savings. This allows merchants to reward very specific desirable consumer behaviour. (examples: time-shifting consumers to non-peak hours; encouraging group spending patterns; rewarding repeated visits; filling in a survey)
These rewards can be surfaced and acquired at any point in the spending journey-so far earlier in the marketing/intent cycle than typical POS based rewards which simply encourage last minute channel selection. A great example of this is our (a.k.a Annual Growth Rate) reward to encourage savings and planning-Save Now Buy Later (SNBL).

### Payout

Merchants have full reward payout customisation:
   Fixed amounts.
   Amounts calculated as % of spend.
   Amounts calculated above a threshold spend (example: 20% off spend over £100 creating motivation for larger basket sizes)
   Dynamically calculated payouts: the basis for our Expander (a.k.a AGR) rewards—the value grows over time (creating motivation for early purchase of vouchers)
   Randomised amounts (example: 1 in 100 chance of all your shopping for free)
   Non-monetary rewards: merchant experience or voucher, in-app icon/badge, free gifts; points in pre-existing merchant scheme.
   Rewards & cash-back equivalents can effectively be denominated in merchant currency (rather than fungible cash-a big departure from current models—example: a 3% cash-back at Nike can only be spent at Nike-rather than normal cash-back which could be spent at Adidas). This dramatically increases incrementality and engagement and is very appealing to our merchant partners.
   Part payments: allowing rewards and vouchers to be consumed in whole or in part in bricks-and-mortar stores is a major innovation. Today, part payment of rewards and vouchers is cumbersome (if allowed at all)—often requiring a physical re-issue of a new-smaller gift-card or voucher by in-store staff.

### Journey

Completely integrated and seamless at POS-both for the consumer and for the merchant.
Using our unique Priority-Of-Payments (POP) technology: users can redeem rewards, vouchers and cash in a single payment, without having to input/use a code (and therefore separate payment) to reduce basket value first. A far superior user journey which can reduce the amount of time customers spend at the till (an important metric for many of our partners)
Rewards can be collected and redeemed in the same transaction-reducing the gap between “earn” and “burn” to zero if required.

### Simplicity

We require zero tech integration for the retailer. We can be up and running in days.
Multiple campaigns can be run simultaneously.

### Attribution

Primary payment channel means perfect attribution for both digital and bricks-and-mortar spend. 1st party GDPR native data.
If a user can link a pre-existing loyalty programme with HyperJar we can splice our data with merchant SKU level data to further enhance data resolution for our partners.
Provision of SKU level data (at or near POS) is possible.
Because we are a fully integrated rewards “loop” we can feed attribution data directly back into our targeting engine so that our models can “learn” and improve over time.

### Other

A continuous presence inside a high-touch, high-utility wallet, and intent-based targeting, mean the customer is much less likely to fall out of the ‘loyalty loop’ between transactions.
Positive brand environment because we are teaching customers about sound financial decision-making.
Our data is fully-permissioned and GDPR-native. Users have fine-grained control over use of data for personalisation (self-custody) and our merchant presence is in context of user budgeting/spending, with consumers selecting which merchants they want to engage with.

The full taxonomy of existing and upcoming reward types is contained in the Reward Taxonomy document. Some examples:
Expander: Rewards that grow over time incentivise regular spend or help customers save up for big ticket items. Looks and feels like interest on your shopping. (Examples: Allocate money to Shell for a 10% Annual Growth Rate; Allocate to ATG Tickets in August for a 10% boost rate)
Lockup: Rewards that can only be spent at your brand. These rewards look and feel like branded money and cash boosts feel different to discounts. No need for physical vouchers/codes/stamp cards. (Examples: Commit £30 to Laithwaites Wine, receive another £30; Shop 5 times at Domino's with your HyperJar card to unlock your £5 Cash Boost)
Santa: Rewards that are distributed via parents to kids. Elegant way to do consented marketing to minors.
Saint: Rewards that can only be given away to others in your network. Social referral and gifting.
Flash-mob: Highly social reward (very popular in the gaming industry) where the pay-out variously: Only happens if enough people claim the reward or increases in value as more and more people claim the reward or complete an activity (e.g. buy a coffee that day)

Further examples around the conditions that can be used, with no integration, to deliver customized, frictionless rewards delivered at POS via the HyperJar card:
Gift: Gift money to your HyperJar network for Reward incentives e.g. Gift £100 and that money will grow at 10% for the year.
Time-bound: Reward only claimable/redeemable at certain times e.g. 10% money off discount when you spend between 12-2 μm on a Tuesday.
Socialize: Rewards increase the more people who pick it up e.g., Share your jar with 5 friends for you all to receive 25% money off discount on your next spend.
Feedback: Earn Rewards for completing a task or providing feedback through surveys e.g., Tell us what you think and receive £15 money on to spend next time.

### Rewards Summary

The merchant rewards industry is a highly fragmented group of monoline providers. Existing rewards platforms deliver single-type rewards. Some platforms deliver cash-back, others deliver gift cards, others deliver points.

We are the only platform that can surface all existing rewards and any new reward type that a merchant wants to deliver. The integration with our digital voucher product is entirely unique and can only be delivered if the underlying account structure has many of our core features (account sharding; merchant level POS permissions; priority of payments (POP))

### Our AGR Reward is an Excellent Example of a New Class of Loyalty Reward:

Requires both voucher and reward technology (we are about to launch a very material upgrade to the offering) Requires dynamic calculation of value at POS.
Requires MID code level blocking and routing.
Requires full integration into the POP.
HyperJar collaborated with Shell to invent this highly valuable and unique reward.

### Voucher Summary

The UK's Gift Card Market is estimated to be £8 bn in 2022 and is expected to continue to grow at 5-10% annually through 20275

The current voucher and gift card market is inefficient and fragmented with distribution commissions offered for the resale of retailer B2C gift cards), in the 3-10% range, distributed between a number of players from gift card management platforms through various layers and channels between the retail issuer and end consumer. This is all value we can capture.

HyperVouchers are next-generation gift cards/vouchers that allow members to commit money to specific merchants within the HyperJar app.

### HyperVouchers Differ to Existing Gift Cards in a Number of Great Ways:

Credit exposure: none to the merchant, so users do not lose money if the retailer goes into liquidation. The money is held in escrow at HyperJar.
Low Breakage: surfaced in a contextually relevant high-touch channel so reduces breakage i.e., no forgetting or losing the card/email; needing to log on or ask in-store to check the balance.
Rewards: Can be delivered with associated rewards-far more elegant than current models which at best, simply offer discounts to face value. We have a far better model to deliver incrementality.
Journey: can be combined with cash, rewards and other vouchers and consumed in a single transaction which is beautiful for both the consumer and the merchant in terms of improving journeys at the till (one of the major reasons loyalty card schemes are losing users is people can't be bothered to tap twice)
Splitting: a voucher can be used multiple times, the balance is stored and visible in HyperJar. The current models for splitting vouchers and gift cards are almost all terrible (except for single proprietary merchant apps and accounts: who are all closed loop)
Environmental impact: 2 billion plastic gift and store cards are produced in the UK each year generating 2,500 tons of plastic from the 200 million thrown away after single use.
Transferability: at the option of the merchant. For example: this can prevent situations where trading markets develop (a big “thing” in the US)
Data: Proper integration with our unique data model. Current voucher/gift-card models range from limited to zero data.

Vouchers can be combined with intent based rewards create extremely elegant loyalty effects. Our Expander reward (grows dynamically over time based on the outstanding value of vouchers purchased from a given retailer) creates a pure Save Now Buy Later (SNBL) proposition:
Very early in the marketing cycle (at point-of-intent (POI) rather than POS)—market and encourage commitment when people are deciding where to allocate funds for future spend. Highly attractive to our partners.
Transparent exchange of value: shopping intent for rewards.
Continuous engagement: consumers feel “invested” in their brands. This is effective at holding customers on the Loyalty Loop, a (see Exhibit 1)
Highly effective for increasing share-of-wallet for “utility” like merchants (examples: Shell and Lidl pilots); or for early channel selection for goods or services people save up for (example: TUI). Data on these initiatives can be provided as requested.

### Exhibit 1: Redefining the Loyalty Loop

Give customers something they want: a fantastic savings product. Non transactional and has very little to do with price competition at the till

Our savings functions, high engagement app and hub model dramatically increases customer touch points and reduces the chance that users fall off the loyalty loop.

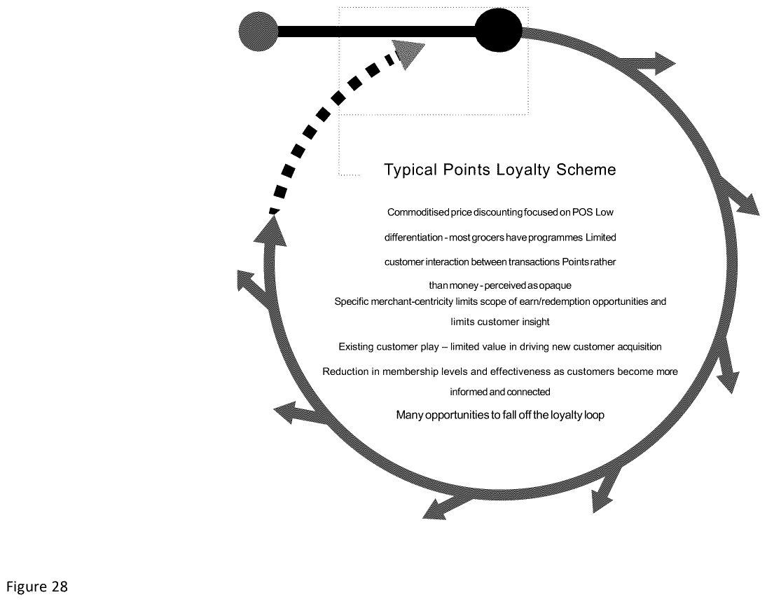

FIG. 28 shows a diagram illustrating a typical points loyalty scheme.

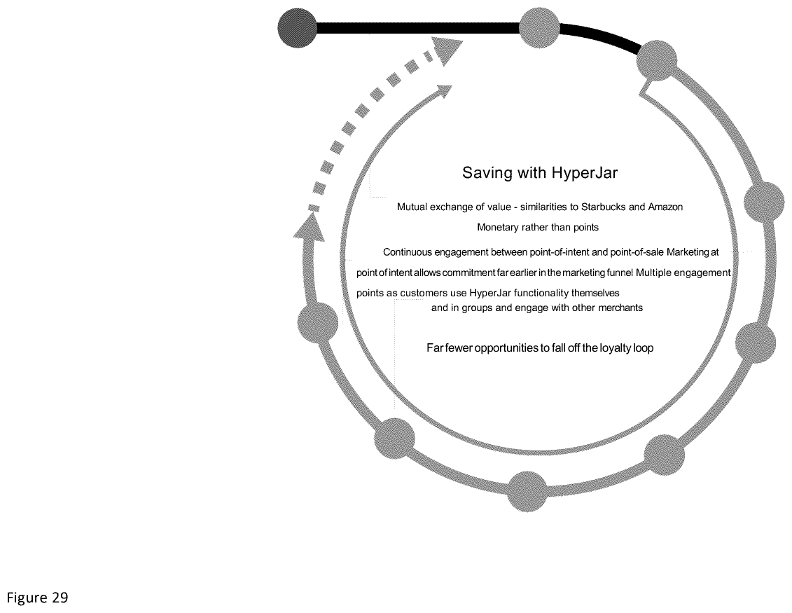

FIG. 29 shows a diagram illustrating saving with HyperJar.

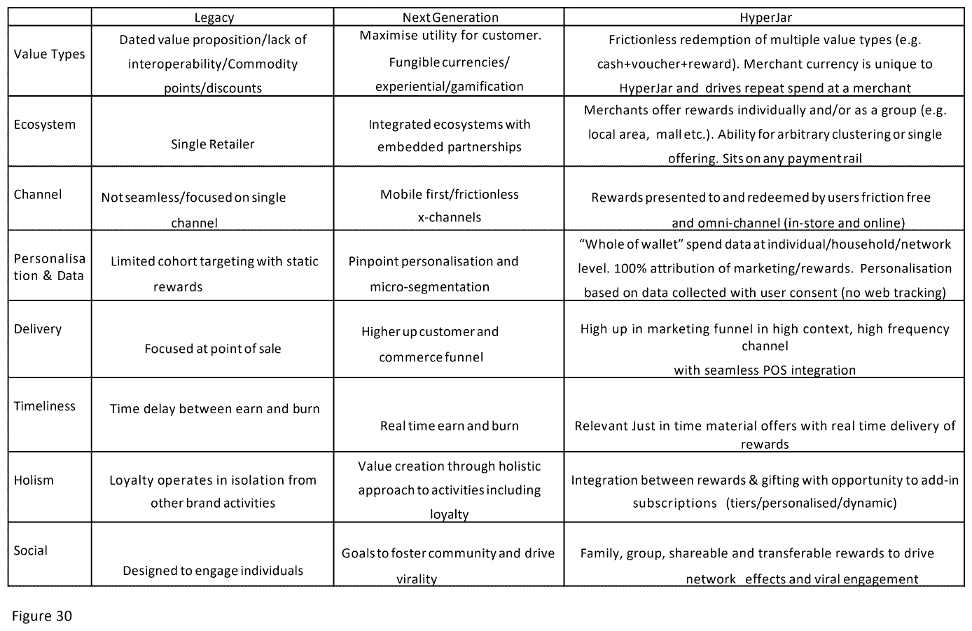

FIG. 30 shows a table illustrating the HyperJar rewards and loyalty features (1.0 vs 2.0 and where we fit in).

### Other Merchant Initiatives

Conversations with Our Partners Extend Beyond Provision of Rewards and Vouchers:
Reduction in merchant service fees by bypassing traditional payment rails: a highly significant (and ultimately unnecessary) tax on consumers and merchants.
Integration with pre-existing loyalty card programmes. This can extend RFM analysis with whole-of-wallet; social and intent data streams.
ESG/CSR. HyperJar purpose, demographics and mission, helping customers Spend Life Well are considered major branding opportunities for many of our merchant partners.
SKU level integration for even better customer engagement and data analysis. We are prepared for this as it gets rolled out—also gives us even finer resolution and control for TEA.
Using intent data can power financial solutions:
   Indirect Debits: an elegant and differentiated form of consumer finance.
   Direct working capital: especially attractive for SMEs and local firms.
   Elegant Supply chain finance solutions: to replace clunky historic payables platforms.

### Revenue Model

Merchants and manufacturers do not expect that they will always get paid Gross Merchandise Value (GMV). Some percentage of GMV is almost always assumed to be consumed by marketing; distribution costs; rewards and other behavioural incentives. Often GMV is set at a particular level to capture consumers who are not price sensitive; or lack the ability (or desire) to seek out the lowest prices in the market (indeed this is essentially a tax on certain consumer demographics—for example: the elderly).

Available discounts to GMV vary by merchant. For more commoditised every day products (examples: groceries and petrol) these discounts are low, reflecting genuine margins on the underlying products. For high margin products (example: fashion), theoretical discounts can run to double digit percentages.

Capturing a healthy portion of available discounts to GMV forms the basis of the revenue model for HyperJar Rewards and Vouchers. This is the same “revenue pot” that Affiliate schemes; re-sellers; BNPL propositions; cashback sites and gift card providers address.

We consider that (net) merchant fees fall into three broad buckets (all of which already exist in the market). These buckets are “porous” and there are various programmes which are designed to achieve more than one of the objectives. We classify these types as:
Loyalty: net fees achievable for loyalty style programmes for pre-existing customers. Our Expander/AGR reward falls into this category—these price @ around 1% net to the distributor. These programmes are bespoke for large merchants who tend to be more utility-like national grocery or petrol chains. We only assume a small number of clients in this vertical.
Affiliate: General price discounting/cash-back. These price at around 2% to the distributor (commissions vary by merchant—this is an average—but benchmarked to pre-existing businesses)
High Value: Gift Cards/CAC. For promotions, acquiring new customers, getting people to on-board family and friends through gifting etc. Price @ 5% and up.

Categories 2 and 3 are currently fairly commoditised. There are multiple companies offering B2B services to “plug-in” product

### Gift Card:

These B2B distributors charge anything from 1-2% of spend and give the rest of the merchant discount to GMV to the B2C distributor (for example: us). The split between what the B2C distributor and the consumer ultimately get is up to the B2C distributor.

As an example: the gross discounts to GMV which are available to us right now (via API) from Gift Card distributors allow us to make the following observations:
Most firms who recycle these fees into gift programmes take 50%+ of the discount (some take all of it). Given the commoditised nature of the market its mainly about giving great UX.
The merchants represent 67% of all current HyperJar spend. Contrast with an affiliate which covers 25% of our current spend.
The UX for these programmes is clunky (typically QR code) so no where near as nice as ours.
There is some breakage involved here (the merchant expects 1-2% of cards never to be used). We hope to minimise this with our fully digital channel (CMOs like this-better brand affinity: conversely CFOs like breakage, this can be addressed through a slight reduction in revenue which we can bake into pricing; conversely fewer lost customers)

### So for the Purposes of Our Model we Assume What we Consider to be Broadly Market Fees:

1% for loyalty (we already charge this to Shell for example)
2% for affiliate cash back equivalents.
4% of high value.

Based on expected amounts of incentivised flow—this averages to 2% (the starting number in the model). We would observe:
This assumes we use/work with B2B services, so we are sacrificing 1-2% of margin rather than going direct.
We have considerable traction going direct so we hope to eat up this B2B distribution fee over time in the UK (because our product is highly differentiated/better than current offerings—not the least because of vastly better targeting and attribution—but this takes time to get embedded)
Ultimately we hope to charge more because of the uniqueness of our product.

### Appendix 8: B2B Taxonomy Overview

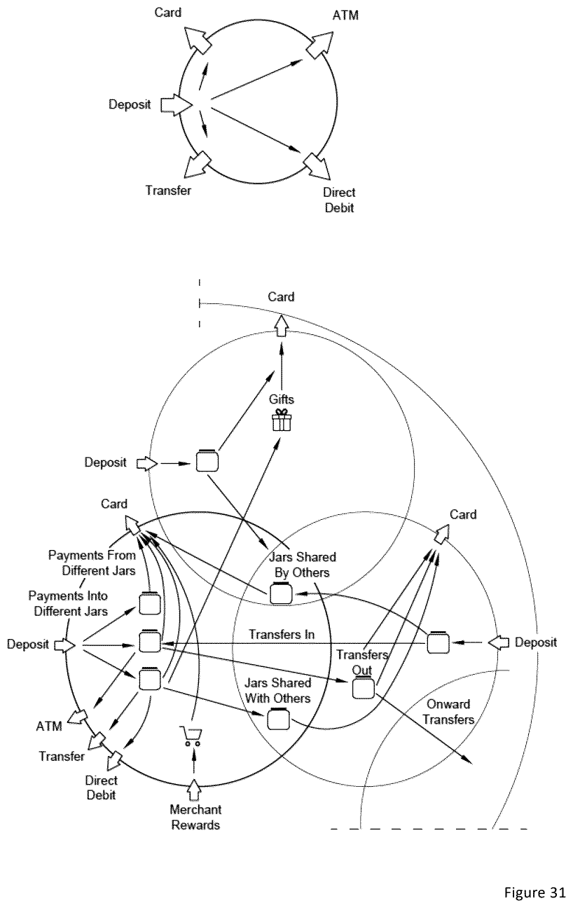

FIG. 31A provides a diagram illustrating a normal bank account and FIG. 31B provides a diagram illustrating a HyperJar system.

### HyperJar

HyperJar acts as a product and IP testing ground for HyperLayer, and a demonstration of our capabilities for prospective B2B clients.

### HyperLayer

Target Clients Fall into Three Distinct Categories:
Applications: Clients who provide digital wallets to consumers. They may already do this (for example: a bank) and want to embed our technology via an API, or they may want to white label and/or modify our pre-existing HyperJar application.
Publishers: Clients who want to publish financial objects or other services into applications (their own or others). Examples: merchant vouchers and rewards; third party savings accounts, ISAs, Sipps
Processors: Clients who want to consume anonymised or suitably permissioned data.

### Examples: Consumer & Business Credit Agencies; Lenders; Analysts

One of our major discoveries has been that the utility HyperLayer extends far beyond the banking sector. There is typically interest and relevance from any organisations who have customer or employee bases who deploy and spend money; the larger the better.

### Applications

### Banks

### Benefits and Use Cases Include:

Differentiation: Neobanks have demonstrated that a high quality user experience can both attract and retain customers at scale. We have rapidly acquired half a million users from a standing start with very limited marketing expense. We offer world first intent based functionality which doesn't exist in current wallets so our partners can really stand out from the crowd.
Defence: Neobanks have taken market share away from traditional banks, but they have tended to be demographically restricted (examples: early adopters; younger adults; particular income segments; London and South East England). In part this is due to trust issues which are incredibly important when it comes to money, which is often why consumers have multiple accounts. Banks are not standing still, nor do they suffer in same way from trust issues, and are building and enhancing their current wallet offerings with copycat features. We also believe intent based functionality is a major missing feature set in wallet offerings and we are going to make it happen. Switching is easy and more and more people are overcoming the inertia to do it. Standing still in terms of wallet evolution looks like a poor choice for an incumbent bank who needs to avoid suffering major erosion of their customer base.
Stickiness: One HyperLayer feature in particular is uniquely sticky and good for customer retention. We allow users to establish financial social networks with their family, friends, contacts, and merchants. This means shifting wallet providers becomes a collective rather than an individual decision, much like exiting a conventional social network. This makes switching far harder and more complex than for current bank account offerings (particularly in light of the Current Account Switching service and significant financial incentives).
Hub: This stickiness can be increased by allowing other financial services offerings to be published in a wallet. Banks need to make a decision to either “own eyeballs” or be a utility provider of deposit holding services in an increasingly competitive market. Banks are well placed to provide the entry point to a users financial life—to do this requires opening up interfaces to third parties—this goes well beyond open-banking.
Cross-Sell: Many banks are looking to cross-sell investment and wealth management products to their customer bases. Enable users to visualise savings/investment accounts as objects in their wallet and to move money in/out easily (example: take any money in my grocery jar at the end of the month and put it in my ISA). Make savings a part of everyday financial management rather than a once a year consideration. HyperJar: helping users “be intentional with their money”—is really the day to day version of longer term savings behaviour.
Credit: Surface existing debt products and negative balances (examples: credit cards; personal loans; mortgages; utility bills) in a wallet. Visibility, management, and micro-payments are all part of day-to-day spend management. Helping people manage debts in a sensible and effective manner can benefit both the user and the provider of credit.
Demographics: Our social and family sharing technology can pull in and empower demographic groups that are otherwise hard to access and/or are digitally disenfranchised (examples: children; the elderly; clubs; carers; gig workers). This is illustrated with the current and highly differentiated demographic profile of the HyperJar customer base.
Digitisation: Digital change: the increase in online shopping; the decline in the use of cash; the increase in digital fraud; the rise of embedded finance. These are all themes which make being intentional with money harder. Help customers address the increasing pace of change in how we spend our money today.
Engagement: Intent-based functionality results in increased high-quality customer interaction—HyperJar has one of the best DAU/MAU engagement rates in the industry given our high-touch feature set. Whilst high user engagement is not a core requirement for wallets historically, most of the use cases we are addressing in this note benefit from high user exposure. Many features of bank apps (for example: active merchant rewards programmes) suffer from low frequency engagement.
Funding: Users—and associated deposits—are attracted by feature set/functionality, not just headline interest rates. As interest rates rise, competition driven by remunerated deposits is only going to increase. By having an interesting differentiated sticky proposition, the requirement to join a race to the bottom on customer remuneration can be avoided. The financial benefits to most consumers of intent based functions can dramatically outweigh the benefits of an extra point or two in interest rates on a typical UK current account balance.
Rewards: A strong merchant rewards offering is now “table-stakes” for modern digital offerings. Consumers want to take advantage of rewards and loyalty programmes and increasingly like having this functionality surfaced in their primary wallet rather than having multiple accounts/cards/QR codes/vouchers. This is an example of “Hub”: allowing third parties access to a wallet in order to reinforce and strengthen the whole proposition. HyperLayer offers up Rewards and Vouchers 2.0—the best offering in the market designed in conjunction with our merchant partners.
Merchants: HyperLayer can provide merchant and loyalty rails to merchants both large and small. There are also important ramifications for payments (A2A) and potential provision of credit products based on and around intent functionality (see separate note). These merchants may be clients (or be future clients) of a bank.
Corporate: Potential for: world first integration of corporate and personal accounts in a single wallet; benefit of shared jars and control features for expense management (many users are already setting up jars for this purpose already); offers to merchant partners and vendors for exclusive deals; be part of a financial wellness solution

“Money worries are the biggest cause of stress for UK employees. They are damaging to business too, often resulting in staff sickness. The case for financial wellbeing at work is compelling” Centre for Economics and Business Research, Financial wellbeing and productivity: A study into the financial wellbeing of UK employees and its impact on productivity, 2018 “4.2 million worker days each year are lost in absences because of a lack of financial wellbeing. That's the equivalent of £626 million in lost output “69% of UK employers. Neyber (2018), The DNA of Financial Wellbeing 2018, “Nearly 7 in 10 UK employers believe staff performance is negatively affected when employees are under financial pressure”.
ESG: Offer customers a better set of tools with which to cope with the cost-of-living crisis; help with the transition from cash budgeting to digital budgeting; promote social inclusion across generations and income levels; provide a counterpoint to BNPL with “Save Now, Buy Later”. HyperJar is a multi-award winning high visibility offering. HyperLayer offers our partners the opportunity to be part of this compelling narrative.
Identity: User-controlled, authorised access to identity and eligibility data to support third party onboarding and verification applications, via a high-touch wallet. This should be an area where banks are taking the lead. We believe that this will be an increasingly important theme as we develop HyperLayer and is one of the reasons we have acquired Factern and its associated IP.

Data: Unique intent data covering social networks; forward looking planning and control. This can provide valuable insights into product marketing and credit decisioning models for consumers. Forward looking Intent data (and payment dominion) can also be used as a completely new credit indicator for merchants to enhance existing products such as merchant cash advance (see note on financial services target products). Bank data currently only sits on the perimeter of the Near Financial Boundary (NFB)—i.e. inputs and outputs to an account.

### HyperLayer Generates Data:

Inside the NFB.
Outside of the NFB, where the user still has an interest in the funds, before they leave the Outer Financial Boundary (OFB)
In interactions and intersections between connected users and their OFBs

### Investment & Wealth Management

For Our Purposes, we Separate Investment/Wealth Management (IM) Clients into Three Groups:
Non-Savers: younger, working, not yet at the point of considering investments, pensions, savings, wealth management
Savers: still working and saving (directly and/or through an employer scheme)
Spenders: no longer working and deploying/spending/giving away savings and pension income

### Benefits and Use Cases Include:

Differentiation: The breadth and quality of service offering is extremely important for both consumers and companies looking to choose between IMs. This can be especially true when the core underlying investment offerings can be relatively homogeneous; like core consumer banking services, many IM functions have become almost “utility-like” (examples: ISAs; SIPPs; stock trading platforms). For many consumers, choice of mid-market wealth management is; all about the app” and service proposition, rather than an analysis of investment performance. In light of this, a number of wealth managers are already considering extending provision of wallet services and cash management offerings. HyperJar offers a unique wallet offering which shares an unusual amount of cultural DNA with Ims—our focus on being “intentional with money” and our recognition that “spending is an important asset class” are really the day-to-day equivalents of longer term savings. This continuum makes the logic of an integration far more natural than with any other form of wallet offering.

Acquisition: A wallet is almost always the first touch-point that a Non-Saver has with financial services (usually long before they are seriously considering wealth management). This is one of the pathways for existing commercial banks and wallet providers to attempt to encroach on more profitable IM business models. Whilst this is happening, the average age of IM clients creeps inexorably upwards. Where has it been written that provision of consumer wallets and accounts are the sole provision of banks? Banks provide wallets in order to drive deposit taking and lending opportunities, we argue that a HyperLayer powered IM wallet from a trusted brand can be a huge medium term driver of acquisition-especially an offering which has fully integrated IM products embedded into an ecosystem which encourages financial intent.

Engagement: Spending is a much higher frequency activity than saving. IM can suffer from limited regular touch points with existing clients exacerbated by digitisation; savings contributions being automated at payroll or made once into ISAs/SIPs at the tax year end. An integrated offering in our in-context digital channel has very high regular visibility. This goes to messaging and communications, marketing and stickiness.

An integration would make the user journey to making incremental investments very short indeed, generating increased share of wallet and increasing overall savings levels by helping movement of unnecessary cash balances into more attractive savings products. HyperJar is a particularly high touch application due to functions for regular active financial management (our DAU/MAU ratio is in the top decile for financial services apps) and also has a full featured scheduler to allow sweeps and round-ups from cash Jars into any other integrated account.

AUM: Not only do users often have earned surplus cash balances which should be moved into IM products, many users also take unnecessarily large amounts of funds out of the IM ecosystem into their bank accounts because its complex to trickle funds out. A particularly good example of this are very large tax free lump sums available from UK pensions which have matured. These are regularly taken out and left sitting doing nothing in bank accounts. This is suboptimal for the IM and for their clients.

An integrated wallet with straightforward transfer functionality should substantially reduce this issue.

Stickiness: Reduce churn, increase stickiness and prevent outflows to other providers. HyperJar is particularly sticky due to its social features (as described above in the Banking section)—this stickiness would be further enhanced by providing unique functionality through IM integration.

Inter-generational: wealth transfer flows. A persistent challenge in IM who have increasingly aging client demographics. As well as early engagement, our focus on families and sharing allows adults who are already saving to share and encourage the younger members of a family group to save by, for example, sharing ISAs or setting up Child ISAs which are visualised on the children's app. For example: A parent (or grandparent) could make a weekly micro payment into a child's ISA: encourages savings habits early—visible growth and contact; starts to encourage and engender intergenerational wealth and brand transfer

Employers: Customer acquisition is often generated through company savings schemes. Wallets in general, and HyperJar in particular are very interesting to corporates (see below)

Partnerships: The IM user base is an incredibly interesting demographic for our merchant partners—especially pensioners. Typically, they do not run large balances nor do they borrow (so not really of interest to banks) but consistently spend money and are hard to address digitally. An integration with HyperJar, with its cutting edge rewards engine, will allow IMs to offer clients highly tailored and interesting rewards. This may go some way to addressing the “age tax” where the older generation are effectively overcharged because of lack of digital engagement.

Demographics: The relative demographics between Savers and Spenders continue to change as the ratio between adult working and retirement span continues to decline. Historically (due to demographics) and commercially (since they are no longer generating salaries for investing), IM focus on Spenders is a relatively lower priority compared to Savers, even though the cohort is growing significantly. For larger firms, there may be good reasons to re-frame client emphasis and consider re-branding as “Investment and Spending companies” rather than just as “Investment Companies”. This means considering/extending product offerings for Spenders. This strategy has the potential to generate new revenue streams in its own right as well as all of the benefits set out above.

### Merchants

As well as providing a fantastic rewards offering (discussed elsewhere), merchants (especially groceries) may issue own branded HyperJar offerings. Benefits include:
Loyalty: Transform the loyalty card sector: a retailer-issued, funded digital wallet, connected to a payment card. Think ‘Nectar with money on it’—not just points. Our demographics suggest that our card would have substantially higher uptake amongst a typical retailers customer base than a neobank or a high net worth offering- and our rewards can be highly personalised in a seamless way (also entirely private for a given user). Become part of a customers planning and budgeting, this would be hugely high profile, differentiated and positive from on ESG perspective.
Existing Services: An enhanced wallet with rewards engine and routing technology may enhance existing retailer-owned financial services propositions. Many large merchants already have Financial Services offerings (including banks) which need to be examined for their continuing relevance.
Products: High interest in variants of some of HyperLayer unique products, namely: AGR rewards (and their impacts on loyalty and basket size); vouchers and gifting; indirect debits (as a far more elegant form of BNPL particularly applicable to grocers and other “utility” merchants)
Costs: Eliminate and/or reduce transaction and interchange fees with direct pay/QR code solutions. Build a multi-merchant solution rather than going it alone (consumers don't want multiple solutions for merchants). This is going to be an increasingly big deal (see Target in the US for details)
Curation: Decide which other merchants to “share” the platform with. HyperJar UK is an open platform which (within reason) attempts to avoid exclusivity. Very large merchants may want to “own” their own channel more fully.
Data: For many large merchants, loyalty/points schemes are primarily about data. By joining a points scheme a user identifies themselves to a merchant which allows a profile to be built of their spending over time. This is fantastic data for: negotiations with FMCG4/Suppliers; internal stock and store management; and for potential personalisation of consumer offers. There is no information about what customers spend away from the merchant however, which is data which merchants would dearly like to have. This is clearly available thorough an integrated merchant card (it is more complex, but not impossible, to get user consent to link data via HyperJar UK) with HyperJar having the huge added incremental benefits of intent and social data.

### Corporates

Corporates have multiple reasons for wanting to offer a Layer powered account to their employees:
Integrated: Deliver the first card in history which can combine personal and corporate spending within one wallet. Embed/firewall a company page within a personal account. Completely discrete spending and transaction functionalities for multiple separated sub-accounts. This essentially combines two typical products in one-a corporate card and a benefits card.
Control: Controls on where company funds can and can't be spent, at a merchant level (example: an office supplies Jar which only works in Ryman with users having a hard cap of £50) Settings are updateable in real time or on a project-to-project basis.
Sharing: Jars as pop-up joint accounts examples: for team members, managers/project leads and their direct reports with permissions for each member. Bespoke, project-specific sub-accounts (Jars) that can be instantly created and closed Rewards: Highly personalised merchant rewards and incentive schemes embedded directly into the account (examples: discounted hotel rates). Merchants love giving targeted rewards to specific corporate demographics (see BlackHawk network as an example).
Exclusivity: Merchants will also pay to be channel partners for control restrictions (example: dinner spend that only works after 8 μm at Deliveroo)
Wellness: Financial wellbeing is very important for corporates as well as their employees. In the UK “11% of UK workers reported they had experienced a fall in productivity at some point over the preceding three years as a result of their financial situation” 5. Helping people be intentional with their money is all about financial wellness. Corporates should be very interested in providing help in this area for their employees.

### Other Organisations

We are engaged in dialogues with a number of other types of organisations about devolved/social spend propositions though HyperJar (or a branded white label). Similar to the Corporate proposition in many ways, these dialogues are built primarily around the ability for centralised control over payments and spending funds managed in one piece of software. For example:
For carers in care homes that are in loco parentis/have power of attorney over service users
For multiple people, including children, on outings, trips or international travel examples: the Scouts, sports clubs

### Audience-Specific Voucher/Reward Propositions:

Hypothecated benefits. Councils offering merchant vouchers as part of benefits e.g. digital supermarket vouchers to supplement or replace food banks
University-issued budgeting and rewards card representing local/campus businesses as well as national chains
Integration with organisation-level discount cards (ego NHS Bluelight) with discounts and rewards automatically recognised and embedded in the app.

### Methods of Engagement

There are a Number of Different Ways in which Potential Partners can Interact with Layer:
Publish: into other Applications (examples: merchant rewards or savings accounts surfaced in HyperJar)
White label: Re-brand our current HyperJar offering, potentially including: different cards; a re-skin of the app look and feel; different products curated and surfaced. All managed by the same team as HyperJar.
API: provide our functionality into a pre-existing digital wallet offering (example: a bank wanting to offer shared jars; routing and blocking; rewards 2.0)

### Collaborations

HyperLayer gets stronger and stronger as more partnerships are added to the ecosystem. One of the great things about having partners with different use-cases is that in many cases there is limited cross-over between objectives. IMs may not be interested in actually holding deposits. Banks are only interested in merchant rewards insofar as it enhances their consumer offering.

Layer is built off, and informed by UKOB and its underlying IP. To the extend that we can add third party partners into UKOB (or white-labelled variants) this can drive improvements in Layer and so the business model becomes self-reinforcing.

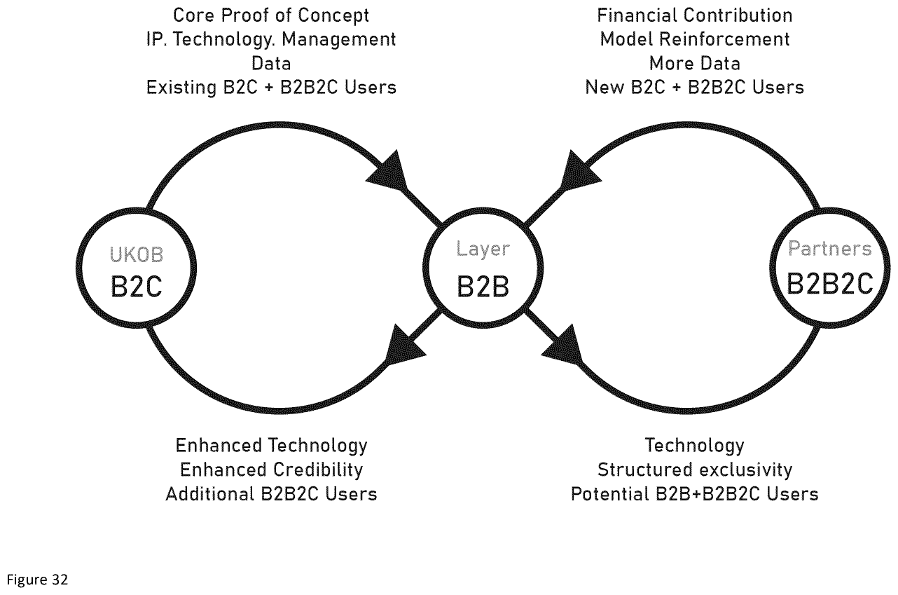

FIG. 32 shows a diagram illustrating the HyperLayer Self Reinforcing Business Model.

### Appendix 9: Layer Architecture

We use the term “Layer” to refer to the technical architecture that implement the HyperLayer system. In many instances, the terms Layer and HyperLayer are synonymous. In this Appendix, we will principally use the ‘Layer’ term.

### Initial Definitions

### User

A person who engages in some form of financial activity—and is directly or indirectly a client of HyperLayer (Layer)

### Account

Anything owned by a User which would generally be regarded as a store of value
We use a broader definition than just digital accounts by also considering other stores of value. (This is generalised later on for Layer with a broader definition of a Financial Object)
Examples:
   Bank accounts
   Points schemes
   Gift Cards
   Vouchers
   Credit cards
   Debt balances (such as a mortgage)
   Money in a pocket
   Funds

### Value

An amount of Units (see below)
A Value doesn't necessarily “exist” anywhere
A Value doesn't need to be a constant, it can be functional
Examples: 100 Pounds, 6 Flying Club Miles, 4 BT shares, 100*EUR/GBP Euros, 50% of a rare Kylie Minogue LP

### Units

Any units used to measure value
Examples:
   Currencies
   A class of shares
   Carbon credits
   An asset with fractional share ownership

### Transaction.

Traditionally. any transfer of Value from or to an Account
For Layer, a transfer of value between two Financial Objects

### Controller

The company who manages a given Account for a User
Examples:
   A Bank
   A Savings Institution
   A Shop

### Digital Wallet

An application for managing one or more Accounts
Wallet Providers are often, but not always, the Controller
Open Banking/BAAS are encouraging more separation between Account Controllers and Digital Wallet Providers
In it's current form HyperJar is somewhat of a hybrid:
   A third party agency banking services provider is the ultimate Controller
   HyperJar is the Wallet Provider
   HyperJar devolves certain responsibilities from the Controller
   HyperJar layers on substantial incremental functionality (using Layer)

### Layer Overview

For Users: Layer is designed to provide access to significant new functionality relating to Financial Objects (FOs)—a form of data object—and associated Transactions that are of interest to consumers. This functionality is delivered through cutting edge Digital Wallets (provided by HyperJar or by third parties). Broad categories of this functionality include:
Passive functions: messaging and notation; goals; display parameters; storage and centralisation of interesting data; advanced analytics
Third party permissions: read access; devolved deposit and spending consents under User defined constraints
Transaction rules: for different methods (examples: deposits; card payments; direct debits) how and if they can be applied across different FOs
Event driven functions: to initiate Transactions, notifications, or alarms.
Grouping—Splitting—Deriving FOs: which can be managed separately from original external Accounts
Integrations: with merchant rewards and other external Accounts which can benefit from being in a common intent-based ecosystem

This is achieved by allowing Users (assisted by one or more Controllers and Wallet Providers) to construct personal data-sets which define their Financial Intent regarding Transactions and FOs that are of interest to them. This is the Users Intent Data Lake (UDL).

### At a High Level, Layer Comprises of:

Data relating to:
   Actors: Corporate and Consumer Users
   UDLs: FO and Transaction information
   Methods: Classification of Transaction types
Instruction sets and incremental data provided by Users, Controllers, Wallet Providers, Publishers and Readers (see below) defining various procedures and rules around how time and proposed changes in the underlying data should be managed
Event handlers
   Note that the a UDL can be Categorised as a:
Consumer Personal UDL (PUDL or Puddle)
HyperLayer internal UDL (HUDL or Huddle)
Controller UDL (CUDL or Cuddle)
Merchant UDL (MUDL or Muddle)

For Wallet Providers: Layer provides the back-end functionality to allow Users to store UDLs and return actions that need to be taken to surface the new functionality to Users.

For Controllers/Account Providers: Layer provides the ability to have Accounts for Users Published into User UDLs which can subsequently be surfaced in Wallets.

### Examples

Passive: Open banking under AISP/PISP, points schemes through APIs
Active: Rewards, third party ISAs or savings accounts

For other Interested parties: Layer provides the potential to be a Reader of (properly consented) information from UDLs. This data can be highly personalised and unique (as we know from the HyperJar use case, examples include: network and social data; forward looking intent data surrounding planning and budgeting; control and routing information) and has an application set analogous and incremental to Open Banking data-sets, so interesting to, for example:
Providers and analysers of credit products:
   Consumers: Forward looking planning and budgeting data to drive credit scoring. Hypothecated lending/merchant accounts
   Small Businesses: Forward looking Intent data as an adjunct to merchant cash advance products (backwards looking)
Retailer/utility insights
Other consumers of open banking data, such as investors and market analysis firms

### Notes:

This document is broadly technology/stack agnostic, however since it is intended to describe the broad structure of Layer, the shape of various technology components and how they fit together is discussed
Layer provides no payment/external functionality. Its scope is limited to data management and processing.
Where Layer believes a transaction should be initiated it is simply informing the Wallet Provider/Controller to complete the transaction and waiting pending confirmation (In certain cases which are pure ledger entry adjustments in the IDL this is not required)
An example of a Publisher with a direct User connection. A mortgage provider who allows users to view and pay-down their outstanding balance through a Layer powered wallet. An example of a Publisher with no direct User connection. A retailer who is publishing a £10 voucher to a given User who they cannot identify.
There is no fundamental reason why Layer needs to know the public identity of any given User (although arguably centralising this information and/or providing identity is good).

### IDL Elements

### Static Data (Past and Present)

Information to record the present state of play of financial networks at a given point in time.

Actors: People or organisations who are relevant to a given User. Typically people who own and/or control relevant Financial Objects (FO) Actors may be participants in Layer (examples: HyperJar; a family member who also has a card) or external (examples: a bank addressed via PISP; Amazon)

### Financial Objects

Building from the Ground Up:

### Atomic FOs (AFO)

Stores of value which are of interest to a User, which a User controls, and are included within Layer (examples: a user Jar; an external bank account (PISP/AISP); a points scheme)
Places where Users send and receive value to and from (examples: Sainsbury's; an employer; a friend)

These are “traditional” start and end points for Transactions. Basically any User Accounts, and any payee or payor they have engaged with, or may engage with in the future.

### Collections of FOs (CFO).

Any relevant collection of FOs is an FO
Examples: All my Jars; all my ISAs; Shell (which contains three vouchers and two rewards); A friend (who has multiple accounts which I can't see); me (all my FOs on the system)
This is definitionally obvious if you consider an FO to be a start/end point of a transaction. If I am sending money to a specific account belonging to Nicola, then I am sending money to Nicola.
There are CFOs which are clearly relevant to Users, and other CFOs which are more relevant to other Actors (examples: all FOs amenable to the Mastercard method; all Rewards offered to any User by Shell).

### CFOs Form Part of the Core Underpinnings of Layer:

Users don't always view the world with an account level resolution. They want to send money to a friend, or a retailer—they don't care what specific Account the money ends up in. They want to analyse all their spend at Amazon, they don't care which of the ten sub-businesses that they are transacting with. Sort codes and Account numbers are of no interest to most people—this is why phone-number/name based P2P cash applications are so popular
Key functionality of Layer involves applying Transactions relating to CFOs across their component elements (AFOs) (Example: all of our priority of payments rules: how a single payment can be comprised of sub-transactions from a reward: a voucher; a jar; a shared jar; my wallet).
One of the challenges for our competitors is that they typically only consider AFOs not CFOs—you have to send money to an Account; or for directing payments you have a proliferation of separate Accounts which you have to select from
An AFO can be in multiple CFOs. CFOs can intersect. Every one of our Users entire IDL represents an overarching CFO where every other CFO/AFO is a subset. User defined CFOs are a “thing”

### Derived FOs (DFO)

### Any Well Defined Set of Transactions can be a DFO. Some Examples:

All Transactions made in pubs.
A bunch of User(s) selected transactions that are going to be reconciled (the “Reconciliation Object”)
All Transactions that Mat has flagged with the tag “Ooops”
Our entire Jar structure is an ordered series of DFOs derived from a single FO. Obviously from the point of view of the User these are simply AFOs.
   What is the Initial Intended Purpose of DFOs? they Form the Basis of:
Analytics: DFOs essentially form the scope of our series of awesome analytic tools (both individual User and multi-User DFOs)
Alarms and events: If This Then That (ITTT). Examples: notify me when my daughter has spent over £100 in any of these three shops
Rules: for Reward activation for example
Synthetic Accounts: As we have seen with the specific example of HyperJar “Jars”

### General Comments

All forms of FO described above (AFO, CFO, DFO) can be generalised simply as well defined sets of Transactions (see below)
Transactions can (and will) sit in multiple FOs (example: a payment can come from “Bob” and “My Friends”; a payment can go to “Amazon” and “Amazon Prime”)
Multiple FOs can be subsets of a CFO and they can intersect (example: “Jars Shared with Me”; and “Bob”)
There is no requirement for a FO to have a well defined balance

### Point-of-View (POV)

Layer is crucially about the Point-of-View of a User. An IDL is an expression of how a given User sees the FOs of interest to themselves:
An FO belongs to a given User even if the underlying Account does not. It essentially acts as a mirror (it may inherit data/balances/characteristics of course).
This means that there may be multiple representations of a given FO within Layer. Example: if a User shares a Jar with 5 other people then there will be six FOs. People may see different transactions based on permissions. If the User deletes the Jar this does not delete the mirrors in the IDLs of the other participants
Users may display, and have entirely personalised rules about how a FO should be treated which are different from other people (we already see this in the fact that different Users can place different controls and priorities on the same object). This is an important point for the structure of Layer—it is constructed around personal frame of reference
It also provides clarity about data ownership which is often a little hazy when it comes to Transactions historically. (Who “owns” the data about a payment from A to B made by C?)

### Transactions

In general a Transaction is any change in a FO. Typically this means a transfer of value From some FO To some other FO. Although:
A straight adjustment (or destruction in value) is essentially a transfer to the null FO
From and To are arguably just shorthand for linking two associated adjustments. Negative numbers allow you to change the direction of a Transaction

Overall template—can be used for Transactions that have happened (or are going to happen)—and also classification into FOs

### General Structure

ID: since the same Transaction can exist in many different FOs (and may be represented differently) and it may be desirable to link incidences together
From and To
Actor: who made it happen (goes to sharing)
Method: how was it done (example: Mastercard)
Other: any other data which is attached (examples: Account data; SKU data; other metadata)
Time: When the Transaction occurred (or is going to occur—this can be functional)

### Split Transaction Groups

As we have discussed above, a Transaction can be an element of more than one FO. It is also the case that a single Transaction can be split into multiple sub-trans-actions. This can be true of both the From and To FOs (or indeed both). Examples:
A single payment with a HJ Card which is comprised of multiple sub-transactions from Rewards, Vouchers, Jars and shared Jars—so the single overarching transaction From a User to a Merchant is comprised of a bundle of sub-Transactions from multiple FOs (contained in the CFO on the User).
An inbound receipt from an employer that a User has chosen to apply into a set of Jars (Groceries; holiday; Car) based on rules (which have been stored in their IDL)

These are both examples of Priority-Of-Payments (POP), one being an Input and one being and output POP (IPOP and OPOP)

### Transaction State

Transactions have a State:
Scheduled: A Transaction which is planned for some time in the future
Theoretical: A proposed Transaction that may not happen. A Transaction can be proposed to Layer
   Layer can return the impact/changes that would occur
Pending: A transaction which should have occurred, Layer has registered it as pending awaiting confirmation-so theoretically it could fail to complete
Completed: A Transaction which was pending and has been (externally confirmed)
Note: In certain circumstances, a Controller may combine Pending and Completion states
   can be dealt with through the API

### Methods

Methods to Initiate/Complete Transactions. Examples:
User transfers
Various card payment
Bank transfer
Direct Debits

Various methods may be treated differently under the IDL (for example different potential POPs).

The level of control of a given method (for example: is it being managed by a Controller) also has ramifications for the levels of functionality that can be generated by Layer.

### Descriptive Metadata

Various. Non-Exhaustive Examples:
Information on how FOs/Transactions should be displayed (in a digital wallet for example). More broadly analytic frameworks
Tagging (to categorise into various other FOs)
Messages/notifications

### Data Relationships

As discussed above, one of the key structural features of Layer is defining and codifying the relationships between various FOs. As part of this, the relationships between metadata held at related FOs need to be well defined. This falls into three groups:
Inheritance: FOs which inherit data/characteristics from CFOs which contain them (example: if a User locks the CFO containing all Shell FOs, then each individual Reward or Voucher is locked)
Bubbling Up: CFOs who pull data from their own elements (Passive examples: messages and transactions. Active examples: balances (which need to be summed up))
Infection: FOs who obtain data from other FOs. This is usually conditional statements which need evaluation (example: this reward is active if total spend by a group is greater than X)

Note: These data relationships really are intrinsic (static) rather than simply queries to be calculated at some point in the future. This is why they sit in this section.

In this way maintaining the integrity of these data structures is a core function of the IDL rather than the processor.

### Intent Data (Future)

Metadata in an IDL to set out instructions for what happens when change happens.

### There are Two Main Ways:

The passage of time (example: a standing order)
New transactions and/or information are proposed or added to the IDL (inbound or outbound Transactions; new FOs added; external events logged)

### Intent Data in the IDL Serves a Couple of Major Functions:

Permissions: Is an Actor allowed to action a proposed change/Transaction (example: Juliette has been permissioned to use this account by Rob)
Allocation: how should Transactions be booked; across which FOs; and in what order. This is core Layer functionality: POP; IPOP; OPOP
Validity: Can you deploy the value in an FO in a given POP (examples: the User has locked it; a merchant says it only works on a Tuesday; you aren't in the right shop)—this forms the basis of some amazing merchant intent functionality and some of our cutting edge gift card products
Event Handling: conditions met which may cause (amongst other things):
   Notifications and Alarms (example: warn me if my balance goes under 1,000 in my grocery Jar)
   Further transactions to occur (example: if my balance goes under 1,000 in my grocery Jar, top it up from my wallet)
   Validity conditions to be changed (example: someone has been in a shop six times, validate their reward for the seventh visit)
   External events to be flagged (example: tell Virgin that Bob has met the conditions for a free space flight)

The combination of Static and Intent data comprises an IDL.

The structure set out above is designed to be as agnostic as possible about what form and manner of FOs are being managed. Specific products and functions are imposed by the Layer Processor and the specific metadata that it chooses to hang off the FO. Clients of Layer will have various products and features imposed upon them by what APIs they are exposed to by the Processor.

The next section sets out a list of functionality offered by (or to be offered by) Layer that is subsequently implemented at the IDL.

### Processor Elements

### Real World Accounts

From the POV of a Controller different sorts of Accounts are amenable to different levels of potential functionality using Layer. In reverse order:
An Account that exists, but you can't get any information about it, nor can you withdraw or deposit (example: Fort Knox)
An external Account that you can only receive money from or send money to, where you have no other information (such as balance). This is most normal external FOs (examples: Sainsbury's, an employer)
An Account owned by a User which has I/O methods which are either: not managed by the Controller, and/or are not managed through Layer—an Open Account. (an Account managed through Open Banking/PISP/AISP where a User could use a cash card away from Layer without notification)
An Account owned by a User where all I/O methods are managed through Layer-a Closed Account (example: Jars and Rewards in HyperJar)

The greater the level of functionality which can be devolved through Layer, the richer the product set which can be made available for the given class of Accounts.

This doesn't mean that Layer doesn't provide rich and useful functionality for all types of Accounts. The key premise of Layer is to stitch together and provide the logical infrastructure to provide digital operability and interoperability between UFOs a whatever level of control is available to the User and their various interested Controllers.

We now describe examples of functions that may be available through Layer.

### Decorative Functions

### Display

Naming/aliases for FOs
Colours/pictures/animations to indicate display preference (may or may not be Digital Wallet dependent)
Rules about how to display transactions
Ability to create user defined CFOs-view them in aggregate, and have inherited characteristics

### Messaging

Rich messages can be attached to FOs and Transactions
Messages can Bubble Up to FOs (containing Transactions with attached Messages) or CFOs
Messages in shared FOs (see below) can be shared with other “members” of the FO. This is effectively a chat group associated with a Shared FO (see below)
Since every relevant contact (or group of contacts) can be an FO. The message functionality extends to direct messages to friends, clubs, payors and payees (to the extent that they are lucky enough to be Users of Layer)
Message functionality can be integrated with external messaging services (such as pop notifications on phones or Whatsapp) in order to provide a more complete UX and/or allow a level of integration with non-layer participants
In this way, Layer allows a binding between a rich messaging and communications layer and a Users FO structure. This is especially important for our social functionality
The Messaging service is also available for (suitably permissioned) Merchants to interact with Users—a key engagement tool

### Notifications

System generated notifications about changes in the IDL
User defined event driven notifications
Notifications can be fully integrated into the Messaging service

### Activity Markers/Red Dots

Provision of activity markers to Wallet providers in order for Users to be able to see where activity has occurred (for example: in Messages/Notifications/Transactions/FOs)

This is a key tool in allowing Users to have a better experience when exploring complex financial relationships. (In many current applications, you have to log into an account and check to see if something has changed)

### Analytics

Ability to define DFOs to which a wide variety of analytic functions can be applied.
Typically these are a combination of an initial scope (a UFO) and then some form of partitioning
Note: alarms and various event driven features are close bed-fellows for the analytic engine
Shared Analytics: Ability to share analytics (in the same way we allow sharing of other Financial Objects)—hugely valuable for comparisons and groups (example: how is our family spend on groceries broken down by individual)
Cross User Analytics: Ability to run analytics across FOs belonging to multiple users (example: what is the total amount set aside for the next football club tour?)
One of the great tragedies of traditional accounts is that they are designed for individuals
   this not only compromises spending functionality it also compromises planning and budgeting functionality

### Devolved Spend

One of the key ideas behind Layer is the idea of devolved spend (to the Outer Financial Boundary. Not a for this document of course). The core principal here is one of Devolved Spending Permission. That is:
A User legally owns an Account (and remains the owner).
The User allows one or more other Users to view/change/spend funds on their behalf subject to constraints (Think of this as a super turbo-charged version of a supplementary credit card)

### Constraints can Include:

Amounts (only £100)
Methods (only with a given card)
Transactions (only in a given shop)
Logical (only on their birthday; only when I confirm the transaction).
Viewing constraints (can they see balances; messages; other Transactions)
In this way Layer allows for logical multi-person spending accounts (examples: family petrol/grocery/take-away; holiday; football club)
Together with messaging these are Social Spending Groups (SSG). Given the multi-User nature of an SSG, Notifications and Activity Markers are key features of effective deployment

### Synthetic Sub-Accounts

Given a Closed Account (one where Layer controls the I/O), Layer can create an arbitrary number of synthetic sub-accounts:
Given X, an FO which is a Closed Account, Layer can create a set Y of DFOs of X where:
There is no intersection between elements in Y.
The sum of the balances of X is the balance of Y
All Transactions in each X are transactions in Y
Note: certain Split Transaction Groups for a single Transaction may include multiple elements of Y which may (for the purposes of some observers of X, may look like a single Transaction
This is essentially imposing a ledger on a traditional account. The key point is that every derived account can be treated entirely independently as an FO with all of the incremental functionality that this brings

### It is Possible to Derive Other Forms of Synthetic Sub-Accounts:

The DFO rules above apply to an Open Account. However every DFO derived in this way is also an Open Account, so the potential uses are more limited
DFOs derived by Transaction/Source/Destination type provided the categorisation forms a clean partition

The key point here is to move away from traditional Account structures where every Account is its own stand-alone entity (with, for example, its own Account number). Normal accounts are impractical and/or unnecessary for Users who want lots of fast accounts spooled up at speed but also for Social Spending Groups.

One of the reasons why various pre-existing attempts at multi-account functionality persist in using multi-account rather than ledger based solutions is because they don't allow Transaction methods to be applied to groups (CFOs). Which brings us onto the next section.

### Priority of Payments

Layer allows for “conventional” Transactions to be addressed to CFOs and for the Transaction to be subject to:
Routing: directed in whole to a particular FO which is an element of the CFO (examples: take my Salary and put it in my income Jar)
Separation: into a Split Transaction Group and applied across all of the elements in a CFO (subject to various rules). In this case the sum of the values of the elements of the Split Transaction Group=the value of the initial Transaction

Note that Routing/Separation can be nested through multiple depths of CFOs (example: A payment has been made with a Mastercard. It is applied to the CFO of Mastercard eligible FOs. Layer has identified that the card has been used at Shell, so the payment is applied to the CFO (within the Mastercard eligible CFO) of Shell related FOs).

Clearly this can be generalised as any arbitrary allocation function, and Routing is a special case of Separation (into one FO within the CFO) however we set out a series of practical functions to make use of this hugely powerful concept. The three primary ideas are:
Filtering: Which FOs are eligible to participate in a POP
Splitting: Breaking a Transaction up into sub-trans-actions based of specific partitioning of associated metadata or rules
Ordering: what order should a payment be cascaded through a given sub-set of eligible FOs. Ordering is basically exhausting the list of eligible FOs in sequence until a Split Transaction Group representing the entire Transaction has been created.

### Filtering/Splitting:

Method: only consider FOs where the given Transaction Method is valid (example: you can't buy sweets from your Stocks and Shares Fund)
Source/Destination: These may be used to rule out certain FOs (example: spend at Shell rules out Reward FOs for any merchant other than Shell; I would like payments from any of my clients to be deposited into my client account)
Metadata: splitting a Transaction based on attached metadata (examples: SKU level splitting; pay for actual groceries from my grocery account; and petrol from my work petrol account)
FO Constraints:
Users: (examples: this Jar can only be used in these places; by these people; on Tuesday; I have specifically locked this FO because I don't want to use it yet)
Merchants (a broad range of constraints to encourage certain behaviours-see below)

### Ordering

Category POP: Example: Consume eligible Rewards (FIFO), then Vouchers, then Accounts.
Starting FO: Begin sequencing the Account FO POP at a User defined start-point (manually selected; or automatically linked based on metadata/location).
Roll-over/Backup FO: If an FO cannot is exhausted before a Split Transaction Group has been formed (essentially run out of funds) a back-up FO is nominated (and attached as metadata to the exhausted FO) (example: if I don't have enough money in my grocery jar, take funds from my wallet)

In this way a Split Transaction Group can be formed for any given Transaction applied to a CFO.

### Example 1 (from HyperJar) OPOP

Reward 1. An AGR dynamic reward calculated at runtime at POS
Reward 2. A further cash reward because the shopper has visited the shop 5 times
A Gift Voucher for the store
Funds from an account shared by a family member which the User has specifically pointed the merchant at
Excess funds paid from the Users wallet because the first four FOs did not form a complete Split Transaction Group

### Example 2 (from HyperJar) IPOP

### A Salary Payment is Received (and Identified as a Salary Payment)

The grocery account is topped up to £1,000
Any unpaid IOUs in the utility account are settled
£100 is paid into my cash ISA
The balance is put into my Wallet

Another way to do this is to Route the salary payment (based on metadata or active addressing in the information field) into a “Collection Account” which triggers four subsequent “when I can” payments.

A few further comments on identification (for purposes of Routing), which may be done using for example, but not limited to:
Passive: Layer/controller mapping based on analysis of metadata (examples: sort code/account numbers, ISO strings, SKU data)
Active: In conjunction with external sources or destinations (examples: API calls at POS; specific data in the notes field for BACs payments)
User Defined: Where a User has defined an FO against a template to define an unmapped Account type (examples: a small local business, I want transactions like this to be routed in this way)

### Transaction Reclassification

What happens if a Transaction is misapplied to the wrong FO? Where possible, a User can simply reclassify a transaction and the balancing payments can be made between the original and the target FO. For this to happen the Transaction generated by the Reclassification has to be valid. This is of course trivial if the Source and Destination FOs are DFOs of a common FO (see HyperJar for details).

The “Time Machine”. This is a time limited ability to rectify mistakes (be able to select a different card) that only works for 3 days (the settlement window for card transactions). Layer Transaction Reclassification is not time bound in any way, and the metadata surrounding the reclassification exists in both FOs from a record keeping perspective.

### Constraints/Validity

As noted above, whenever a Transaction is attempted (in any way) a potentially eligible FO may need to be evaluated for validity based on certain logical constraints that may have been imposed on it. These constraints are structured as lists of logical statements which can be chained together and have to evaluate as True in aggregate in order for a given FO to be eligible to contribute value to a Split Transaction Group. This allows:
Users to place constraints on their own FOs
Users to place constraints of FOs which they share (examples: shared Accounts and gifts)
Publishers (such as Merchants) to add conditionality around Rewards/Vouchers. This allows for a rich ability to provide almost any reward that one can imagine.

Layer allows for almost complete flexibility in setting of Constraints.

### For Users:

Blocking: Transactions from or to particular destinations. This can be structured as Only or Never lists. A great example of this is fraud prevention. We can create Validity Templates for major merchants where payments can be blocked if source accounts or MID codes are wrong
If available: SKU Level Blocking (example: reject any transaction with alcohol contained in the basket)
Time based: (example: only allowed to spend from this jar at the weekend)
Consented: For sharing and gifting, the permission has been given subject to the User flagging OK in their IDL (examples: £10 to a child requiring the parent to acknowledge that homework has been done; various escrow solutions)

### Transferability

One of the key product classes that can be managed through Layer are Hyper Vouchers (HV). HV are a form of super-powered gift card:
A sum of money is placed into a new FO
This FO has a (nominally) irreversible constraint placed on it which limits its use to one (or more) Merchants.
This HV is transferable, however the recipient cannot remove the constraint

In this way, an HV is a riskless digital gift card which can be operated seamlessly behind various payment methods (since it can be part of an OPOP)

### Other Key Features of HVs:

Users can buy HVs for themselves.
In the event of a merchant default funds can be returned to the User (or the giftee) since they remain with the original account provider
HVs have balances so can be used multiple times (unless structured otherwise)
Users can place additional constraints on an HV which is packaged as a gift (as well as spending location):
   Date ranges (example only works at Christmas)
   Behavioural constraints (giftee has to have a certain amount of identical HVs before activation)
   Transfer and sharing constraints.
Merchants are clearly very motivated to see Users generating HVs, and there are many interesting Rewards that can have HV creation as a trigger event
As a side note: use of an HV can create a notification event (using the Event Handler) to message the gift or when the HV is consumed

Merchant constraints are covered in more detail in a following section on the Rewards Engine.

### Transaction Engine

From the POV of a User who wants to execute a Transaction (both immediate and scheduled for the future-essentially the same thing where When can be “Now”), there are essentially four main variables (ignoring decoration):
Amount
From
To
When

Layer keeps a record of Transactions executed by (or to be executed by) each User.

Layer takes the simple template and generalises it to create extensive additional functionality:

### Amount

Functional: Amount can be calculated rather than absolute (examples: pay a % share of a request; round-ups-pay a transaction from my wallet equal to the difference between the last transaction and the nearest £1)
From To: make a payment that adjusts the source balance to a target (can be monotonic (i.e. only a reduction) of symmetric (i.e. transaction can be reversed)) (examples: clear a shared Account down to zero after a holiday has been completed; do Account level round-ups)
To: make a payment that adjusts the source balance to a target (can be monotonic (i.e. only an increase) of symmetric (i.e. transaction can be reversed)) (examples: make sure that at the beginning of every month I have £1,000 in my grocery Account)
Bounded: Pay of no more than X when a request gets made (for variable subscriptions)
Fractional Scheduled: Pay a total of X in a series of payments of amount Y (requires periodic “When”) (example: Pay my debt of £100 to Mat off with £10 every week)
Fractional Unscheduled: Pay X off with any amounts that Arrive in a Jar (requires periodic “When”) (example: Pay my Gas Bill down with any amounts that arrive in my Bill paying account)

### From/To

Internal: Huge User functionality can be derived from transfers and scheduling between separate FOs of a User. We call regular scheduled payments for budgeting, pocket money Internal Subscriptions
Requests: Transactions where the From FO belongs to someone else are “Requests”. They appear in the Transaction list of both the requester and the requestee (who can choose to ignore it or not—the When date is Suggested (see below))

CFO level: From and To can be pointed at groups of Users—this allows group requests of payments, or payments to groups (partitioned/repeated or through a POP) (examples: please request £10 from everyone in the club; please pay everyone in the club £10; please request this group pays me £100 in aggregate; please pay this bill from this Jar but if I don't have enough, take the rest from my Wallet)

### When

Singular: Now or a specific date and time in the future
Periodic: Standard Standing Order functionality (examples: weekly; monthly; end-of-month all starting on a singular date)
When Asked: Consented and variable subscriptions
When I Can: Make a payment when sufficient funds exist in the From FO to successfully complete the transaction (a key part of Reconciliation and Indirect debits)
Undated: Set up a payment but leave the Transaction Date incomplete (examples: undated requests; payments which a User intents to make but is unclear on the completion date)
Event Driven/ITTT: Payments where execution date relies on a Logical condition being True (examples: Pay this when I receive my Salary/when Bob has paid/when everyone in a group has paid into a Shared Account)

### Ordering

### Where Transactions are Scheduled at the Same Time Either:

FIFO: First In First Out
User Defined: An ability to re-order the FIFO list
Event Driven: Make transactions dependent on one (or more) other events occurring

### Merchant/Retailer Functionality

Merchant Rewards are FOs Created by Merchants which:
Can be seen by a visibility CFO (comprising of Users who meet certain criteria)
Are “Owned” by an Ownership CFO (comprising of Users who have either picked up, earned or been given a particular Reward)
Can have functional “balances” addressable for each User (as well as a total balance for audit purposes) for example:
   Absolute amounts (example: £10 of Shell “money”)
   Percentage: of Transaction spend (example: 10% off your total shop up to £100)
   Discontinuous Functional: Different amounts based on conditions or events (example: £10 off but £20 if you shop in-store rather than on-line)
   Continuous Functional: Amounts that increase over time. These Dynamic rewards form the basis of our novel flagship intent reward—AGR (see below)
   Random/Variable: Allows for exciting gamification with lottery style rewards (example: 1/100 gets all their shopping for free)
Can be “denominated as Merchant currency” for a single of a group of Merchants (example: this can only be spent at Sainsbury's or Argos)
Can have arbitrary sets of Validity conditions attached.

### This Allows for a Rich Series of Different Forms of Rewards to be Offered:

Highly targeted to Users
Opportunities for Gamification.
Can serve different objectives for different Merchants. In this way, HyperRewards represent expressions of Merchant Intent

### A Non-Exhaustive List of Reward Categories Offered Up Through Layer:

### Commitment (AGR)

Dynamic rewards for regular commitment
Encourages savings and planning
A fantastic form of loyalty (examples: Shell and Lidl pilots)
Can grow over time—similar to interest
Purpose: Loyalty. Continuous engagement. Wallet Share

### Money On

Deductions/coupons calculated in real time at POS
Better user journey than cash-back
Cheaper in terms of VAT
Merchant “money” feels different from “Money Off”
Purpose: Traditional driver of acquisition/one time spend

### Jigsaw

Activates when a series of a user collects a series
Transferability makes social Jigsaws possible
Consumer doesn't need to carry annoying card
Purpose: Repeated engagement+fun

### Collective

Rewards that increase the more people pick it up
Can be global or within social groups
Can be time/amount/count limited
Great for addressing social networks
Purpose: Mass Participation+viral+referral

### Random

Any reward with a random payout function
Allows for a small number of big prizes
Like premium bonds/scratch-cards
Consumers prefer the chance of a big payout
Purpose: An interesting variation for any other reward

### Stamp

Money off after a set number of visits Popular in many coffee chains No need for cards or training staff in-store
Consumer doesn't need to carry annoying card

### Encourages Repeat Visits

### Time Based

Only works during quiet times for merchant
Can decline in value over time
Only works on Birthdays/at Christmas
Great for addressing social networks
Purpose: Drives desirable time based behaviour

### Social

Rewards given to friends (Secret Santa)
Rewards that can only be given away (viral)
Rewards for groups
Rewards that can be given to children
Purpose: Referral+family+group spend

### Survey

Rewards for completing a task
Filling in a merchant survey
Watching merchant content
Can be tied in with spending patterns
Purpose: Bespoke data gathering with consent

1. A computer-implemented system configured to provide data processing services to an entity, the system including:
(i) a data-analysis environment, which includes or accesses a data store that stores data and meta-data for one or more data objects that represent a store of value (‘data objects’), such as data objects that are created by the entity; and
(ii) an API layer that links the data-analysis environment to (a) a digital wallet provider, and to (b) a service publisher that publishes data to, and receives data from, the data-analysis environment.

2. The system of claim 1, in which:
(i) the service publisher is configured to receive a message defining a proposed transaction from the data-analysis environment, such as a payment transaction relating to the data object associated with the entity;
and the system further includes:
(ii) a digital wallet app, such as a smartphone or desktop app, that exchanges data with the data-analysis environment and where the digital wallet app includes a user interface that displays one or more user-selectable icons or items that each represent a data object in the data store;
and where the data-analysis environment is configured (i) to analyse data or meta-data in the message defining the proposed transaction to allocate that proposed transaction to the relevant data object in the data store and, if the transaction is allowed, then (ii) approve the transaction and initiate a response to a transaction proposer, (iii) to automatically alter a value of the relevant data object and (iv) to automatically alter the value of the data object as shown by the digital wallet app, or if the proposed transaction is not allowed, then (v) decline the transaction and initiate the response to the transaction proposer.

3. The system of claim 1 in which the data-analysis environment is configured to enable a data object to be created, selected, defined or modified by the entity to represent a future intent or an intended future action, namely one or more of: (a) what they intend to spend on; (b) where they intend to spend; (c) when they intend to spend; (d) who they intend to spend with; (e) how they intend to spend.

4. The system of claim 1 in which the data-analysis environment is configured to receive proposed or completed transaction data from an external digital system, such as a debit card, points/loyalty card, an app running on a smartphone or a webshop, and to analyse the transaction data to automatically allocate the transaction to an appropriate data object by comparing the transaction data with the meta-data for one or more data objects.

5. The system of claim 1 in which the data or meta-data for a data object defines (a) one or more permissions that describe who can and cannot transact with a data object or a clusters or group of several individual data objects, and/or (b) one or more rules that describe whether a predefined transaction or other event affecting the data object is permitted or blocked;
and the data-analysis environment further includes:
(ii) a rules engine that is configured to automatically and in real-time analyse a proposed transaction relating to a specific data object, against the permissions and/or rules stored in the data store, and is configured to automatically send a message or signal that results in the proposed transaction being automatically allowed or blocked.

6. The system of claim 1 in which the data-analysis environment is configured to analyse in real time a payment transaction to determine if it relates to a specific data object and to analyse any applicable rules or permissions for that data object; and, if the rules or permissions allow the payment transaction, to then process and record the payment transaction against that specific data object in real time.

7. The system of claim 1 in which the data-analysis environment is configured to enable a data object to be created, selected, defined or modified by the entity to represent a shared data object that one or more third parties, identified by the entity and whose identities are recorded in the data store, are able to view and/or to transact with.

8. The system of claim 1 in which a data object is created, selected, defined or modified by the entity to represent a shared data object that one or more third parties, identified by the entity, are able to view and to transact with, and the identities of the third parties is stored as data or meta-data in the data store;
and in which the data-analysis environment is configured to enable messages relating to the shared data object be sent between the entity and the third parties.

9. The system of claim 1 in which the data-analysis environment is configured to enable the entity to create, select, define or modify a data object to give a third party entity the ability to perform actions in relation to the data object that are delegated by or devolved by the entity to that third party entity, such as initiating a payment transaction from that shared object.

10. The system of claim 1 in which the data-analysis environment is configured to enable multiple entities to share a data object for a shared transaction or event;
and in which the data-analysis environment is configured to automatically reconcile or allocate sums, e.g. after the transaction or event has concluded, among the multiple entities, according to rules or conditions as agreed by the multiple entities.

11. The system of claim 1 in which the data-analysis environment:
(i) is configured to enable a supplier to create rules relating to one or more of the data objects, the rules being stored in the data store;
(ii) includes or accesses a rules engine that is configured to automatically apply those rules when determining if data messages are sent and displayed in relation to the data object or objects.

12. The system of claim 1 in which the meta-data for a data object defines which third party merchant or merchants are permitted to transact with the data object.

13. The system of claim 1 in which the data-analysis environment is configured to share, with one or more merchants, one or more of the following types of intent-related data, which are collected into a queryable database or data set that is stored in or is accessible by the data-analysis environment: what the user intends to buy using a specific data object;
who the user intends to spend their money with, using a specific data object; when the user intends to spend their money, using a specific data object; any transaction entered into by the entity using a specific data object with the merchant or other merchants, such as what was purchased, when it was purchased, where it was purchased, and whether any reward or incentive was used in the purchase.

14. The system of claim 1 in which the data-analysis environment is configured to enable a merchant to define one or more rules for awarding rewards or incentives, the rules being stored in a rules engine in or accessible by the data-analysis environment; and
the data-analysis environment is configured to use the rules engine to determine whether to automatically award those rewards or incentives to a data object that satisfies the rule(s).

15. The system of claim 1 in which the data-analysis environment is configured to analyse a proposed transaction to automatically identify a counter-party or origin of the proposed transaction, such as a specific merchant that the entity is transacting with.

16. The system of claim 1 in which the data-analysis environment is configured:
(i) to enable the creation, supply, or purchase of, non-fiat currency linked with a specific merchant or group of merchants, such as rewards points or vouchers, and stores these as data objects; and
(ii) to analyse in real time a payment transaction to determine if it relates to one of the data objects stored in step (i) above, and to analyse any applicable rules or permissions for that data object;
and, if the rules or permissions allow the payment transaction, to determine the value to be exchanged, and then process and record the payment transaction against that specific data object in real time.

17. The system of claim 1 in which the data-analysis environment is configured to receive a direct debit request from a specific merchant and, when there is no data record stored in the data store of the entity agreeing to accept a direct debit from that merchant, to meta-tag an amount of the direct debit request as a debt that the entity owes to the specific merchant and to store that meta-tag to enable the entity to automatically make future payments to that merchant to progressively pay off that amount.

18. The system of claim 1 in which the data-analysis environment is configured (i) to store meta-data that defines the entity's future intent or spending plans with a specific merchant; and (ii) to generate financial and/or credit evaluation data for that merchant that automatically uses or takes into account the meta-data that captures the future intent or spending plans of that entity.

19. The system of claim 1 in which the data-analysis environment is configured (i) to store a data record for the amounts of one or more non-fiat items owned by or associated with entity and, (ii) when the entity starts or enters a proposed transaction in a fiat currency, then the data-analysis environment is configured to retrieve or look up an exchange rate between the non-fiat item type and the fiat currency, and automatically calculate how the transaction could be completed, in whole or part, using the non-fiat items at a prevailing exchange rate.

20. The system of claim 1 in which the data-analysis environment is configured to store for the service publisher a specific order in which the available stores of value in their service proposition should be credited or debited, based on attributes of the transaction and/or attributes of the available stores of value.

21. The system of claim 1 in which the data-analysis environment is configured: (i) to store for the service publisher multiple different available stores of value in their service proposition that may be credited or debited for a transaction; and
(iii) to process a transaction on receipt of a message from a single user controlled item, such as a payment card, a smartphone, a computer, and to then allocate the transaction to one or more of the available stores of value to be credited or debited for the transaction, based on attributes of the transaction and/or attributes of the available stores of value.

22. The system of claim 1 in which the data store includes data sets, or data lakes, which define, for a user, financial intent regarding transactions and data objects.

23. The system of claim 1 in which the data store includes data sets, or data lakes, which are organised into one or more of the following groups: consumer personal; system internal; controller; merchant.

24. The system of claim 1 in which the data store includes data sets, or data lakes, which define one or more of: permissions; allocation; validity; event handling.

25. The system of claim 22 in which the data-analysis environment is configured to enable data exchange, via an API, an event handler and a processor layer, between one or more of the data sets, or the data lakes, with a digital wallet system.

26. The system of claim 22 in which the data-analysis environment is configured to enable data exchange, via an API, an event handler and a processor layer, between one or more of the data sets, or the data lakes, with an external banking computer system.

27. The system of claim 22 in which the data-analysis environment is configured to enable data exchange, via an API, an event handler and a processor layer, between one or more of the data sets, or the data lakes, with an external merchant computer system.

28. The system of claim 22 in which the data-analysis environment is configured to enable data exchange, via an API, an event handler and a processor layer, between one or more of the data sets, or the data lakes, with an external payment processing computer system.

29. The system of claim 1 in which a data object defines a start or end point for a transaction, where a transaction is any form of a transfer of value between data objects, or any change in the value of a data object.

30. The system of claim 1 in which a data object relates to or defines a transaction, including a planned or intended future transaction.

31. The system of claim 1 in which a transaction is directed or routed to one or multiple data objects.

32. The system of claim 1 in which a transaction is split and then directed or routed to multiple data objects.

33. The system of claim 1 in which a transaction is split and then directed or routed to multiple data objects, based on an analysis of the meta-data attached to each data object.

34. The system of claim 1 in which a transaction is itself, or is directed to, a data object, and a defined set of transactions is a derived data object, and the data-analysis environment is configured to analyse or process derived data objects for the purpose of one or more of: analytics; alarms; events; rules; synthetic accounts.

35. The system of claim 1 in which a data object is a collection of separate data objects or a collective data object.

36. The system of claim 1 in which a transaction relating to a collective data object is split up and applied separately to data objects that make up that collective data object according to a pre-set priority.

37. The system of claim 1 in which a data object is in or associated with several collective data objects.

38. The system of claim 1 in which a data object is a personal financial data object that (i) is structured or selected by an entity consumer to enable the entity consumer to plan, budget, share and control their finances and (ii) include or is referenced by meta-data defining the personal financial data object.

39. The system of claim 1 in which data objects are financial objects, such as bank accounts, savings accounts, ISA accounts, reward point schemes, synthetic accounts, or any other value representation.

40. The system of claim 1 in which the data-analysis environment enables visualisation of a data object, as well as clusters or groups of several individual data objects.

41. The system of claim 1 in which a data object is a digital jar or other discrete object with a discrete user interface icon, stored in a digital wallet.

42. The system of claim 1 in which a data object is a ledger entry, such as recorded in a database.

43. The system of claim 1 in which a data object is a virtual or synthetic sub-account.

44. The system of claim 1 in which a root or primary virtual account data object is linked to a single account number and/or a single physical card.

45. The system of claim 1 in which root or primary virtual account data object is linked to a credit card, debit card, QR code or any other payment channel.

46. The system of claim 1 in which data objects are stored within the data-analysis environment or are stored externally to the environment but are accessible by the data-analysis environment.

47. The system of claim 1 in which the data-analysis environment enables data and meta-data describing a data object associated with a user to be shared with other entities, such as other users, merchants, financial institutions.

48. The system of claim 1 in which, where a data object associated with a user is shared with other entities, then the data-analysis environment provides the user and the other entities with a view or point-of-view of that data object that is specific to, and can hence vary, between the user and the other entities.

49. The system of claim 1 in which the data-analysis environment enables a reward, voucher, gift or incentive redeemed or used by a consumer to be linked to that consumer and shared with the provider of that reward, voucher, gift or incentive.

50. The system of claim 1 in which the data objects include or are referenced by meta-data defining each data object.

51. The system of claim 1 in which the data-analysis environment is configured to process a transaction, where the transaction is defined by meta-data that enables the transaction to be linked to a data object.

52. The system of claim 1 in which the meta-data defines one or more of the following: how data objects are displayed; how transactions are displayed; tagging; messages.

53. The system of claim 1 in which the meta-data defines one or more of the following: what happens to data in the data store when change happens, such as a passage of time or new transactions arise, or new data objects are created.

54. The system of claim 1 in which the meta-data for a data object defines (a) one or more permissions that describe who can and cannot transact with an object or a clusters or group of several individual data objects, and/or (b) one or more rules that describe whether a predefined transaction or other event affecting the data object is permitted or blocked.

55. The system of claim 1 in which at least some of the meta-data is organised into data sets, or data lakes, which define, for a user, financial intent regarding transactions and data objects.

56. The system of claim 1 in which at least some of the meta-data is organised into data sets, or data lakes, which are organised into one or more of the following groups: consumer personal; system internal; controller; merchant.

57. The system of claim 56 in which the data-analysis environment is configured to enable data exchange between one or more of the data sets, or the data lakes, with a digital wallet system.

58. The system of claim 56 in which the data-analysis environment is configured to enable data exchange between one or more of the data sets, or the data lakes, with an external banking computer system.

59. The system of claim 56 in which the data-analysis environment is configured to enable data exchange between one or more of the data sets, or the data lakes, with an external merchant computer system.

60. The system of claim 56 in which the data-analysis environment is configured to enable data exchange between one or more of the data sets, or the data lakes, with an external payment processing computer system.

61. The system of claim 1 in which meta-data for a data object defines one or more rules that describe whether a predefined transaction or other event affecting the data object is permitted or blocked.

62. The system of claim 61 in which a consumer who has created or selected the data object defines one or more of the rules.

63. The system of claim 61 in which a third party to a consumer, such as a merchant or a payment channel defines one or more of the rules.

64. The system of claim 61 in which the rules are if/then logic defining the circumstances when a transaction is permitted or blocked.

65. The system of claim 61 in which the rules are if/then logic defining the circumstances whether a predefined transaction can automatically occur and that define customer incentives or rewards.

66. The system of claim 61 in which the rules are if/then logic defining customer incentives or rewards.

67. The system of claim 61 in which the rules define time-based customer incentives or rewards.

68. The system of claim 61 in which the rules define a merchant's incentives or rewards associated with a consumer committing to spend with that merchant.

69. The system of claim 61 in which the rules define which merchants, or which kinds of merchants, can transact with an individual personal financial object.

70. The system of claim 61 in which the rules define a kind of goods that can be purchased, with their costs debited against a specific individual personal financial object.

71. The system of claim 1 in which the system includes a digital wallet app, such as a smartphone or desktop app, that exchanges data with the data-analysis environment and where the meta-data for each data object includes a numeric quantity that represents value (‘numeric value’), such as a monetary or financial value, and the system is configured to display the numeric value of one or more of the data objects to enable the entity to plan how to use the value represented by the numeric value.

72. The system of claim 1 in which a digital wallet user interface enables a user to enter an input defining one or more of the following types of user data, which are then processed by the data-analysis environment: what the user intends to buy, using money allocated to a specific data object; who the user intends to spend their money with, using money allocated to a specific data object; when the user intends to spend their money, using money allocated to a specific data object.

73. The system of claim 1 including a digital wallet user interface with graphical user interface items, icons or labels for one or more of the following categories of data objects that enable the entity to plan, budget, share and control their finances; (a) data objects that represent different spending categories; (b) data objects that represent different saving categories; (c) data objects that represent different data objects shared by other entities; (d) data objects that represent different objects shared with other entities.

74. The system of claim 1 in which a data object is different from a bank account in that the entity can create or select multiple different data objects, to enable the entity to create a personalised or customised cluster of these data objects.

75. The system of claim 1 in which a digital wallet user interface enables the entity to create or select multiple different data objects in different categories of data objects that enable the entity to plan, budget, share and control their finances.

76. The system of claim 71 in which a digital wallet user interface enables the entity to initiate a transaction with an external entity from or to a data object, created by or for that entity, in a manner that automatically alters a numeric value of the data object that represents value.

77. The system of claim 71 in which a digital wallet user interface enables the entity to initiate a transaction with an external entity from or to a cluster of data objects, created by or for that entity, in a manner that automatically alters the numeric value of the cluster.

78. The system of claim 1 in which a digital wallet user interface enables the entity to share access to and use of one or more data objects, created by or for that entity, with other external entities.

79. The system of claim 1 in which a digital wallet user interface enables the entity to prevent or mask viewing or access to one or more private data objects, created by or for that entity, with other external entities.

80. The system of claim 1 in which a digital wallet user interface enables the entity to determine how data objects, created by or for that entity, are visualised or seen by other external entities.

81. The system of claim 1 in which a digital wallet user interface enables the entity to set permissions that define if and how a data object, created by or for that entity, can be seen and used by other external entities, such as make purchases, transfer funds in or out, spending limits.

82. The system of claim 1 in which a digital wallet user interface enables the entity to permit or block transactions with specific data objects, created by or for that entity, at specific named shops or services, such as to permit a data object relating to food shopping to be used to buy items only from specified stores.

83. The system of claim 1 in which a digital wallet user interface enables the entity to automate financial activity in relation to data objects, created by or for that user entity, by time event based rules.

84. The system of claim 1 in which a digital wallet user interface enables the entity to automate financial activity in relation to data objects, created by or for that entity, by trigger-event based rules.

85. The system of claim 1 in which a digital wallet user interface displays any one or more of rewards, vouchers, gifts or incentives available to a user from different merchants.

86. The system of claim 1 in which a digital wallet user interface displays any one or more of rewards, vouchers, gifts or incentives available to the entity if that entity spends a defined amount with a merchant, and if the entity does spend at least that amount, then the reward etc is automatically provided to an appropriate object, shown in the wallet, for that entity.

87. The system of claim 1 in which a digital wallet user interface displays any one or more of rewards, vouchers, gifts or incentives available to the entity if the entity commits to spend a defined amount with a merchant, and if the entity does in fact spend at least that amount, then the reward etc is automatically provided to an appropriate data object, shown in the wallet, for that entity.

88. The system of claim 1 in which a digital wallet user interface includes a chat or messaging function to enable a first entity to send chats or messages to other users or entities who share access to the same data objects, such as the first entity's objects.

89. The system of claim 71 in which a digital wallet user interface enables the entity to construct, view and interact with a collection of data objects, created by or for that entity, where the data objects: (i) are structured or selected by the entity to enable the entity to plan, budget, share and control their finances and (ii) include meta-data defining each data object; and
where the digital wallet user interface enables the entity to initiate a transaction with an external entity from or to a data object, in a manner that automatically alters the numeric value of the data object.

90. The system of claim 1 in which a digital wallet enables a single payment transaction, made with a single payment card or virtual card, to both pay for goods and/or services and also redeem and/or earn rewards, vouchers, gifts or incentives.

91. The system of claim 71 in which a digital wallet enables a single payment transaction, made with a single payment card or virtual card, to both pay for goods or services in a manner that is automatically processed in relation to a predefined data object to automatically pay for those goods or services and also to alter the numeric value of that data object.

92. The system of claim 1 in which a digital wallet enables a single payment transaction, made with a single payment card or virtual card, to both pay for goods or services in a manner that is automatically processed in relation to a predefined data object, and also to earn or redeem rewards, vouchers, gifts or incentives, in a manner that is also automatically processed in relation to a predefined data object to deliver fully accurate attribution to link a purchase by a specific entity to a specific reward, voucher, gift or incentive used by that entity.

93. The system of claim 1 in which the data-analysis environment enables a consumer to initiate a transaction with an external entity from or to a data object, or in a manner that automatically alters the data or meta-data associated with the data object, such as spending directly from or in relation to a specific virtual sub-account or jar.

94. The system of claim 7 in which the data-analysis environment enables permissions, that define how a shared data object can be used by an external entity, to be processed in real-time to permit or block a transaction initiated by that external entity.

95. The system of claim 7 in which the data-analysis environment enables permissions, that define how a shared data object can be used by an external entity, to be processed by a Point-of-Sale system in real-time.

96. The system of claim 1 in which the data-analysis environment enables time-based rules to be defined and to permit or block a transaction depending on whether a time-based rule is satisfied.

97. The system of claim 1 in which the data-analysis environment enables trigger-event based rules to be defined and to permit or block a transaction depending on whether a trigger-event based rule is satisfied.

98. The system of claim 1 in which the data-analysis environment is configured to process in real time the time-based rules and the trigger-event based rules.

99. The system of claim 1 in which the data-analysis environment enables the time event based rules and the trigger-event based rules to be processed at or by a Point-of-Sale system in real-time.

100. The system of claim 1 in which the data-analysis environment enables a transaction to be reclassified to one or more different data objects.

101. The system of claim 1 in which the data-analysis environment enables a transaction to be reclassified to one or more different data objects and meta-data defining the reclassification is preserved across all affected data objects.

102. The system of claim 1 in which the data-analysis environment generates data that enables messages, such as advertising messages and offers of rewards, vouchers, gifts or incentives, to be automatically targeted at consumers with data objects that have meta-data that indicates potential relevance of those messages.

103. The system of claim 1 in which if the data-analysis environment determines that a numeric value of an appropriate data object is insufficient to meet or satisfy a transaction, then the data-analysis environment is configured to automatically allocate some or all of the proposed transaction to another data object or data objects, according to a predefined priority order.

104. The system of claim 15 in which the origin of the proposed transaction is determined using a combination of one or more of the following: pattern matching; regular expressions matching; or machine learning.

105. The system of claim 15 in which the data-analysis environment is configured to output a confidence score associated with the identified origin of the proposed transaction.

106. The system of claim 105 in which, when the confidence score is higher than a pre-defined threshold, the system is configured to check the data store to see if there are any rules and or rewards that need to be applied to the proposed transaction.

107. The system of claim 1 in which the data-analysis environment is configured to process and record a transaction against a specific data object in real time to alter a value or balance for that specific data object.

108. The system of claim 1 in which the data-analysis environment is configured to enable a transaction that relates to a specific data object to be recorded against that specific data object in real time, so that a payment from that specific data object is reflected or displayed in real time, such as by altering a value or balance for that specific data object.

109. The system of claim 1 in which meta-data for a data object defines one or more permissions that describe who can and cannot transact with a data object or a clusters or group of several individual data objects and a consumer or a third party creates the permissions.

110. The system of claim 1 in which the data-analysis environment is configured to enable a user to transact, such as spend, directly from or in relation to a specific data object, such as a virtual sub-account or jar or a primary virtual account and the data-analysis environment only approves a proposed transaction if there are sufficient funds in or attributed to that specific data object, such as that specific virtual sub-account.

111. The system of claim 1 in which the meta-data for a transaction is analysed in the data-analysis environment to profile the entity.

112. The system of claim 1 in which the data-analysis environment is configured so that any payments relating to a specific data object, such as out from or into a secondary virtual sub-account, are made solely using a digital payment device, such as a debit card or app running on a smartphone.

113. The system of claim 1 in which the data-analysis environment is configured so that any payments out from or into a specific data object, such as a secondary virtual sub-account, automatically and substantially immediately alters the balance or value of a linked primary virtual account.

114. The system of claim 1 in which the data-analysis environment enables the amount of a value in a transaction to be a calculated amount.

115. The system of claim 1 in which the data-analysis environment triggers a transaction to alter a value associated with a source data object to a preset level when a predefined condition is met.

116. The system of claim 1 in which the data-analysis environment automatically triggers a transaction from a source data object to a target data object when a predefined condition is met.

117. The system of claim 1 in which the data-analysis environment triggers a fractional series of transactions from a source data object to a target data object

118. The system of claim 1 in which when a proposed transaction data is received, the data-analysis environment is configured to recommend a suitable allocation to one or more jars.

119. The system of claim 1 in which the data-analysis environment includes or accesses rules that are used by a rules engine.

120. The system of claim 119 in which the rules engine determines in real-time if a transaction with a specific merchant should be blocked or permitted, by using a MID code for that merchant and checking data or meta-data related to that MID code that defines what transactions with that merchant are blocked and what transactions are permitted.

121. The system of claim 119 in which the rules engine determines in real-time whether to permit or block a transaction for specific types of goods or services by using a MCC code and checking data or meta-data related to that MCC code that defines what types of goods or services are blocked and what types of goods or services are permitted.

122. The system of claim 119 in which the rules engine determines in real-time whether a transaction altering the numeric value of a data object should be blocked or permitted, such as whether money is permitted to be moved in or out of a virtual sub-account or jar to be spent with a specific merchant or on specific types of goods or services.

123. The system of claim 119 in which conditionality rules define one or more of the following: merchant name, merchant type, MID code, MCC code, SKU, to hence enable the rules engine to automatically determine in real-time if a proposed transaction that would lead to a debit associated with a data object is permitted or not.

124. The system of claim 119 in which the rules engine determines in real-time whether to permit or block a debit or credit transaction that directly affects, such as changes the value of a specific data object such as a specific jar.

125. The system of claim 119 in which the rules engine implements in real-time a debit or credit transaction from a linked series of data objects, such as jars, according to a predefined priority of payments order.

126. The system of claim 119 in which the priority of payments order includes an ordered list of different types of stores of value, such as money, then crypto, then rewards, then non-fiat currency or redemption points.

127. The system of claim 119 in which the rules engine implements in real-time a debit or credit transaction from a linked series of data objects so that a debit or credit cascades or flows through the linked series of data objects until conditions defined in the rules engine are met.

128. The system of claim 119 in which the rules engine determines in real-time whether to permit or block a debit transaction using predefined affordability criteria.

129. The system of claim 119 in which the rules engine automatically changes, such as rounds up or down, the amount of a payment transaction and attributes the amount of a change to a specific data object.

130. The system of claim 119 in which the rules engine automatically allocates a single invoice or payment to multiple data objects.

131. The system of claim 1 in which the data-analysis environment is configured to enable a data object to be shared by a first entity with multiple entities, with each entity having rights to perform actions or events that relate to that data object, as permitted by rules stored in or accessed by the data-analysis environment that are under the control of the first entity, such as devolved spending.

132. The system of claim 1 in which the data-analysis environment is configured to enable a data object to be shared by a first entity with multiple entities, with each entity having rights for one of more of the following: to read, or pay into, or spend from, that shared data object, or invite new entities to share that data object, in each case as permitted by rules stored in or accessed by the data-analysis environment that are under the control of the first entity.

133. The system of claim 1 in which, when a data object is transferred to another entity, the meta-data associated with the data object is also transferred to the other entity.

134. The system of claim 7 in which, when a proposed transaction data is received that meets the rules or conditions of the shared data object, the system is configured to automatically allocate the proposed transaction to the shared data object, such as to affect the numeric value of that shared data object.

135. The system of claim 7 in which, when a proposed transaction data is received, the data-analysis environment is configured to recommend a suitable allocation to the shared data object.

136. The system of claim 1 in which a data object is a clusters or group of several individual data objects.

137. The system of claim 1 in which the data analysis environment is configured to provide the entity with a view-only access to specific meta-data linked to a data object associated with another entity.

138. The system of claim 1 in which the data-analysis environment is configured to enable a consumer to share any data object, such as a virtual sub-account, with a group of people to create a shared data object, or ledger that captures the intent of the group of people, acting towards a shared goal, where that intent is defined by meta-data stored in the data store.

139. The system of claim 1 in which the data-analysis environment is configured to enable a first entity to create, linked to a primary virtual account of that entity, a data object, for a different entity.

140. The system of claim 139 in which the data-analysis environment is configured to enable that different entity to create, linked to the primary virtual account of the first entity, another data object for another different entity.

141. The system of claim 1 in which the data-analysis environment is configured to process data messages that relate to a specific data object.

142. The system of claim 1 in which the data-analysis environment is configured to process data messages that relate to a data object that is shared across several entities to enable a chat group associated with that shared data object.

143. The system of claim 1 in which meta-data for messages is matched by the data-analysis environment to meta-data for one or more of the data objects when determining if data messages are sent to or visible to any entity that can view the data object.

144. The system of claim 1 in which a data object is a contact or group of contacts, and the data-analysis environment is configured to process data messages that are between contacts or groups of contacts.

145. The system of claim 1 in which the data-analysis environment is configured to process data messages that are a notification of a change in data in the data store or a change in a data object.

146. The system of claim 1 in which the data-analysis environment is configured to process data messages from a supplier, where the supplier is one of the following: a merchant; a service provider; a bank; an asset or wealth manager; an insurance company; a pension provider; a merchant loyalty or reward programme; a group or team or club.

147. The system of claim 1 in which the data-analysis environment is connected, via an API, to a data infrastructure of one or more of the following suppliers: a merchant; a service provider; a bank, an asset or wealth manager, an insurance company, a pension provider, a merchant loyalty or reward programme, a group or team or club, to enable the provision of services to entities that extends the scope of that supplier data infrastructure.

148. The system of claim 141 in which the data messages relate to rewards, vouchers, gifts or incentives that affect a data object.

149. The system of claim 141 in which the data messages relate to data objects that are shared across, or accessible to, several different entities, to enable group messaging that is related to a specific data object.

150. The system of claim 1 in which the data-analysis environment is configured to enable a customer to identify a specific data object for which only transactions with a specific merchant, as identified by a MID code, are permitted, and to define one or more rules so that future transactions are completed from or to this specific data object only if the rule or rules are met.

151. The system of claim 1 in which the data-analysis environment is configured to enable a creation of a transferrable data object, associated with an amount of value, for which only transactions that meet preset criteria, such as merchant name or type, date ranges, are permitted, and that data object is transferrable between different users, like a voucher or riskless gift card.

152. The system of claim 1 in which the data-analysis environment is configured to automatically inform a merchant when a data object is created that is specific to that merchant, as identified by a MID (Merchant Identification) code.

153. The system of claim 1 in which the data-analysis environment is configured to automatically inform a merchant what the future spend from a specific customer is intended to be, using data from the data object(s) that is specific to that merchant.

154. The system of claim 1 in which the system includes a digital wallet app, such as a smartphone or desktop app, that exchanges data with the data-analysis environment and is configured to share with a merchant one or more of the following types of intent-related data: what the user intends to buy, using money allocated to a specific data object; who the user intends to spend their money with, using money allocated to a specific data object; when the user intends to spend their money, using money allocated to a specific data object.

155. The system of claim 1 in which the system includes a digital wallet app, such as a smartphone or desktop app, that exchanges data with the data-analysis environment and is configured to share with a merchant one or more of the following types of data: any transaction entered into by a user with the merchant or other merchants, including what was purchased, when it was purchased, where it was purchased, and whether any reward or incentive was used in the purchase.

156. The system of claim 1 in which the data-analysis environment and is configured to share with one or more merchants one or more of the following types of intent-related data, which are collected into a queryable database or data set: what the user intends to buy, using money allocated to a specific data object; who the user intends to spend their money with, using money allocated to a specific data object; when the user intends to spend their money, using money allocated to a specific data object; any transaction entered into by the user with the merchant or other merchants, including what was purchased, when it was purchased, where it was purchased, and whether any reward or incentive was used in the purchase.

157. The system of claim 1 in which the data-analysis environment is configured to store personal profiles and preferences and to build an anonymised cohort of entities that meet criteria defined by a merchant, to enable the merchant to automatically send incentives or rewards targeted at the cohort.

158. The system of claim 1 in which the data-analysis environment is configured to share with one or more merchants one or more of the following types of data, which are collected by the merchant into a queryable database or data set: who gets rewards of other incentives and who does not, such as which data objects and their related owning/controlling entities get incentives; when incentives are delivered to a data object; how incentives are delivered to a data object, such as which data channel is used; whether an incentive worked or not, such as whether it triggered or was used in a transaction.

159. The system of claim 1 in which the data analysis environment is configured to enable one or more merchants to define one or more rules for targeting and/or awarding and/or attributing rewards or other incentives; and the data-analysis environment is configured to automatically target, and/or award and/or attribute those rewards or incentives to a data object that satisfies the rule or rules.

160. The system of claim 1 in which the data analysis environment is configured to use a feedback loop to learn over time from targeting, and/or awarding and/or attribution data, how to improve targeting of rewards or other incentives.

161. The system of claim 1 in which the system is configured to perform a large number of testing and analysis of different incentives prior to the moment an end-user spends from a specific jar, and to then generate end-users' behaviour models.

162. The system of claim 1 in which the data-analysis environment is configured to generate individual recommendations for how a merchant can engage with a specific end-user in a way that the specific end-user finds appealing based on historical transactional data.

163. The system of claim 1 in which the data-analysis environment is configured to generate behavioural change triggers, such as using a gamification engine, based on historical transactional data.

164. The system of claim 1 which the data-analysis environment is configured to generate individual recommendations prior to a point of sale, such as at the moment of intent.

165. The system of claim 1 in which rules for awarding rewards or other incentives take into account any one or more of the following: merchant loyalty points, longevity with merchant, geo-location data, time stamp data, amount of transaction, or any event or action that relates to the merchant, such as the creation of a data object (i) related to the specific merchant and/or (ii) shared with a number of other entities; or the completion of a pre-defined number of transactions; or a pre-commitment to spend a specific amount at the merchant; consumer demographics; consumer behaviour tracked by the data-analysis environment; environmental conditions; merchant specific conditions; specific conditions stored by or accessible to the data-analysis environment.

166. The system of claim 1 in which the data-analysis environment is configured to automatically apply any rewards or other incentives from a specific merchant for that specific consumer such as hyper-personalised promotions and incentives, to automatically update the amount left in or associated with the appropriate data object.

167. The system of claim 1 in which the data-analysis environment is configured to enable one or more merchants to define rules for awarding rewards or other incentives; and the data-analysis environment is configured to automatically award those rewards promotions, offers or incentives to an entity whose future intent, defined in a data object, meets those rules, such as whenever money is paid into a merchant-specific virtual sub-account or whenever money is spent with the merchant from that virtual sub-account).

168. The system of claim 1 in which the data-analysis environment is configured to enable one or more merchants to define any kind of incentive, such as any rules based promotion or discount, such as experiential incentives, save-now and buy-later, as well as more conventional % discount or a two for ones, that is specific to an individual consumer or consumers that meet a demographic profile or meet any other metadata parameters the data-analysis environment captures.

169. The system of claim 1 in which the data-analysis environment is configured to enable multiple merchants to define any kind of incentive that is common across all the merchants.

170. The system of claim 119 in which the rules engine automatically awards or redeems rewards or incentives to an entity whose future intent, defined in or by a data object, such as a virtual sub-account, meets certain rules, and the award or redemption occurs in real-time when the entity commits to a future transaction, or that transaction occurs.

171. The system of claim 170 in which the data-analysis environment is configured to automatically award those rewards or incentives to a data object whenever money is paid into a virtual sub-account or whenever money is spent with the merchant from that virtual sub-account or money is placed into a specific data object.

172. The system of claim 170 in which data objects defining rewards or other incentives have one or more of the following properties:
grows over time;
awarded at time of event;
awarded on completion of n steps-like a stamp card;
must be used in a specific;
must be used between specific times/by this date;
is a random amount;
a random user is selected for a prize;
is awarded for completing a task;
follows a merchant;
created with a shared jar with x friends;
requires spending x amount over y period;
is a percentage discount for a transaction spend, based on the total amount of the transaction;
are specific and different amounts based on meeting specific rules or conditions;
can be used in whole or part, even in a physical, retail store;
rewards sent to parents are shared with their children to enable parental-consented marketing;
cannot be used by the initial recipient, but can be given away and then used by the subsequent recipient;
increase in value over time;
increase in value over time if shared with others;
deduction or coupon calculated in real-time at the POS;
activates when a user collects a set or series of rewards;
increase as more users collect a reward;
is a money off after a set number of transactions at a specific merchant;
are time-based;
decline in value over time;
only works on specific dates;
can only be given to friends, groups, or children;
can only be given away as gifts;
are rewards for completing a survey, or watching content.

173. The system of claim 1 in which the system implements in real-time a single debit or credit transaction with a permissioned merchant, according to a predefined priority of payments order, including rewards or incentives data objects associated with that permissioned merchant, and which are defined with a specific priority.

174. The system of claim 1 in which the system implements a reward that grows over time, and dynamically calculates reward value at the point of redemption, using merchant level MID code blocking or routing.

175. The system of claim 1 in which rewards are fully or partially transferable on meeting specific rules or conditions defined by the merchant, such as rewards when transferred should be spent at a specific time or geo-location data, or with merchant.

176. The system of claim 1 in which the data-analysis environment is configured to automatically identify an end-user to a merchant, such as when the end-user enters a store of the merchant or when a specific card or QR code is used, to automatically apply any promotion or offer for that end-user, and to automatically update the amount left in the merchant-specific jar of that end-user.

177. The system of claim 1 in which the data-analysis environment is configured to generate a risk level associated with each end-user based on historical transactional data from each user.

178. The system of claim 177 in which rewards are provided based on the generated risk level of each end-user.

179. The system of claim 1 in which the data-analysis environment is configured to receive a direct debit request from a specific merchant and, when there is no data record of the entity agreeing to accept a direct debit from that merchant, to meta-tag the amount of any direct debit as a debt that the entity owes to the specific merchant and to enable the entity to make future payments to that merchant to progressively pay off that amount.

180. The system of claim 179 in which a direct debit request from the merchant is in a standard data format and is sent over a standard banking system, such as BACS.

181. The system of claim 179 in which the data-analysis environment sends a data signal to the merchant that a direct debit request has been accepted.

182. The system of claim 1 in which unpaid amounts are configured to be automatically repaid in the future in circumstances defined by a rule.

183. The system of claim 182 in which the system is configured to enable the entity to input a schedule of payments for the unpaid amounts.

184. The system of claim 1 in which the system is configured to enable the entity to manually settle the unpaid amounts or part of the unpaid amounts.

185. The system of claim 179 in which the system is configured to automatically send an alert to the specific merchant when the direct debit request has been modified.

186. The system of claim 179 in which the system is configured to provide customer related parameters to the specific merchant.

187. The system of claim 179 in which the system is configured to notify the specific merchant of a total amount of the debt that is remaining, on a scheduled basis.

188. The system of claim 119 in which the data-analysis environment is configured to automatically reconcile or allocate any unused amounts after the transaction or event has concluded among the multiple entities, according to rules or conditions as agreed by the multiple entities.

189. The system of claim 119 in which the data analysis environment is configured to automatically distribute any remaining money or crypto or rewards or non-fiat currency linked to a shared data object between the multiple entities according to rules or conditions as agreed by the multiple entities.

190. The system of claim 188 in which the rules or conditions define the distribution of any unused amounts according to pre-agreed principles of fairness.

191. The system of claim 188 in which the rules or conditions prohibit any entity receiving more than they contributed

192. The system of claim 18 in which the data-analysis environment is configured to generate credit evaluation data for the specific merchant that automatically takes into account data objects that capture the future intent or spending plans of one or more entities with the specific merchant.

193. The system of claim 18 in which the data-analysis environment is configured to consolidate or group all data objects that capture the future intent or spending intent of multiple entities with a specific entity.

194. The system of claim 193 in which the data-analysis environment is configured to generate credit evaluation data for that entity that automatically takes into account the consolidated or grouped data objects that capture future intent or spending plans with that entity.

195. The system of claim 193 in which the data-analysis environment is configured to automatically generate a revised credit score for that specific entity, that takes into account the consolidated or grouped data objects that capture future intent or spending intent with that entity.

196. The system of claim 195 in which the data-analysis environment is configured to automatically analyse a loan request for that entity, taking into account the credit evaluation data and/or revised credit score.

197. The system of claim 1 in which the data-analysis environment is configured to store a data record for the amounts of one or more non-fiat items owned by or associated with that entity and, when the entity starts or enters a proposed transaction in a fiat currency, then the data-analysis environment retrieves or looks up an exchange rate between the non-fiat item type and the fiat currency, and automatically calculates how the transaction could be completed, in whole or part, using the non-fiat items at the prevailing exchange rate.

198. The system of claim 197 in which non-fiat items includes reward points, Crypto tokens, Merchant Money, such as non-fiat currency linked with a specific merchant or group of merchants, such as rewards points.

199. The system of claim 197 in which the data analysis environment is configured to apply a pre-defined set of rules or conditions to determine if and how much non-fiat items should be used to pay for the transaction.

200. The system of claim 1 in which the data objects track data associated with one or more of the following: a bank; an asset or wealth manager; an insurance company; a pension provider; a merchant loyalty or reward programme; a group or team or club.

201. The system of claim 1 in which the data-analysis environment is connected, via an API, to a data infrastructure of one or more entities that publish solutions to consumers, where meta-data for the solutions is matched by the data-analysis environment to meta-data for consumers that describes the consumers' future intent or intended future actions.

202. The system of claim 201 in which the entities that publish solutions are one of the following: a bank; an asset or wealth manager; an insurance company; a pension provider; a merchant loyalty or reward programme; a group or team or club.

203. The system of claim 1 in which the data-analysis environment is connected, via an API, to a data infrastructure of one or more of the following entities: a bank, an asset or wealth manager, an insurance company, a pension provider, a merchant loyalty or reward programme, a group or team or club, to enable the provision of services to customers of the entity.

204. The system of claim 1 in which the data-analysis environment is connected, via an API, to a data infrastructure of one or more of the following entities: a bank, an asset or wealth manager, an insurance company, a pension provider, a merchant loyalty or reward programme, a group or team or club, to enable the provision of services to customers of the entity that extends the scope of that data infrastructure to include data objects that are (i) created by a customer to define the customer's future intent or intended future actions, such as to enable the customer to plan, budget, share and control their finances and (ii) track transactions, such as purchases.

205. The system of claim 1 in which the system includes a data-analysis environment configured to include digital wallet functionality.

206. The system of claim 1 in which the data-analysis environment is configured to enable personal budgeting for future spend across different categories, such as shopping, petrol, mobile phone, utilities, using data objects, such as virtual sub-accounts, that are specific to each category.

207. The system of claim 1 in which the data-analysis environment is configured to enable financial contributions to a shared or group social activity and spending on the activity, using a shared data object, such as a shared virtual sub-account, associated solely with that activity.

208. The system of claim 1 in which the data-analysis environment is configured to enable children's pocket money, by enabling a child to spend directly from a defined data object, but in ways that are controlled in advance by an adult who controls the data object.

209. The system of claim 1 in which the data-analysis environment is configured to enable long term savings and pensions, by providing a data object, such as a virtual sub-account for savings or pensions, and to enable a customer to set up rules that determine regular payments into that data object.

210. The system of claim 1 in which the data-analysis environment is configured to enable testing and analysis of different incentives designed to explore what induces consumers and what their demographic parameters are to commit to allocating funds to a specific merchant or data object.

211. The system of claim 1 in which the data-analysis environment: (i) includes a data record for a root or primary virtual account for an entity, and also data records for one or more data objects of the root or primary account, such as a UUID or other uniquely defined logical entity, that are defined or created by that entity and are linked to the primary virtual account, the data objects constituting the data objects.

212. The system of claim 1 in which the data-analysis environment: is configured to include a multi-level hierarchy of accounts, with a root or primary virtual account at the top level, and data objects at a lower level, and one or more core virtual accounts, each specific to one type of store of value, such as either money, or crypto, or rewards, positioned in-between the root or primary virtual account and the data objects, so that transaction data flows from the root or primary virtual account to a core virtual account and then to a data object.

213. A computer-implemented method to provide data processing services to an entity, the method comprising the steps:
(i) providing a data-analysis environment which includes or accesses a data store that stores data and meta-data for one or more data objects that represent a store of value (‘data objects’) that are created by the entity; and
(ii) providing an API layer that links the data-analysis environment to (a) a digital wallet provider, and to (b) a service publisher that publishes data to the data-analysis environment;
(iii) operating the data-analysis environment by linking the data-analysis environment via the API layer to (a) the digital wallet provider, and to (b) the service publisher.

214. (canceled)
